(19) United States
(12) Patent Application Publication
(10) Pub. No.: US 2026/0180939 A1
(43) Pub. Date: Jun. 25, 2026

(54) USER INTERFACES AND TECHNIQUES FOR EDITING, CREATING, AND USING STICKERS

(71) Applicant: Apple Inc., Cupertino, CA (US)

(72) Inventors: Adrian ZUMBRUNNEN, San Francisco, CA (US); Alan C. DYE, San Francisco, CA (US); James N. JONES, San Francisco, CA (US); Nicholas V. KING, San Jose, CA (US); Johnnie B. MANZARI, San Francisco, CA (US); Grant R. PAUL, San Francisco, CA (US)

(21) Appl. No.: 19/540,463

(22) Filed: Feb. 13, 2026

Related U.S. Application Data
(63) Continuation of application No. 18/520,372, filed on Nov. 27, 2023.
(60) Provisional application No. 63/462,953, filed on Apr. 28, 2023.
(60) Provisional application No. 63/470,889, filed on Jun. 3, 2023.
(60) Provisional application No. 63/471,182, filed on Jun. 5, 2023.

(51) Int. Cl. H04L 51/04; G06F 3/04845; H04L 51/10

(52) U.S. Cl. CPC H04L 51/04; G06F 3/04845; H04L 51/10

(57) ABSTRACT

The present disclosure generally relates to techniques and user interfaces for creating, editing, and using stickers. In some embodiments, a sticker can be created using a media item. In some embodiments, a sticker can be edited to apply a visual effect. In some embodiments, a sticker can be suggested for use in a messaging interface.

### CROSS-REFERENCE TO RELATED APPLICATIONS

This application is a continuation of U.S. patent application Ser. No. 18/520,372, entitled “USER INTERFACES AND TECHNIQUES FOR EDITING, CREATING, AND USING STICKERS,” filed on Nov. 27, 2023, which claims priority to: U.S. Provisional Patent Application No. 63/471,182, entitled “USER INTERFACES AND TECHNIQUES FOR EDITING, CREATING, AND USING STICKERS,” filed on Jun. 5, 2023; U.S. Provisional Patent Application No. 63/470,889, entitled “USER INTERFACES AND TECHNIQUES FOR EDITING, CREATING, AND USING STICKERS,” filed on Jun. 3, 2023; and U.S. Provisional Patent Application No. 63/462,953, entitled “USER INTERFACES AND TECHNIQUES FOR EDITING, CREATING, AND USING STICKERS,” filed on Apr. 28, 2023, the contents of each of which are hereby incorporated by reference in their entireties.

### FIELD

The present disclosure relates generally to computer user interfaces, and more specifically to techniques for editing, creating, and using stickers.

### BACKGROUND

Stickers can be used to provide a graphical effect to enhance multimedia communications.

### BRIEF SUMMARY

Some techniques for editing, creating, and using stickers using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for editing, creating, and using stickers. Such methods and interfaces optionally complement or replace other methods for editing, creating, and using stickers. Such methods and interfaces reduce the cognitive burden on a user and produce a more efficient human-machine interface. For battery-operated computing devices, such methods and interfaces conserve power and increase the time between battery charges.

Example methods are described herein. An example method includes, at a computer system that is in communication with a display generation component and one or more input devices: displaying, via the display generation component: a media item that includes a representation of a respective object; and a graphical user interface object that is selectable to generate a sticker based on the media item; detecting, via the one or more input devices, a selection of the graphical user interface object; in response to detecting the selection of the graphical user interface object, generating a respective sticker having an appearance based on the representation of the respective object in the media item; and displaying, via the display generation component, a plurality of stickers, wherein the plurality of stickers includes a representation of the respective sticker having the appearance based on the representation of the respective object in the media item.

An example method includes, at a computer system that is in communication with a display generation component and one or more input devices: displaying, via the display generation component, a sticker editing interface that includes one or more visual effect options that are selectable to apply a visual effect to a respective sticker, wherein the respective sticker has a first appearance; detecting, via the one or more input devices, a set of one or more inputs that includes a selection of one of the one or more visual effect options; and in response to detecting the set of one or more inputs that includes a selection of one of the visual effect options: in accordance with a determination that the set of one or more inputs includes a selection of a first visual effect option, displaying a representation of the respective sticker having a second appearance that is different from the first appearance, wherein the second appearance includes a first visual effect applied to the respective sticker; and in accordance with a determination that the set of one or more inputs includes a selection of a second visual effect option that is different from the first visual effect option, displaying a representation of the respective sticker having a third appearance that is different from the first appearance and the second appearance, wherein the third appearance includes a second visual effect applied to the respective sticker without the first visual effect, wherein the second visual effect is different from the first visual effect.

An example method includes, at a computer system that is in communication with a display generation component and one or more input devices: while displaying, via the display generation component, a messages interface that includes respective text, detecting that the respective text meets a first set of criteria; in response to detecting that the respective text meets the first set of criteria, displaying a set of one or more selectable options associated with the respective text; detecting a set of one or more inputs that includes a selection of a respective option of the set of one or more selectable options; and in response to detecting the set of one or more inputs that includes a selection of a respective option of the set of one or more selectable options: in accordance with a determination that the respective option is a first type of selectable option, replacing the respective text with an emoji corresponding to the respective option; and in accordance with a determination that the respective option is a second type of selectable option different from the first type, displaying, in the messages interface, a sticker corresponding to the respective option without replacing the respective text.

Example non-transitory computer-readable storage media are described herein. An example non-transitory computer-readable storage medium stores one or more programs configured to be executed by one or more processors of a computer system that is in communication with a display generation component and one or more input devices, the one or more programs including instructions for: displaying, via the display generation component: a media item that includes a representation of a respective object; and a graphical user interface object that is selectable to generate a sticker based on the media item; detecting, via the one or more input devices, a selection of the graphical user interface object; in response to detecting the selection of the graphical user interface object, generating a respective sticker having an appearance based on the representation of the respective object in the media item; and displaying, via the display generation component, a plurality of stickers, wherein the plurality of stickers includes a representation of the respective sticker having the appearance based on the representation of the respective object in the media item.

An example non-transitory computer-readable storage medium stores one or more programs configured to be executed by one or more processors of a computer system that is in communication with a display generation component and one or more input devices, the one or more programs including instructions for: displaying, via the display generation component, a sticker editing interface that includes one or more visual effect options that are selectable to apply a visual effect to a respective sticker, wherein the respective sticker has a first appearance; detecting, via the one or more input devices, a set of one or more inputs that includes a selection of one of the one or more visual effect options; and in response to detecting the set of one or more inputs that includes a selection of one of the visual effect options: in accordance with a determination that the set of one or more inputs includes a selection of a first visual effect option, displaying a representation of the respective sticker having a second appearance that is different from the first appearance, wherein the second appearance includes a first visual effect applied to the respective sticker; and in accordance with a determination that the set of one or more inputs includes a selection of a second visual effect option that is different from the first visual effect option, displaying a representation of the respective sticker having a third appearance that is different from the first appearance and the second appearance, wherein the third appearance includes a second visual effect applied to the respective sticker without the first visual effect, wherein the second visual effect is different from the first visual effect.

An example non-transitory computer-readable storage medium stores one or more programs configured to be executed by one or more processors of a computer system that is in communication with a display generation component and one or more input devices, the one or more programs including instructions for: while displaying, via the display generation component, a messages interface that includes respective text, detecting that the respective text meets a first set of criteria; in response to detecting that the respective text meets the first set of criteria, displaying a set of one or more selectable options associated with the respective text; detecting a set of one or more inputs that includes a selection of a respective option of the set of one or more selectable options; and in response to detecting the set of one or more inputs that includes a selection of a respective option of the set of one or more selectable options: in accordance with a determination that the respective option is a first type of selectable option, replacing the respective text with an emoji corresponding to the respective option; and in accordance with a determination that the respective option is a second type of selectable option different from the first type, displaying, in the messages interface, a sticker corresponding to the respective option without replacing the respective text.

Example transitory computer-readable storage media are described herein. An example transitory computer-readable storage medium stores one or more programs configured to be executed by one or more processors of a computer system that is in communication with a display generation component and one or more input devices, the one or more programs including instructions for: displaying, via the display generation component: a media item that includes a representation of a respective object; and a graphical user interface object that is selectable to generate a sticker based on the media item; detecting, via the one or more input devices, a selection of the graphical user interface object; in response to detecting the selection of the graphical user interface object, generating a respective sticker having an appearance based on the representation of the respective object in the media item; and displaying, via the display generation component, a plurality of stickers, wherein the plurality of stickers includes a representation of the respective sticker having the appearance based on the representation of the respective object in the media item.

An example transitory computer-readable storage medium stores one or more programs configured to be executed by one or more processors of a computer system that is in communication with a display generation component and one or more input devices, the one or more programs including instructions for: displaying, via the display generation component, a sticker editing interface that includes one or more visual effect options that are selectable to apply a visual effect to a respective sticker, wherein the respective sticker has a first appearance; detecting, via the one or more input devices, a set of one or more inputs that includes a selection of one of the one or more visual effect options; and in response to detecting the set of one or more inputs that includes a selection of one of the visual effect options: in accordance with a determination that the set of one or more inputs includes a selection of a first visual effect option, displaying a representation of the respective sticker having a second appearance that is different from the first appearance, wherein the second appearance includes a first visual effect applied to the respective sticker; and in accordance with a determination that the set of one or more inputs includes a selection of a second visual effect option that is different from the first visual effect option, displaying a representation of the respective sticker having a third appearance that is different from the first appearance and the second appearance, wherein the third appearance includes a second visual effect applied to the respective sticker without the first visual effect, wherein the second visual effect is different from the first visual effect.

An example transitory computer-readable storage medium stores one or more programs configured to be executed by one or more processors of a computer system that is in communication with a display generation component and one or more input devices, the one or more programs including instructions for: while displaying, via the display generation component, a messages interface that includes respective text, detecting that the respective text meets a first set of criteria; in response to detecting that the respective text meets the first set of criteria, displaying a set of one or more selectable options associated with the respective text; detecting a set of one or more inputs that includes a selection of a respective option of the set of one or more selectable options; and in response to detecting the set of one or more inputs that includes a selection of a respective option of the set of one or more selectable options: in accordance with a determination that the respective option is a first type of selectable option, replacing the respective text with an emoji corresponding to the respective option; and in accordance with a determination that the respective option is a second type of selectable option different from the first type, displaying, in the messages interface, a sticker corresponding to the respective option without replacing the respective text.

Example computer systems are described herein. An example computer system is configured to communicate with a display generation component and one or more input devices and includes: one or more processors; and memory storing one or more programs configured to be executed by the one or more processors, the one or more programs including instructions for: displaying, via the display generation component: a media item that includes a representation of a respective object; and a graphical user interface object that is selectable to generate a sticker based on the media item; detecting, via the one or more input devices, a selection of the graphical user interface object; in response to detecting the selection of the graphical user interface object, generating a respective sticker having an appearance based on the representation of the respective object in the media item; and displaying, via the display generation component, a plurality of stickers, wherein the plurality of stickers includes a representation of the respective sticker having the appearance based on the representation of the respective object in the media item.

An example computer system is configured to communicate with a display generation component and one or more input devices and includes: one or more processors; and memory storing one or more programs configured to be executed by the one or more processors, the one or more programs including instructions for: displaying, via the display generation component, a sticker editing interface that includes one or more visual effect options that are selectable to apply a visual effect to a respective sticker, wherein the respective sticker has a first appearance; detecting, via the one or more input devices, a set of one or more inputs that includes a selection of one of the one or more visual effect options; and in response to detecting the set of one or more inputs that includes a selection of one of the visual effect options: in accordance with a determination that the set of one or more inputs includes a selection of a first visual effect option, displaying a representation of the respective sticker having a second appearance that is different from the first appearance, wherein the second appearance includes a first visual effect applied to the respective sticker; and in accordance with a determination that the set of one or more inputs includes a selection of a second visual effect option that is different from the first visual effect option, displaying a representation of the respective sticker having a third appearance that is different from the first appearance and the second appearance, wherein the third appearance includes a second visual effect applied to the respective sticker without the first visual effect, wherein the second visual effect is different from the first visual effect.

An example computer system is configured to communicate with a display generation component and one or more input devices and includes: one or more processors; and memory storing one or more programs configured to be executed by the one or more processors, the one or more programs including instructions for: while displaying, via the display generation component, a messages interface that includes respective text, detecting that the respective text meets a first set of criteria; in response to detecting that the respective text meets the first set of criteria, displaying a set of one or more selectable options associated with the respective text; detecting a set of one or more inputs that includes a selection of a respective option of the set of one or more selectable options; and in response to detecting the set of one or more inputs that includes a selection of a respective option of the set of one or more selectable options: in accordance with a determination that the respective option is a first type of selectable option, replacing the respective text with an emoji corresponding to the respective option; and in accordance with a determination that the respective option is a second type of selectable option different from the first type, displaying, in the messages interface, a sticker corresponding to the respective option without replacing the respective text.

An example computer system is configured to communicate with a display generation component and one or more input devices and includes means for displaying, via the display generation component: a media item that includes a representation of a respective object; and a graphical user interface object that is selectable to generate a sticker based on the media item; means for detecting, via the one or more input devices, a selection of the graphical user interface object; means for, in response to detecting the selection of the graphical user interface object, generating a respective sticker having an appearance based on the representation of the respective object in the media item; and means for displaying, via the display generation component, a plurality of stickers, wherein the plurality of stickers includes a representation of the respective sticker having the appearance based on the representation of the respective object in the media item.

An example computer system is configured to communicate with a display generation component and one or more input devices and includes means for displaying, via the display generation component, a sticker editing interface that includes one or more visual effect options that are selectable to apply a visual effect to a respective sticker, wherein the respective sticker has a first appearance; means for detecting, via the one or more input devices, a set of one or more inputs that includes a selection of one of the one or more visual effect options; and means for, in response to detecting the set of one or more inputs that includes a selection of one of the visual effect options: in accordance with a determination that the set of one or more inputs includes a selection of a first visual effect option, displaying a representation of the respective sticker having a second appearance that is different from the first appearance, wherein the second appearance includes a first visual effect applied to the respective sticker; and in accordance with a determination that the set of one or more inputs includes a selection of a second visual effect option that is different from the first visual effect option, displaying a representation of the respective sticker having a third appearance that is different from the first appearance and the second appearance, wherein the third appearance includes a second visual effect applied to the respective sticker without the first visual effect, wherein the second visual effect is different from the first visual effect.

An example computer system is configured to communicate with a display generation component and one or more input devices and includes means for, while displaying, via the display generation component, a messages interface that includes respective text, detecting that the respective text meets a first set of criteria; means for, in response to detecting that the respective text meets the first set of criteria, displaying a set of one or more selectable options associated with the respective text; means for detecting a set of one or more inputs that includes a selection of a respective option of the set of one or more selectable options; and means for, in response to detecting the set of one or more inputs that includes a selection of a respective option of the set of one or more selectable options: in accordance with a determination that the respective option is a first type of selectable option, replacing the respective text with an emoji corresponding to the respective option; and in accordance with a determination that the respective option is a second type of selectable option different from the first type, displaying, in the messages interface, a sticker corresponding to the respective option without replacing the respective text.

Example computer program products are described herein. An example computer program product includes one or more programs configured to be executed by one or more processors of a computer system that is in communication with a display generation component and one or more input devices, the one or more programs including instructions for: displaying, via the display generation component: a media item that includes a representation of a respective object; and a graphical user interface object that is selectable to generate a sticker based on the media item; detecting, via the one or more input devices, a selection of the graphical user interface object; in response to detecting the selection of the graphical user interface object, generating a respective sticker having an appearance based on the representation of the respective object in the media item; and displaying, via the display generation component, a plurality of stickers, wherein the plurality of stickers includes a representation of the respective sticker having the appearance based on the representation of the respective object in the media item.

An example computer program product includes one or more programs configured to be executed by one or more processors of a computer system that is in communication with a display generation component and one or more input devices, the one or more programs including instructions for: displaying, via the display generation component, a sticker editing interface that includes one or more visual effect options that are selectable to apply a visual effect to a respective sticker, wherein the respective sticker has a first appearance; detecting, via the one or more input devices, a set of one or more inputs that includes a selection of one of the one or more visual effect options; and in response to detecting the set of one or more inputs that includes a selection of one of the visual effect options: in accordance with a determination that the set of one or more inputs includes a selection of a first visual effect option, displaying a representation of the respective sticker having a second appearance that is different from the first appearance, wherein the second appearance includes a first visual effect applied to the respective sticker; and in accordance with a determination that the set of one or more inputs includes a selection of a second visual effect option that is different from the first visual effect option, displaying a representation of the respective sticker having a third appearance that is different from the first appearance and the second appearance, wherein the third appearance includes a second visual effect applied to the respective sticker without the first visual effect, wherein the second visual effect is different from the first visual effect.

An example computer program product includes one or more programs configured to be executed by one or more processors of a computer system that is in communication with a display generation component and one or more input devices, the one or more programs including instructions for: while displaying, via the display generation component, a messages interface that includes respective text, detecting that the respective text meets a first set of criteria; in response to detecting that the respective text meets the first set of criteria, displaying a set of one or more selectable options associated with the respective text; detecting a set of one or more inputs that includes a selection of a respective option of the set of one or more selectable options; and in response to detecting the set of one or more inputs that includes a selection of a respective option of the set of one or more selectable options: in accordance with a determination that the respective option is a first type of selectable option, replacing the respective text with an emoji corresponding to the respective option; and in accordance with a determination that the respective option is a second type of selectable option different from the first type, displaying, in the messages interface, a sticker corresponding to the respective option without replacing the respective text.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for editing, creating, and using stickers, thereby increasing the effectiveness, efficiency, and user satisfaction with such devices. Such methods and interfaces may complement or replace other methods for editing, creating, and using stickers.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AR illustrate exemplary user interfaces for creating stickers, in accordance with some embodiments.

FIG. 7 is a flow diagram illustrating a method for creating stickers, in accordance with some embodiments.

FIGS. 8A-8N illustrate exemplary user interfaces for editing stickers, in accordance with some embodiments.

FIG. 9 is a flow diagram illustrating a method for editing stickers, in accordance with some embodiments.

FIGS. 10A-10I illustrate exemplary user interfaces for using stickers, in accordance with some embodiments.

FIG. 11 is a flow diagram illustrating a method for using stickers, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for editing, creating, and using stickers. Such techniques can reduce the cognitive burden on a user who edits, creates, and/or uses stickers, thereby enhancing productivity. Further, such techniques can reduce processor and battery power otherwise wasted on redundant user inputs.

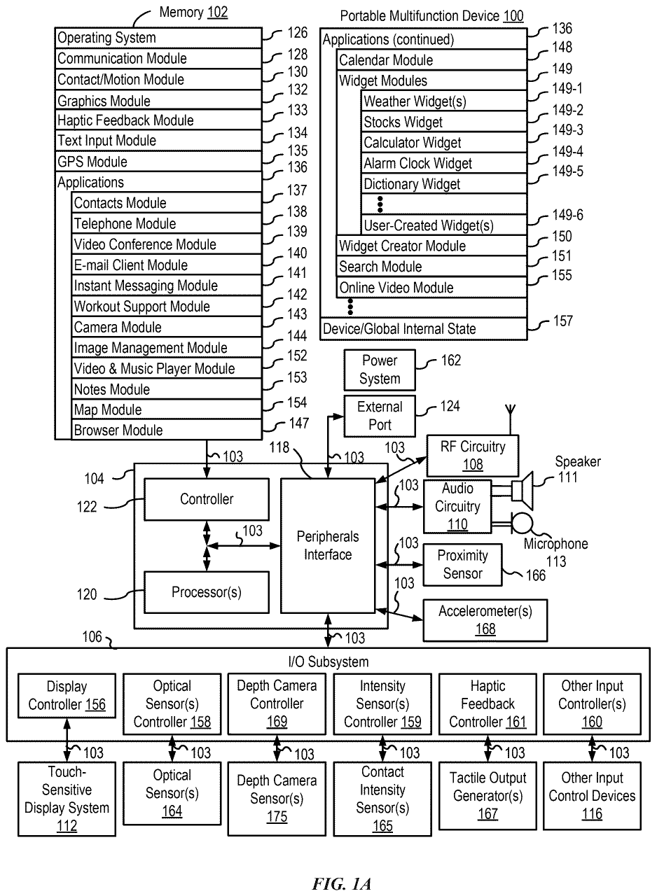

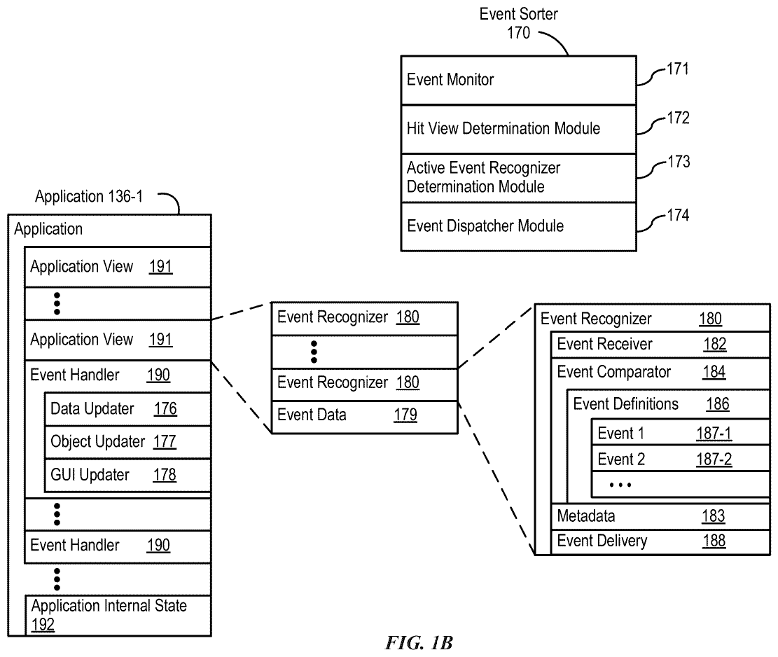

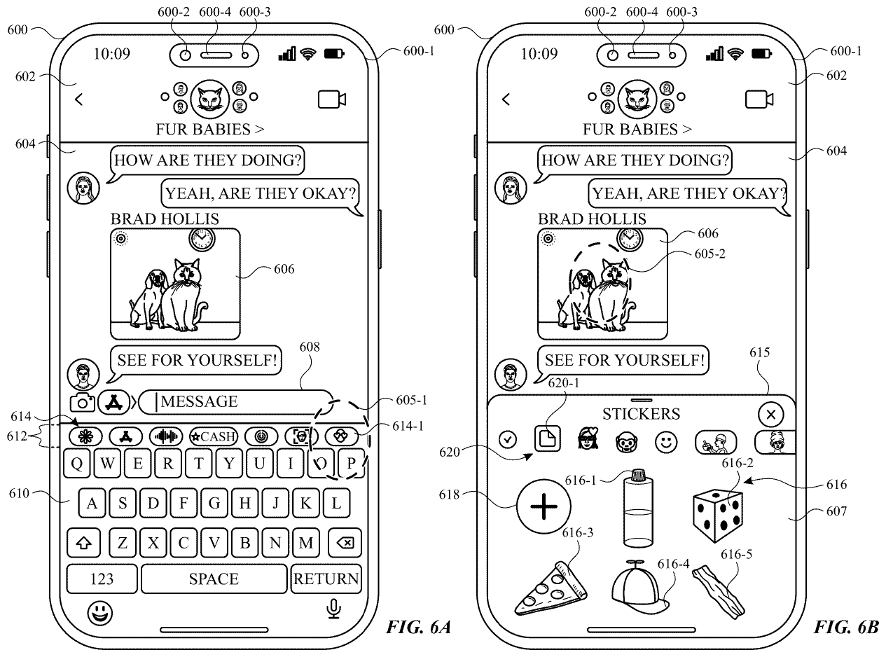

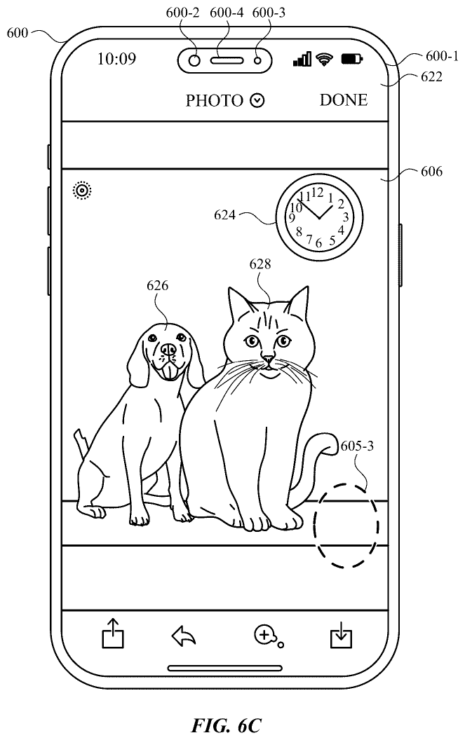

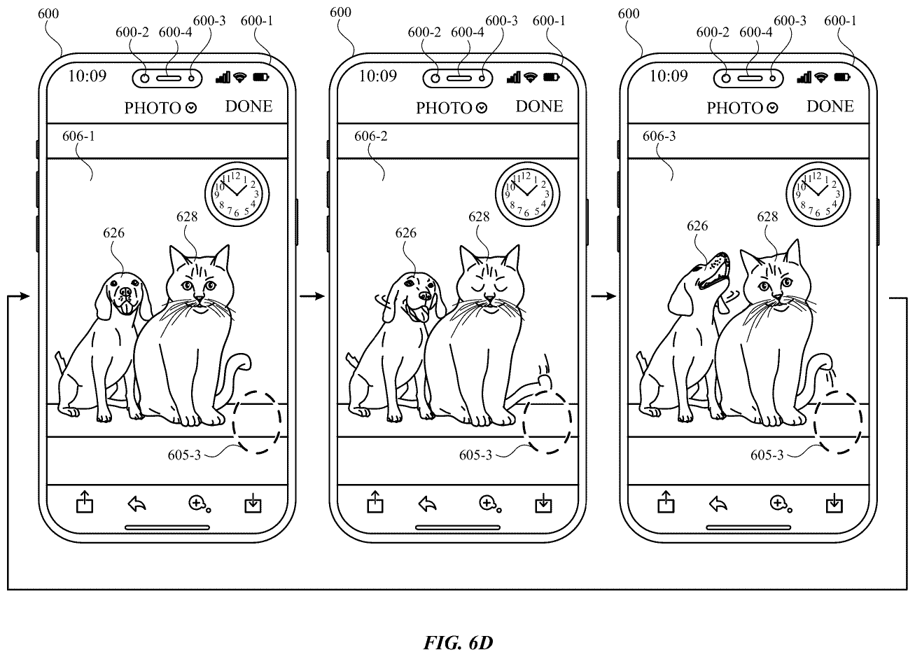

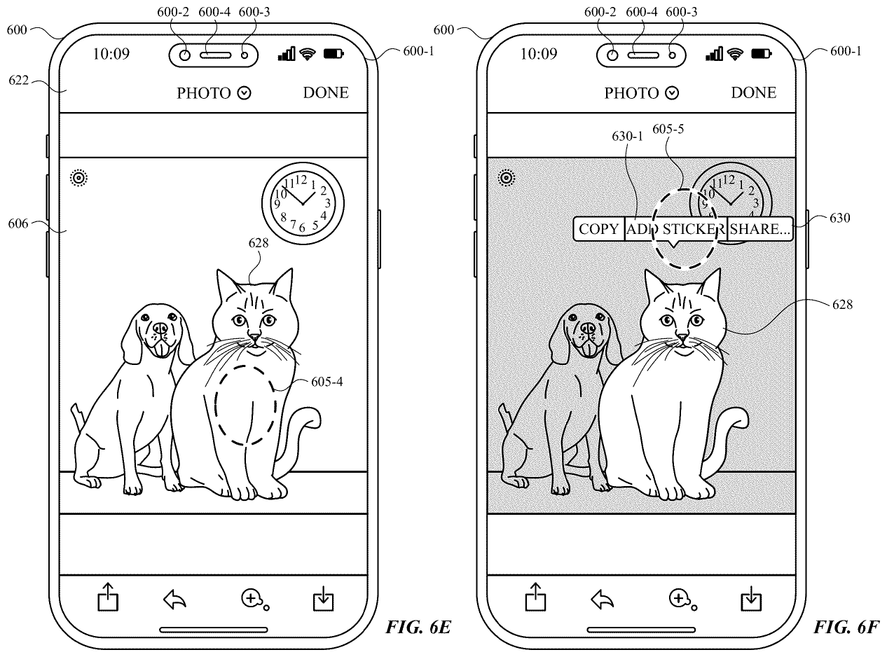

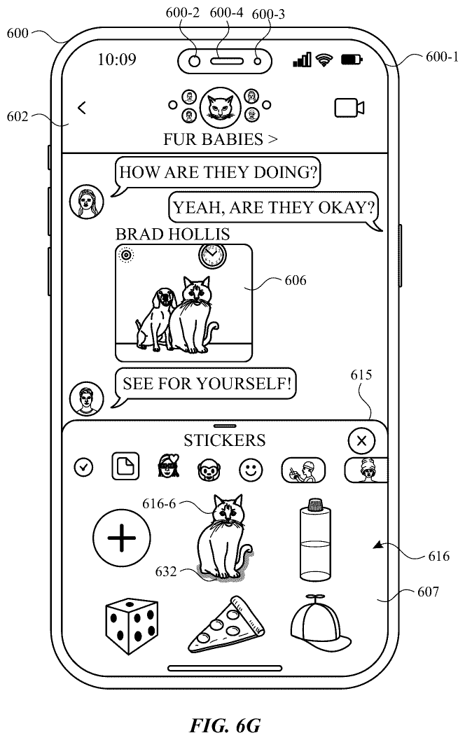

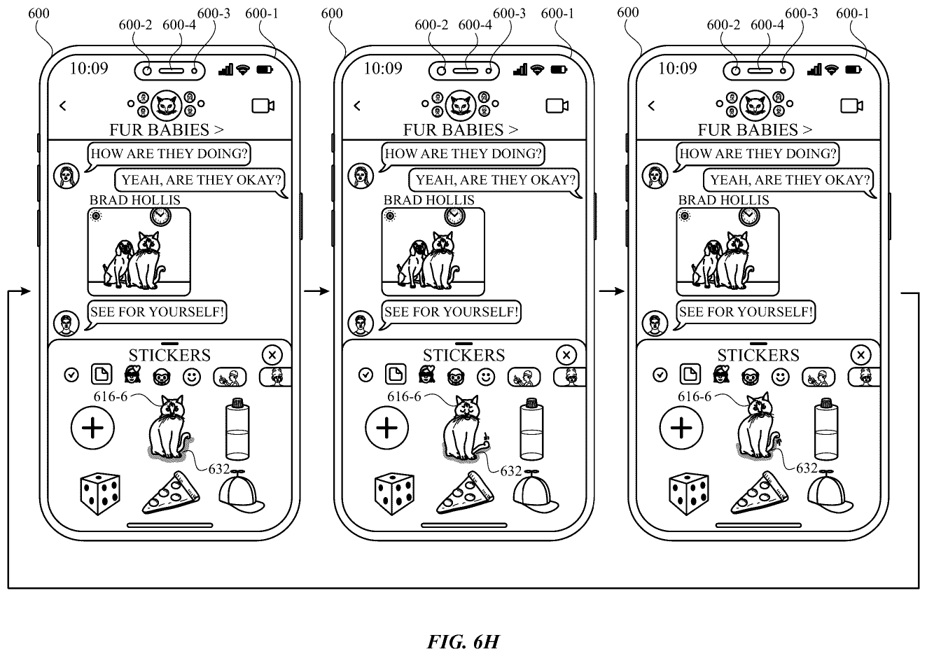

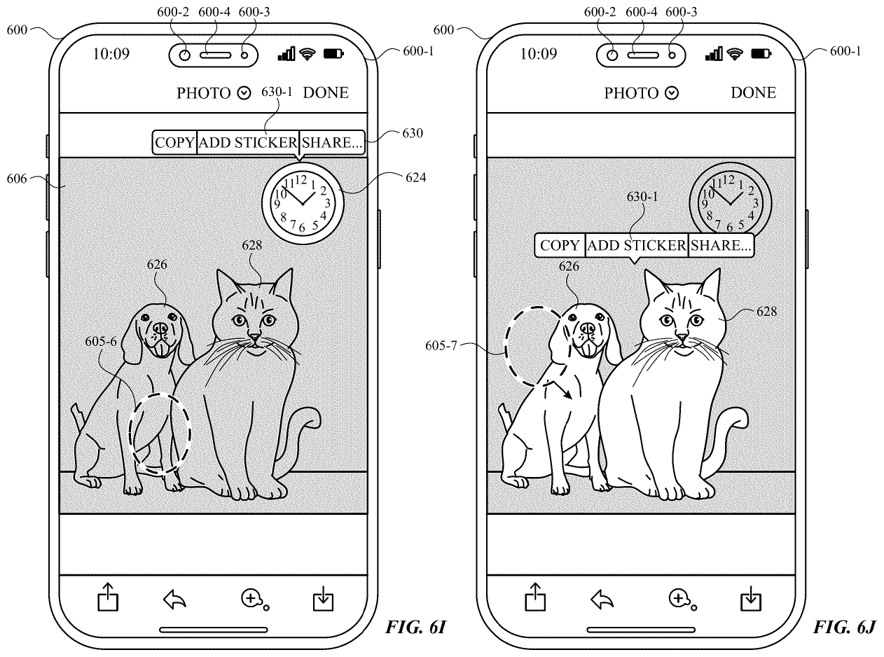

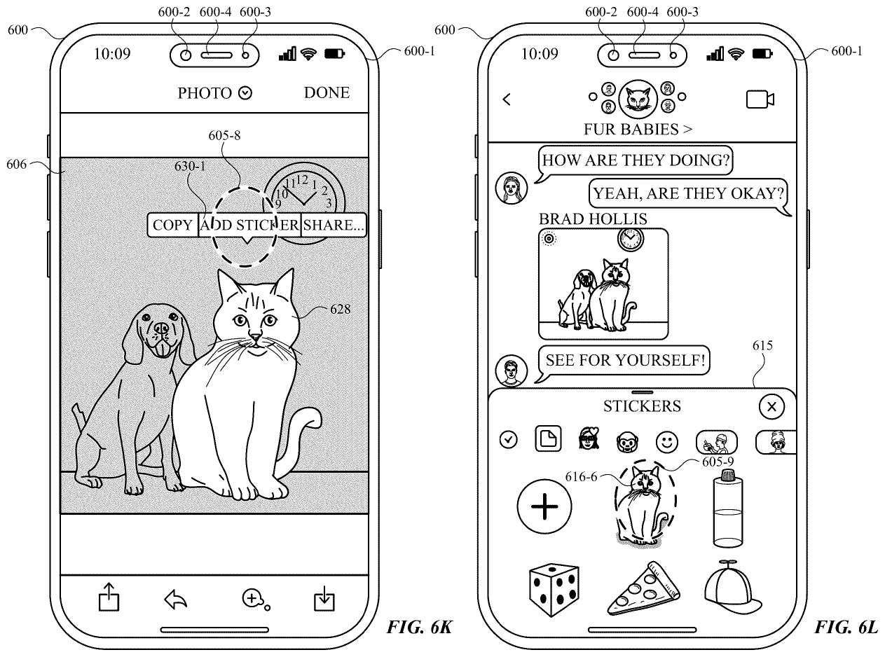

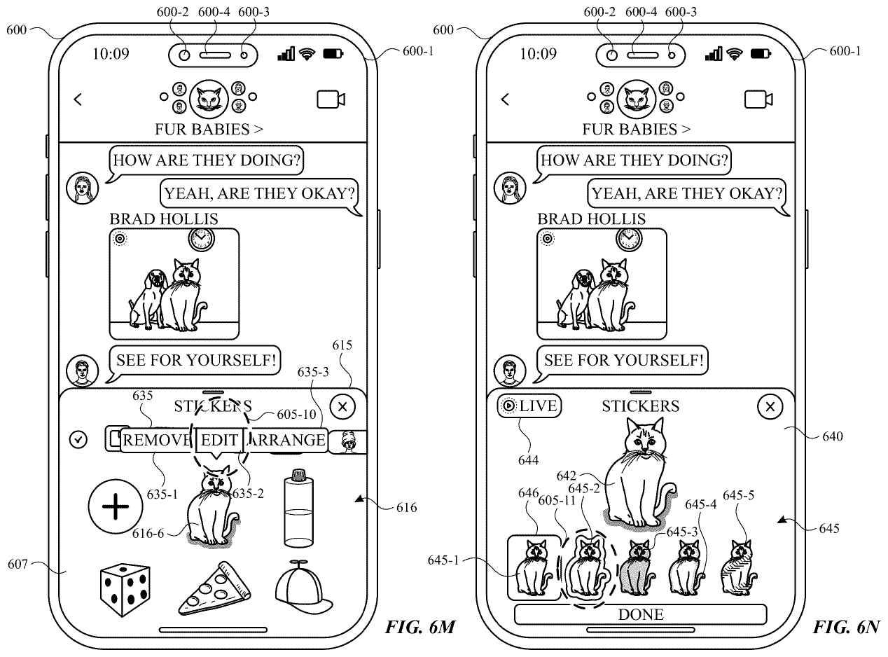

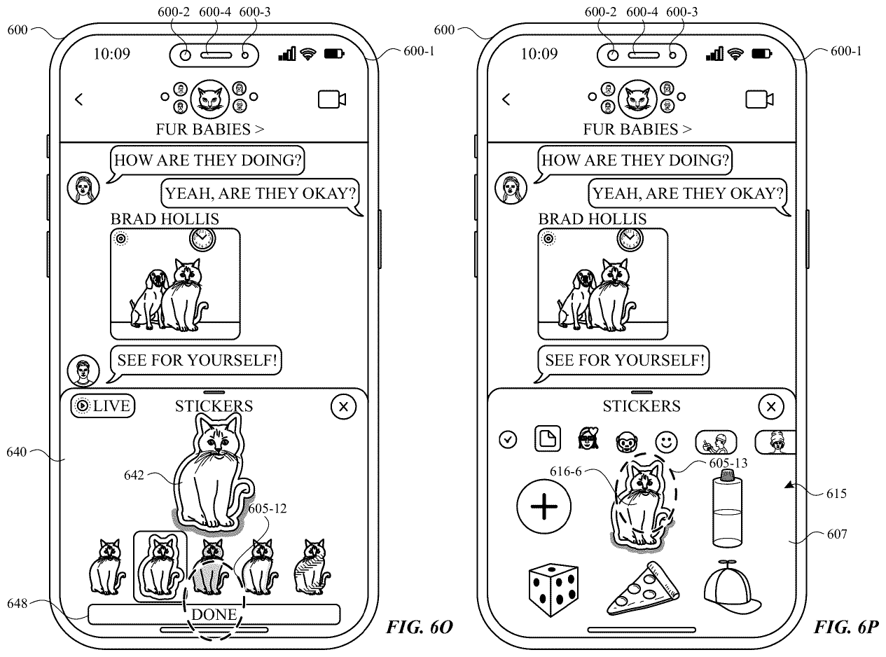

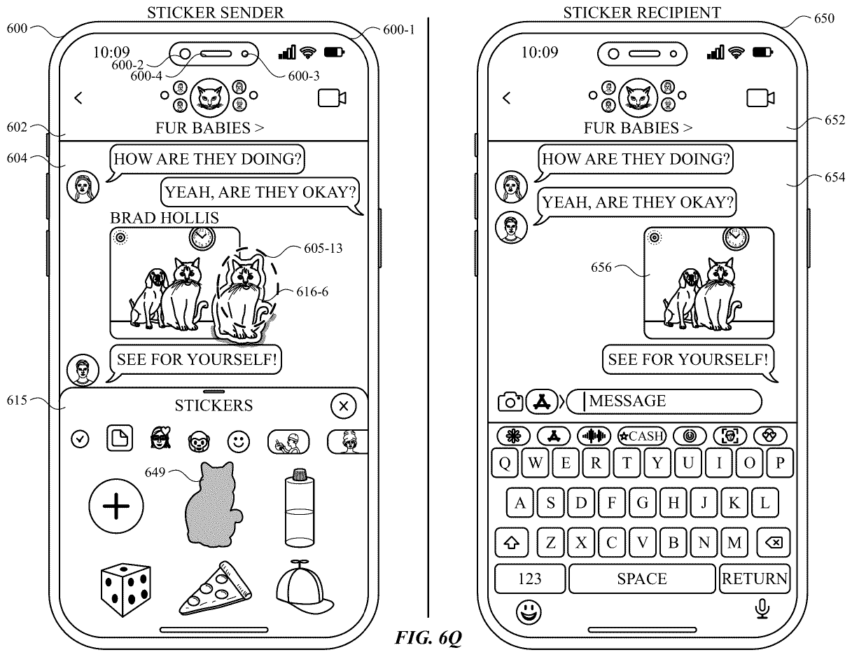

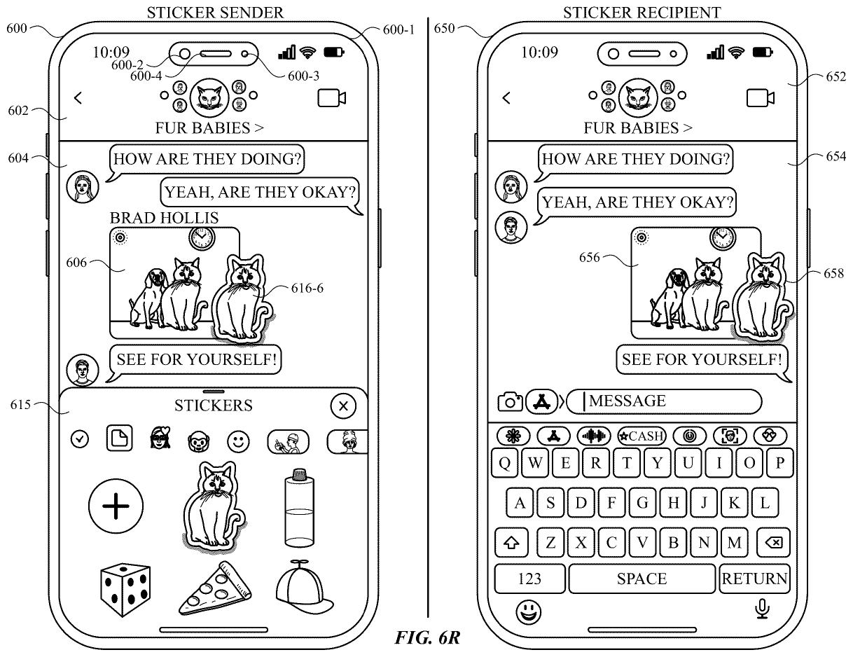

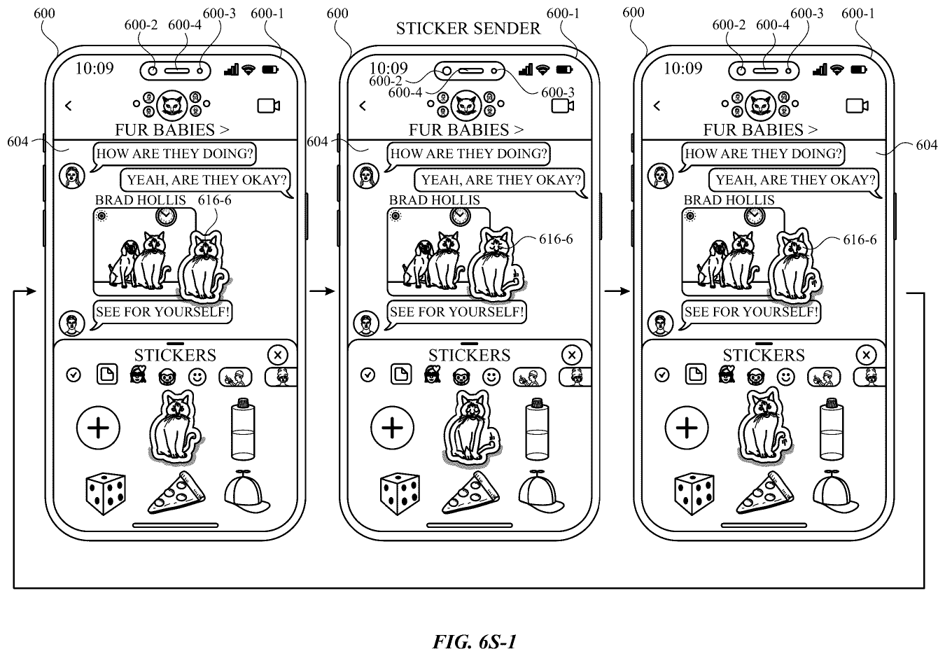

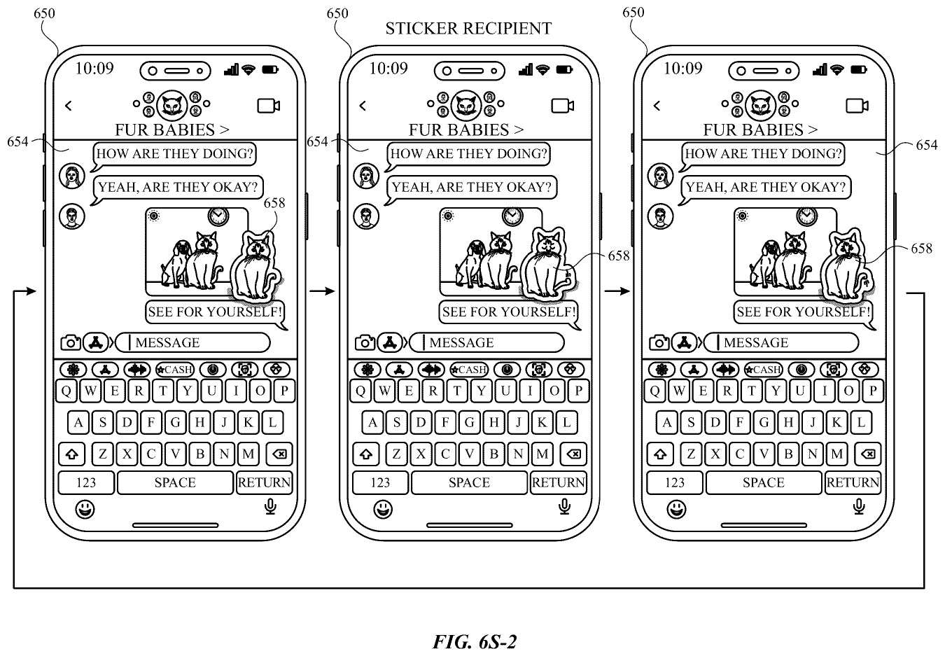

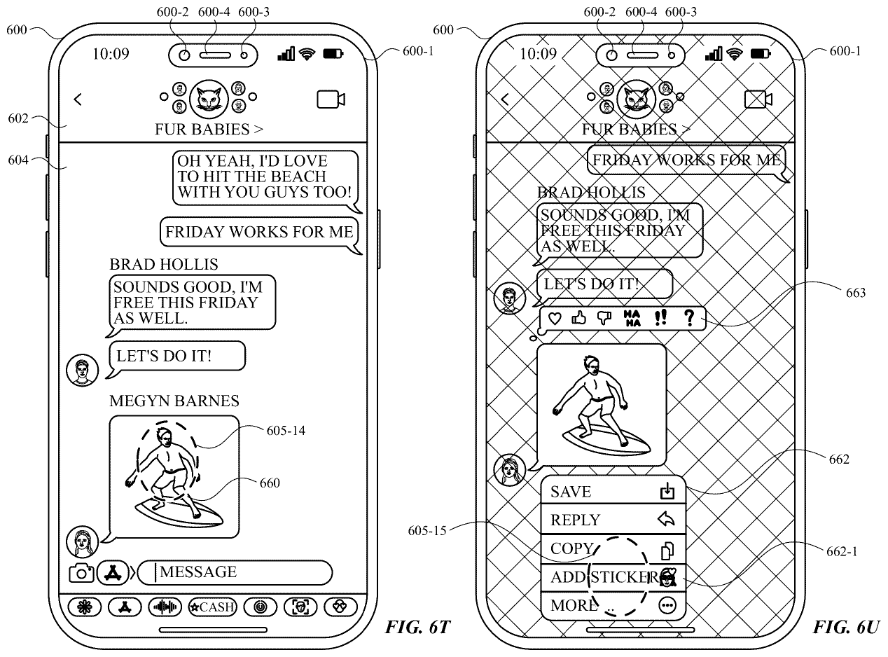

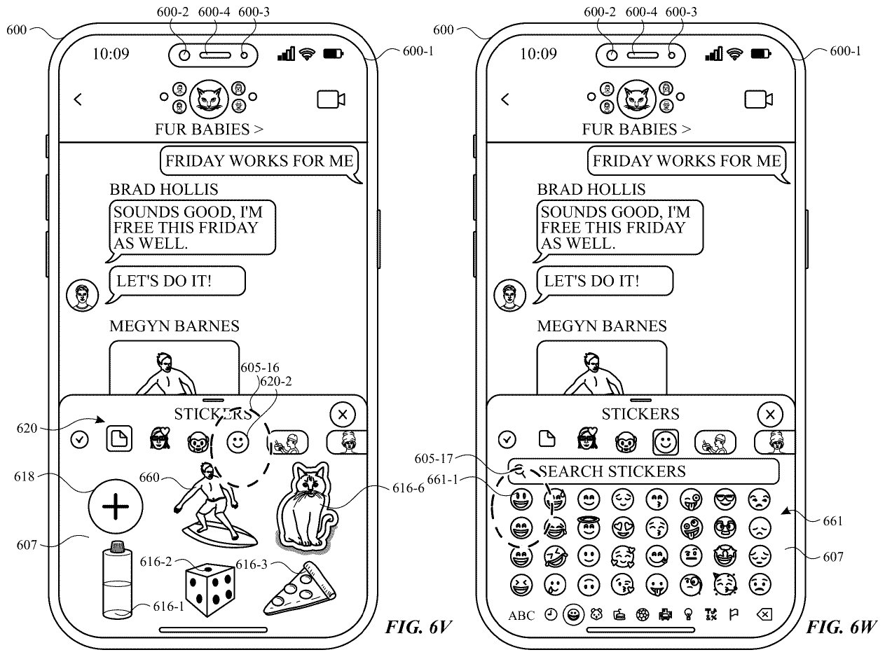

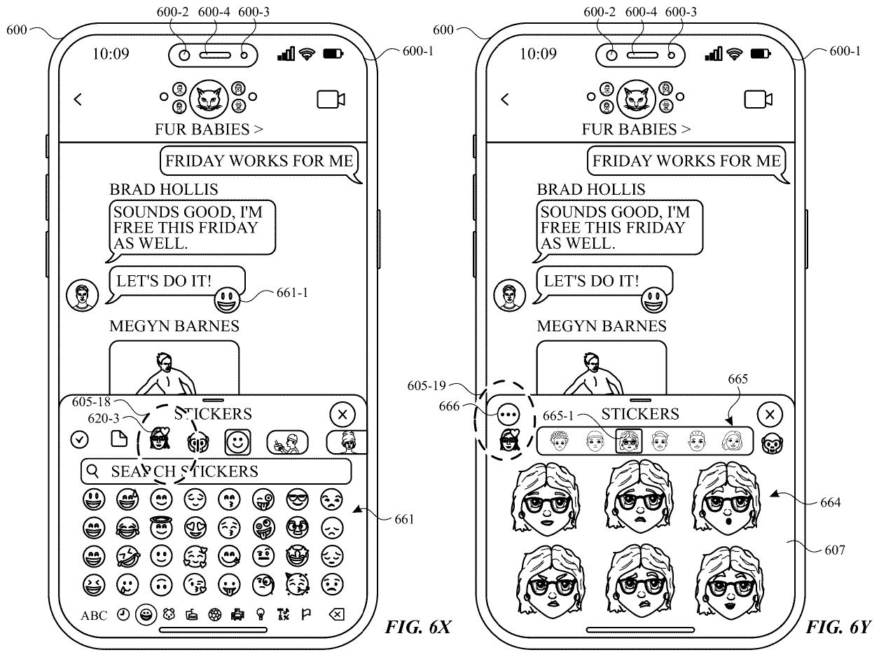

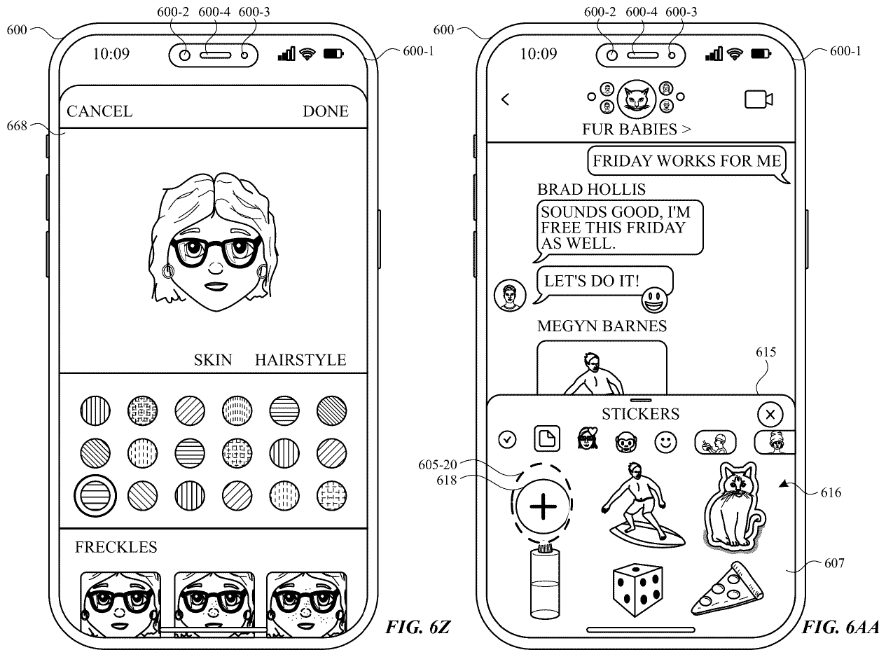

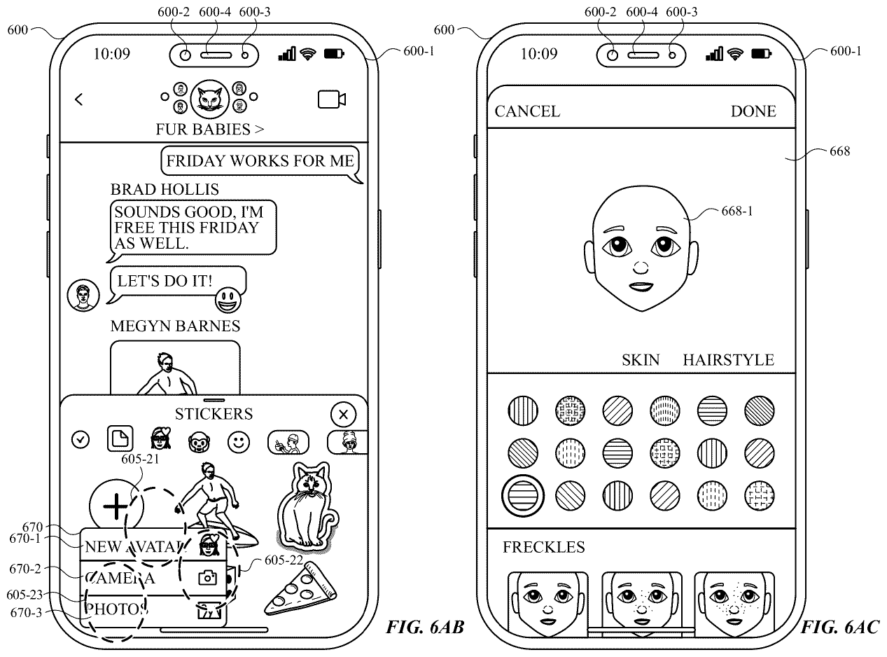

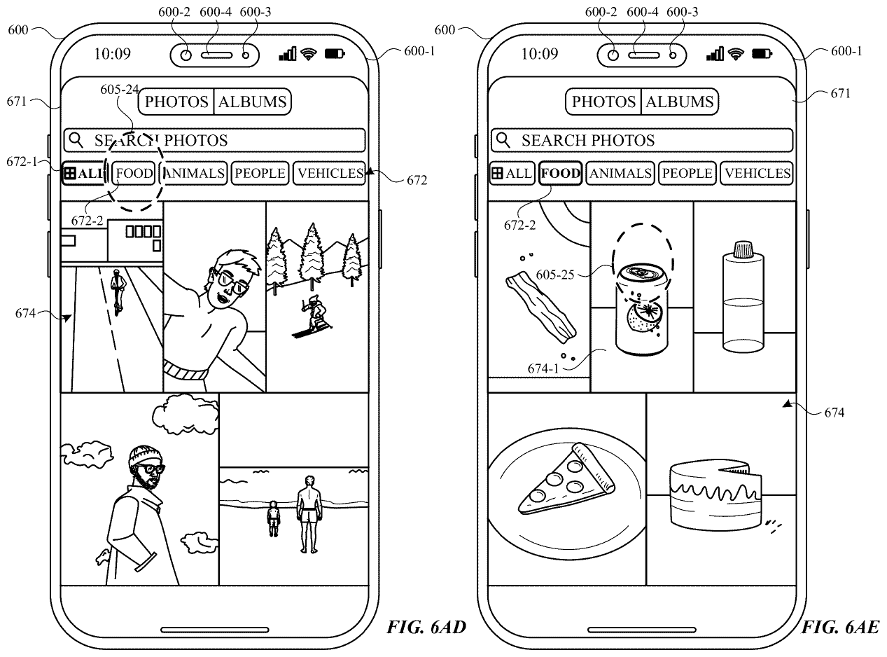

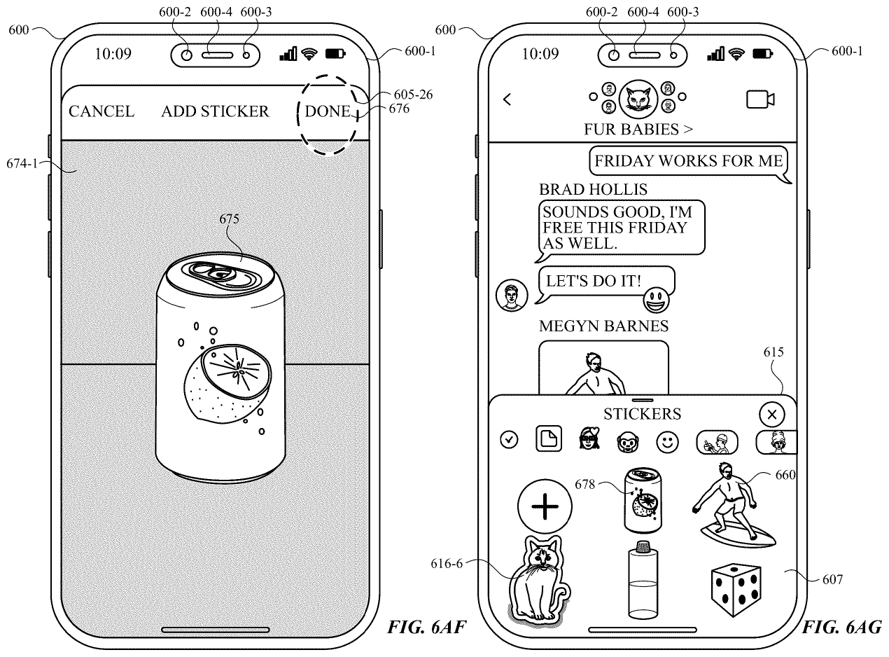

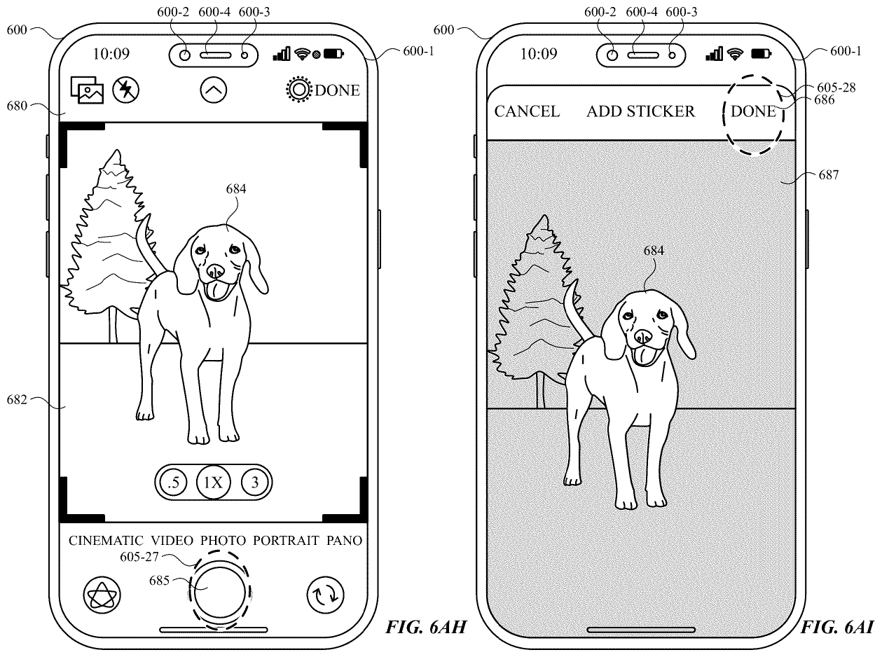

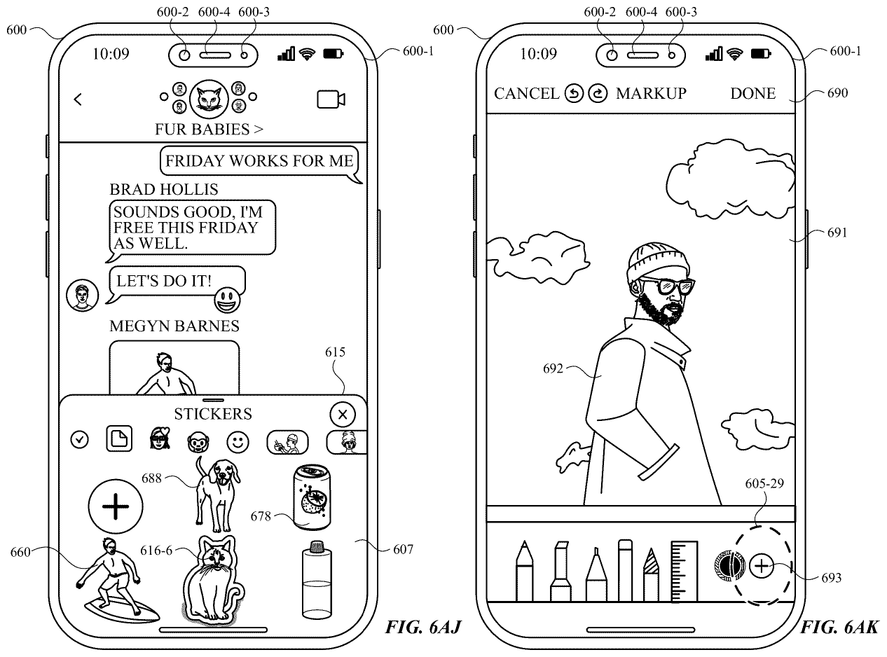

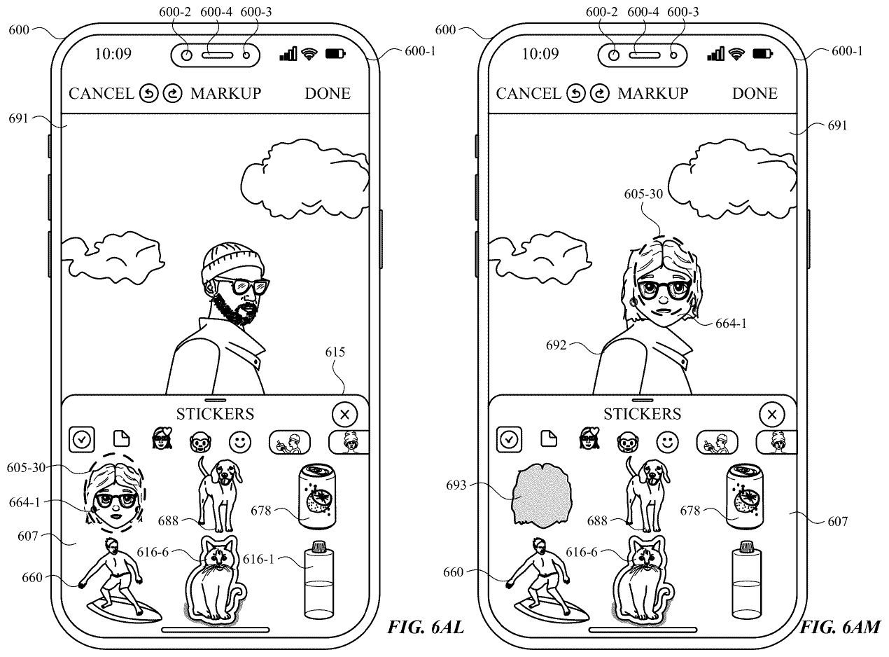

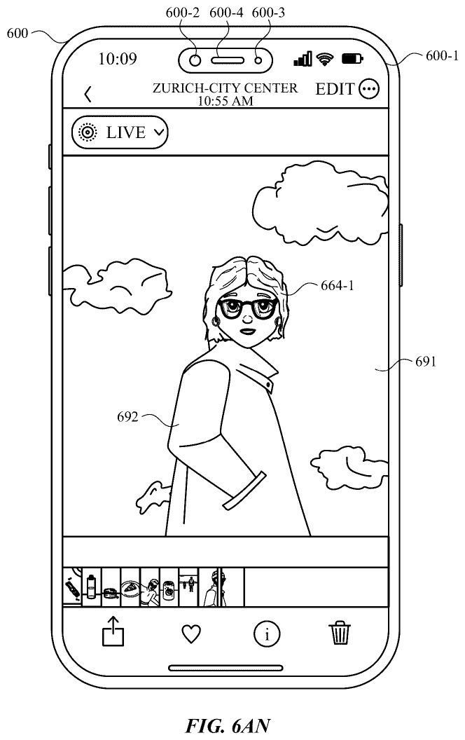

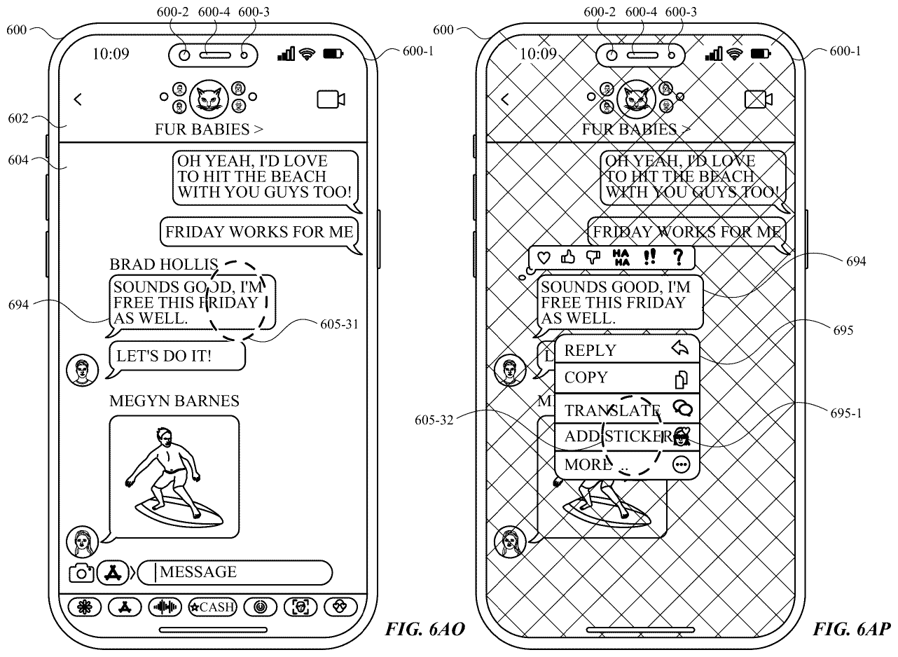

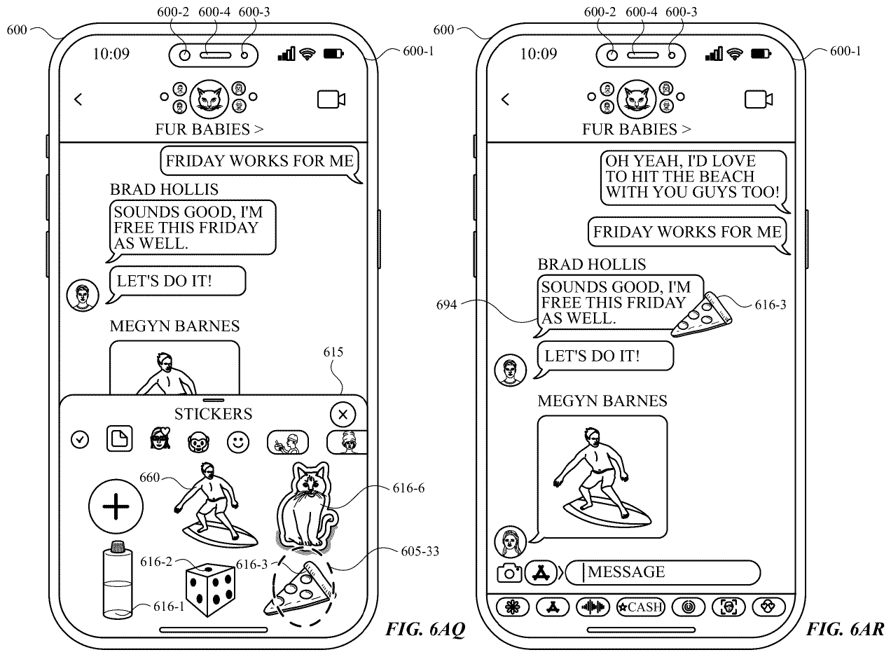

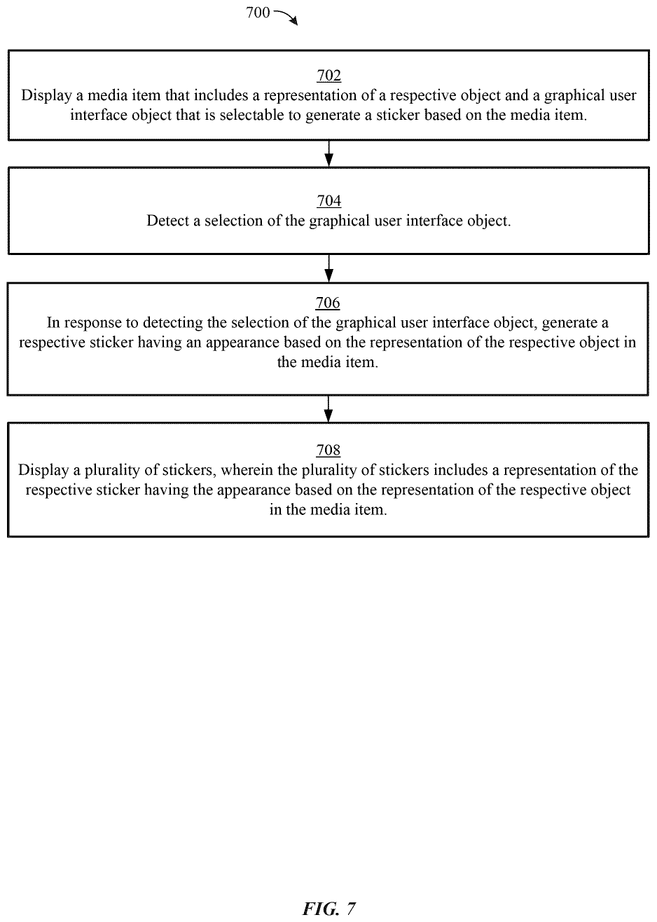

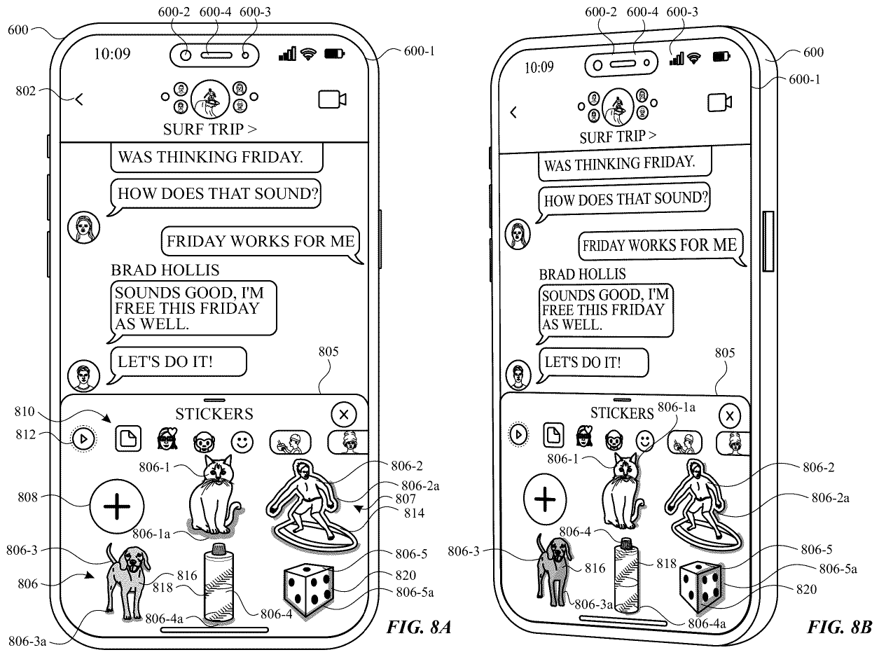

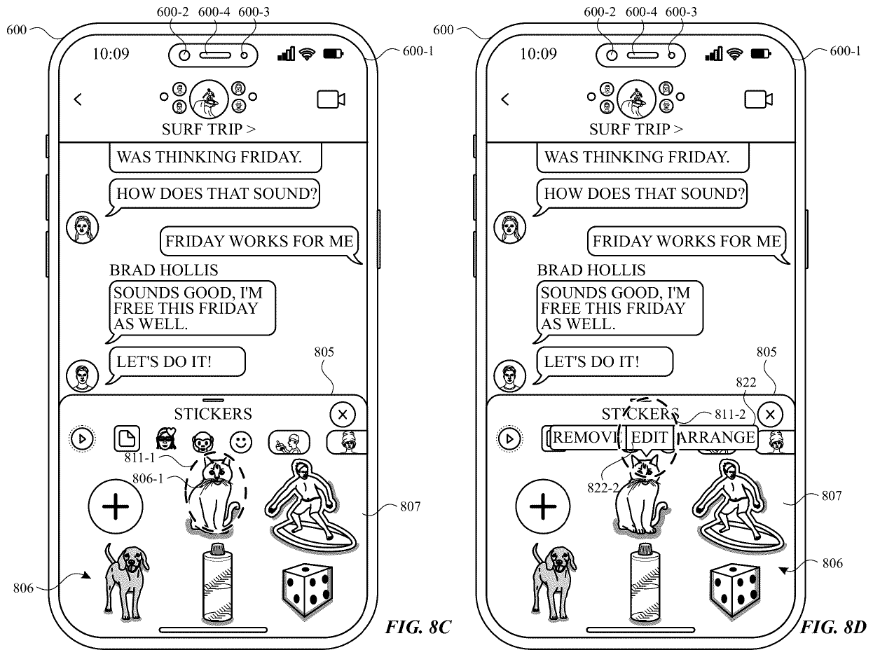

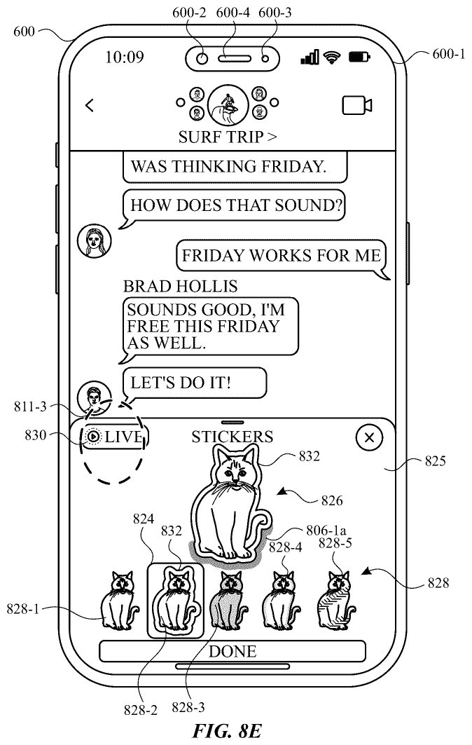

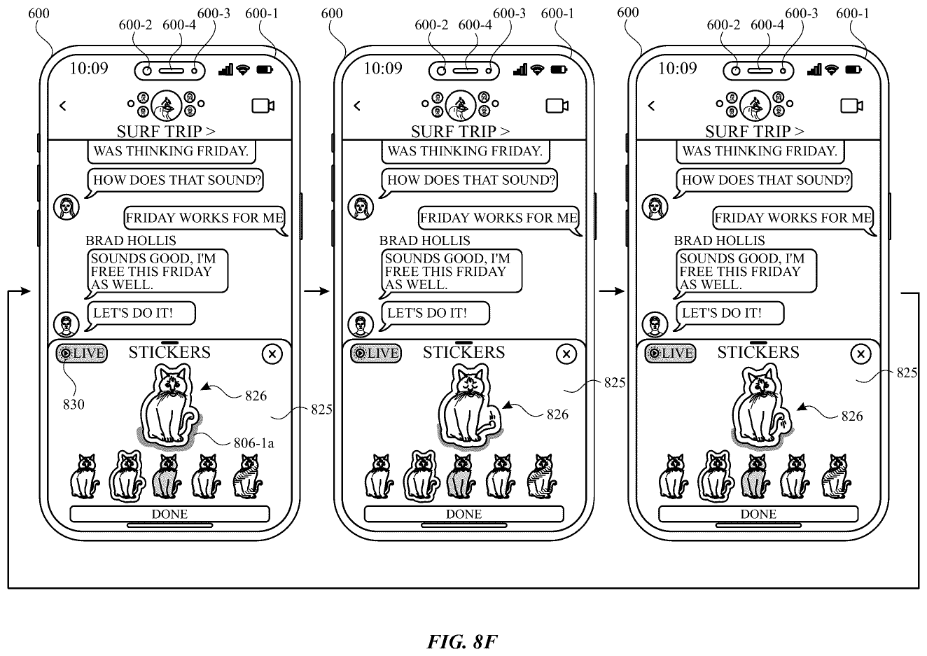

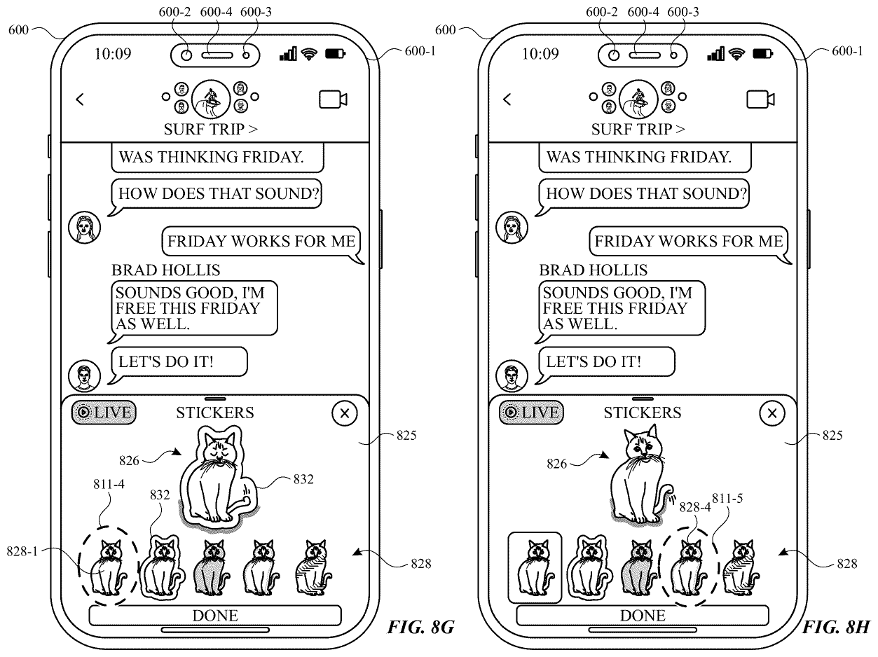

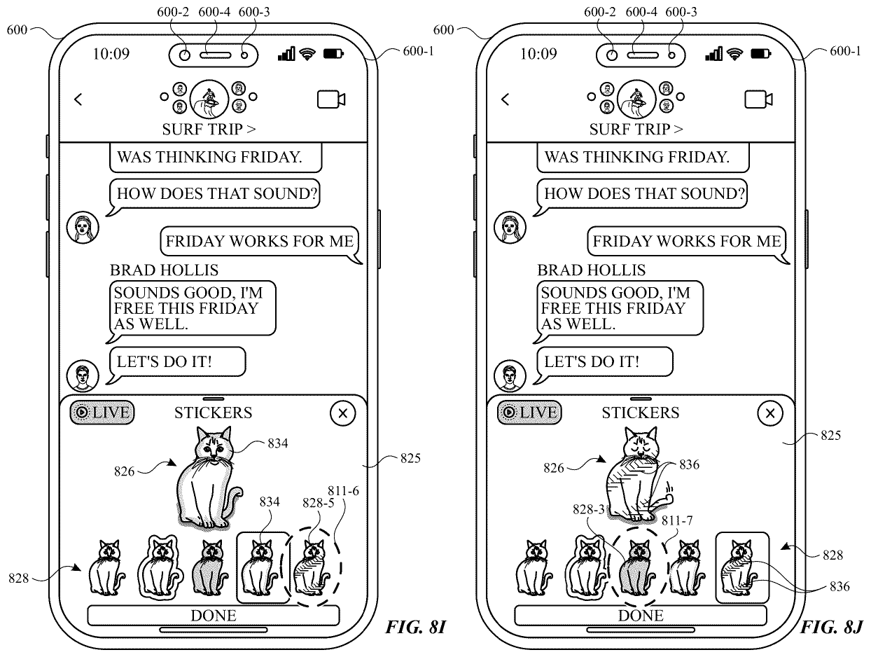

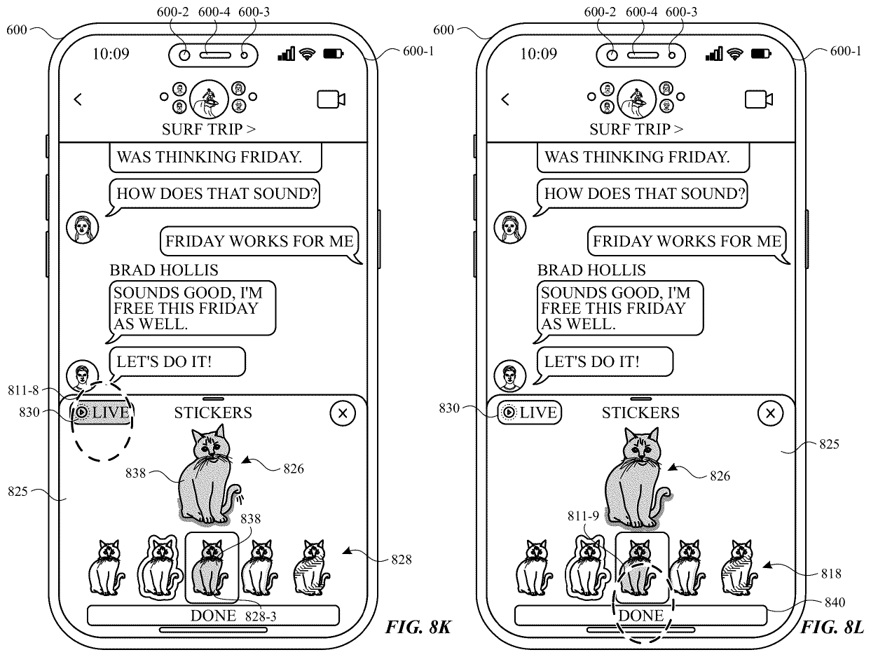

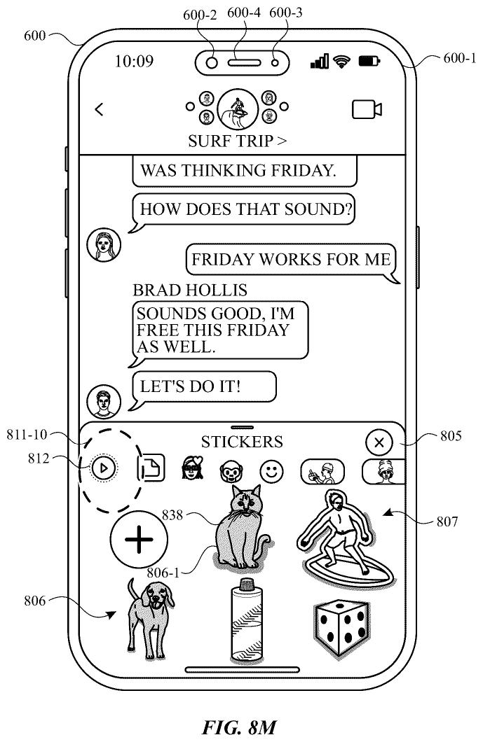

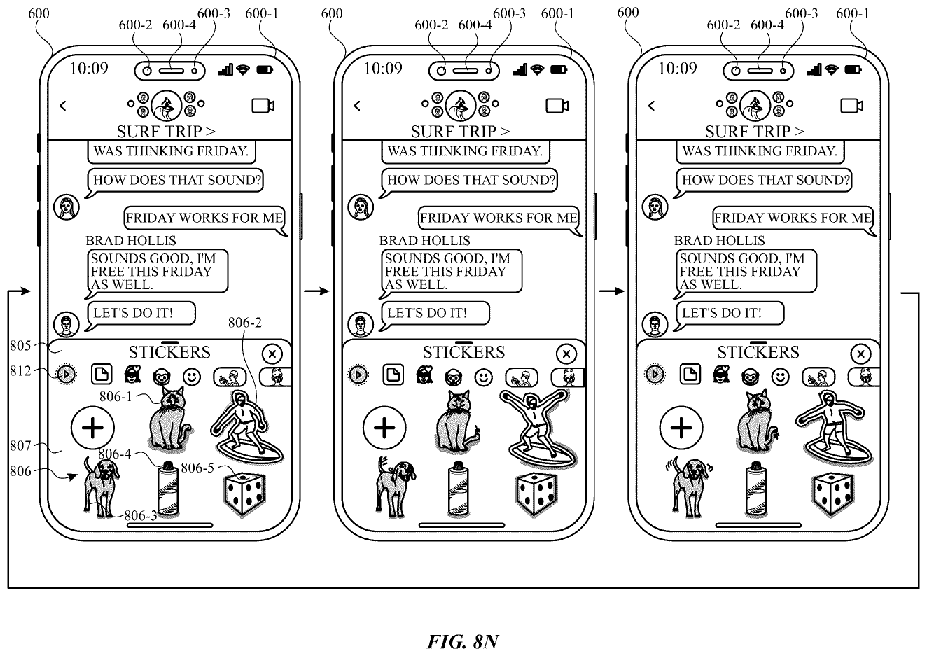

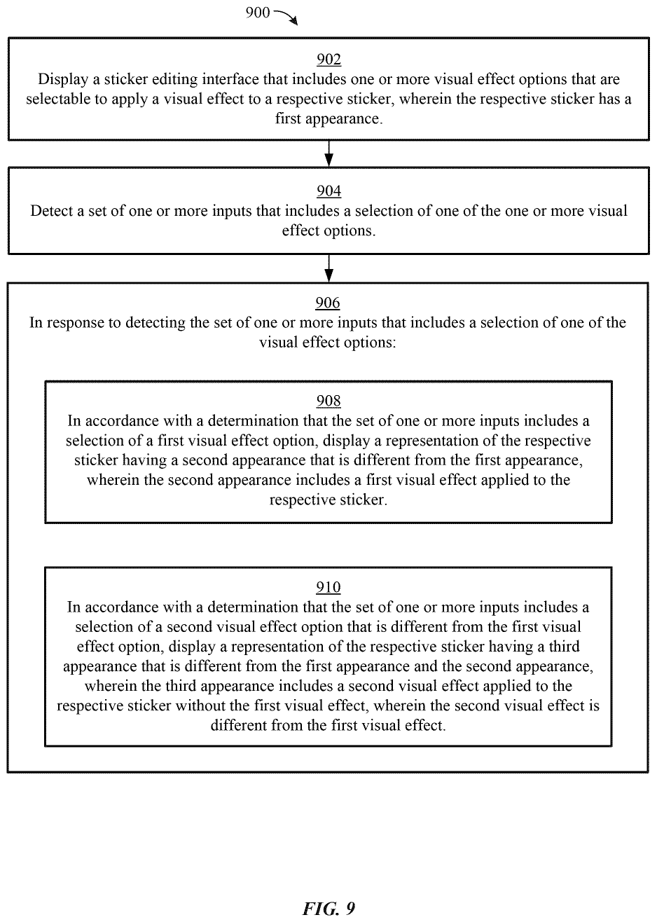

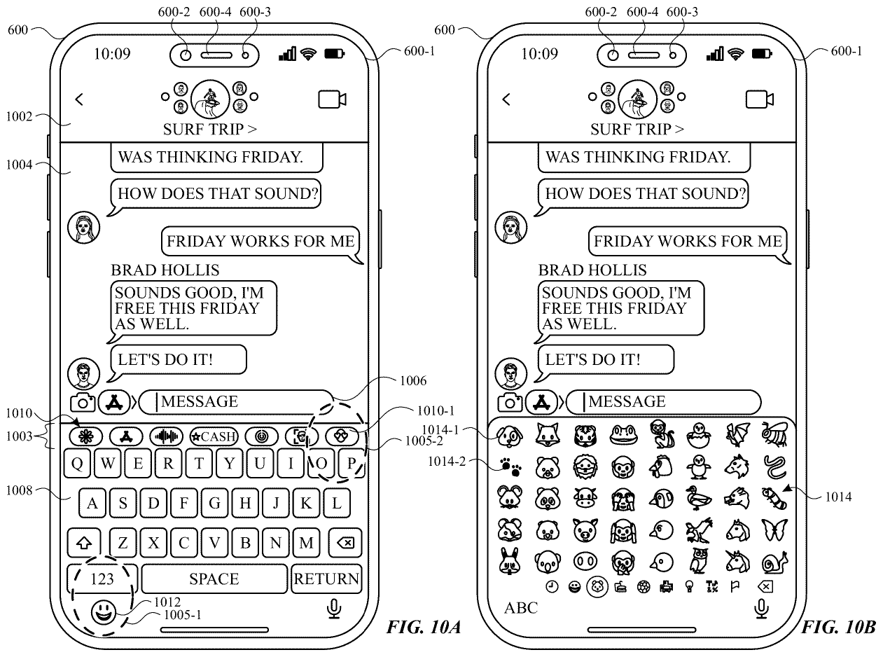

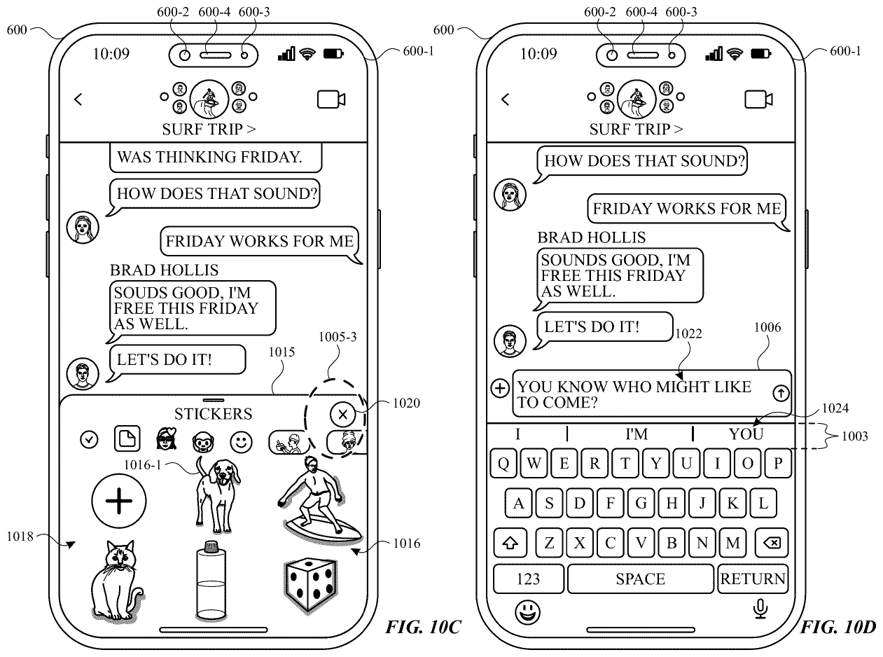

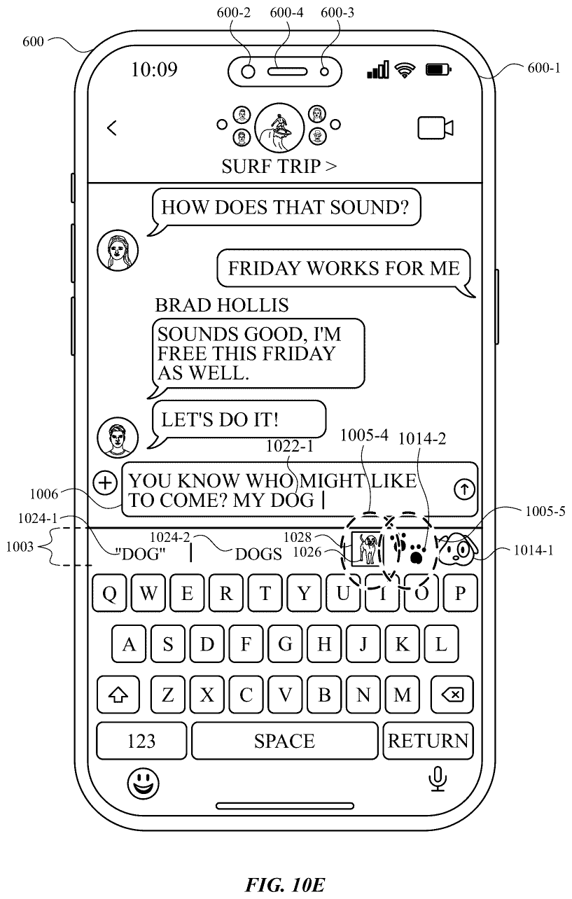

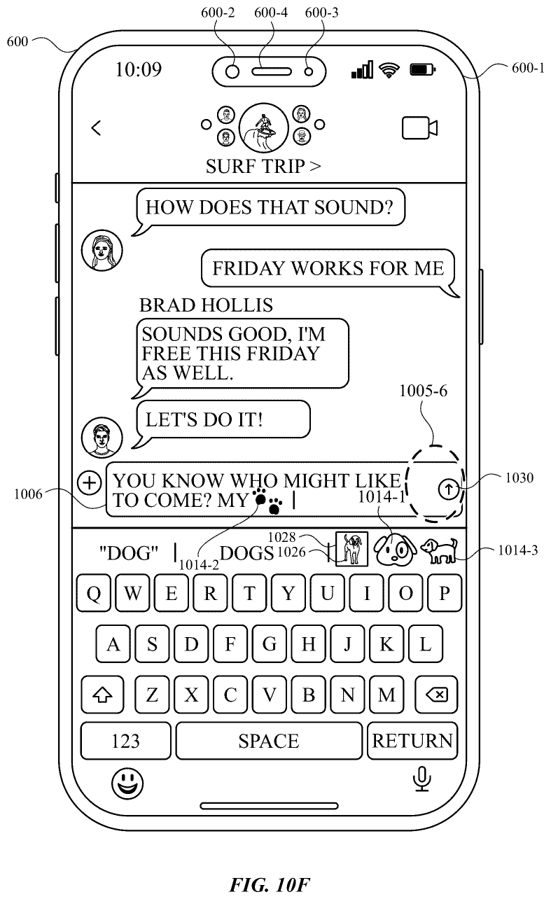

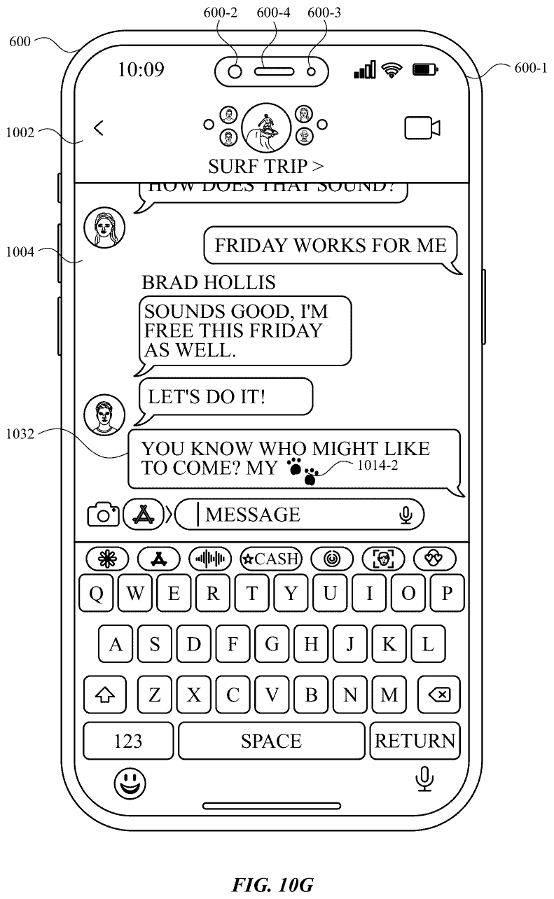

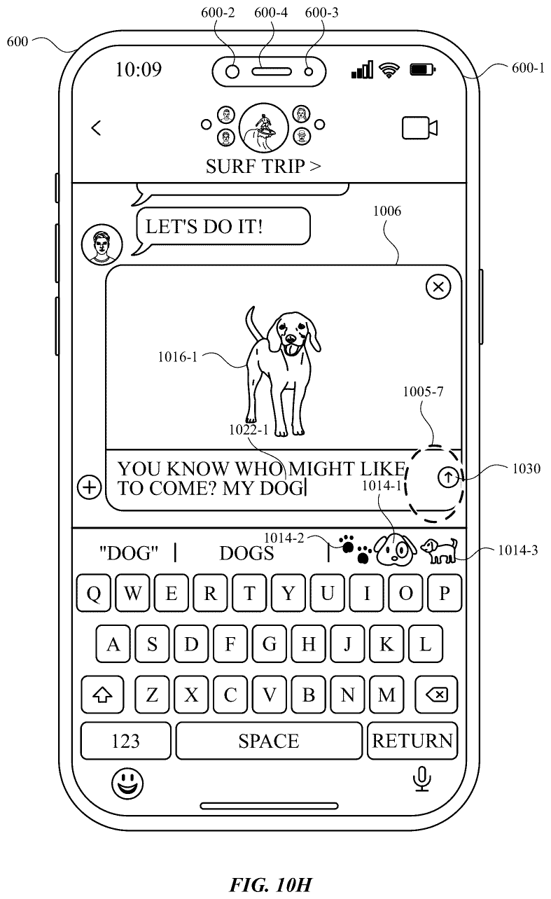

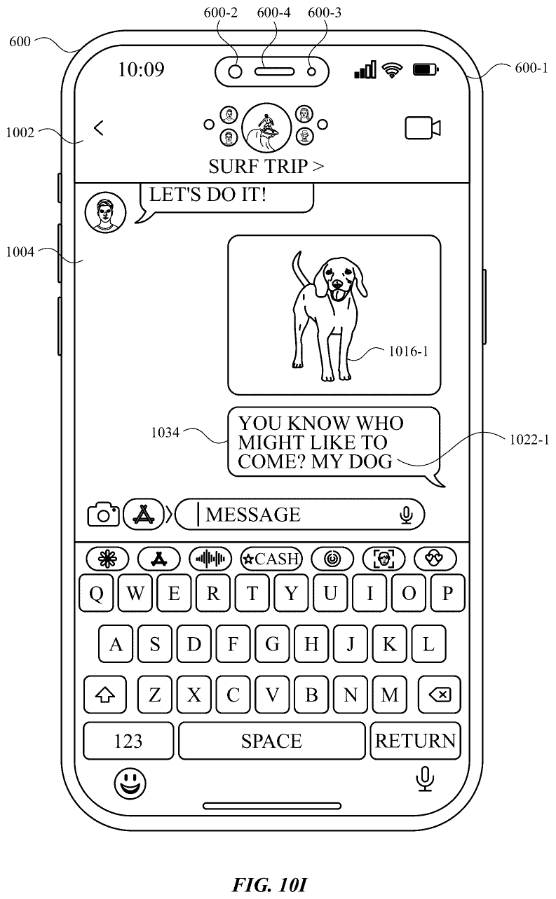

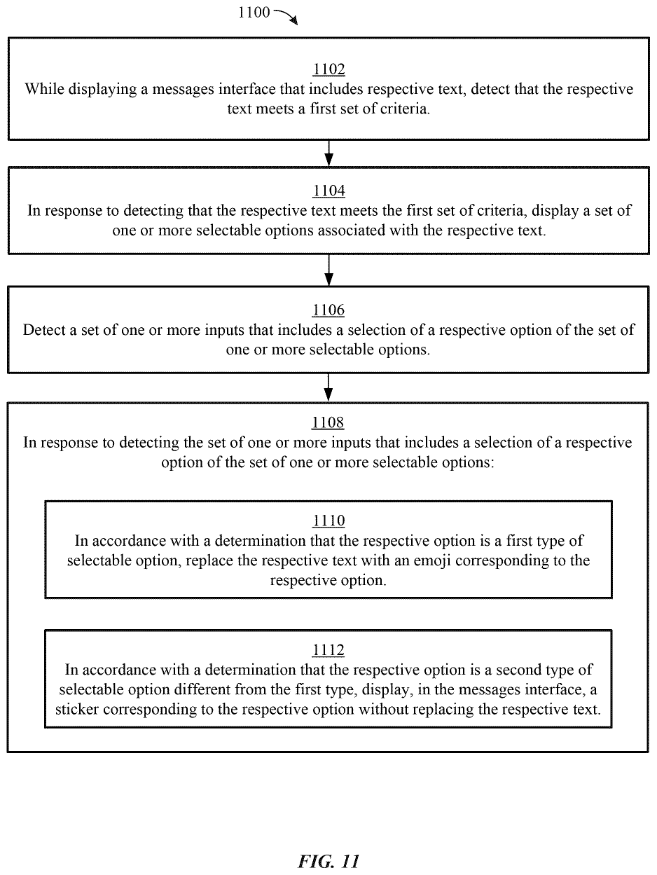

Below, FIGS. 1A-1B, 2, 3, 4A-4B, and 5A-5B provide a description of exemplary devices for performing the techniques for editing, creating, and using stickers. FIGS. 6A-6AR illustrate exemplary user interfaces for creating stickers. FIG. 7 is a flow diagram illustrating methods of creating stickers, in accordance with some embodiments. The user interfaces in FIGS. 6A-6AR are used to illustrate the processes described below, including the processes in FIG. 7. FIGS. 8A-8N illustrate exemplary user interfaces for editing stickers. FIG. 9 is a flow diagram illustrating methods of editing stickers, in accordance with some embodiments. The user interfaces in FIGS. 8A-8N are used to illustrate the processes described below, including the processes in FIG. 9. FIGS. 10A-10I illustrate exemplary user interfaces for using stickers. FIG. 11 is a flow diagram illustrating methods of using stickers, in accordance with some embodiments. The user interfaces in FIGS. 10A-10I are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved feedback (e.g., visual feedback) to the user, reducing the number of inputs needed to perform an operation, providing additional control options without cluttering the user interface with additional displayed controls, performing an operation when a set of conditions has been met without requiring further user input, providing an enhanced control scheme for performing an operation, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

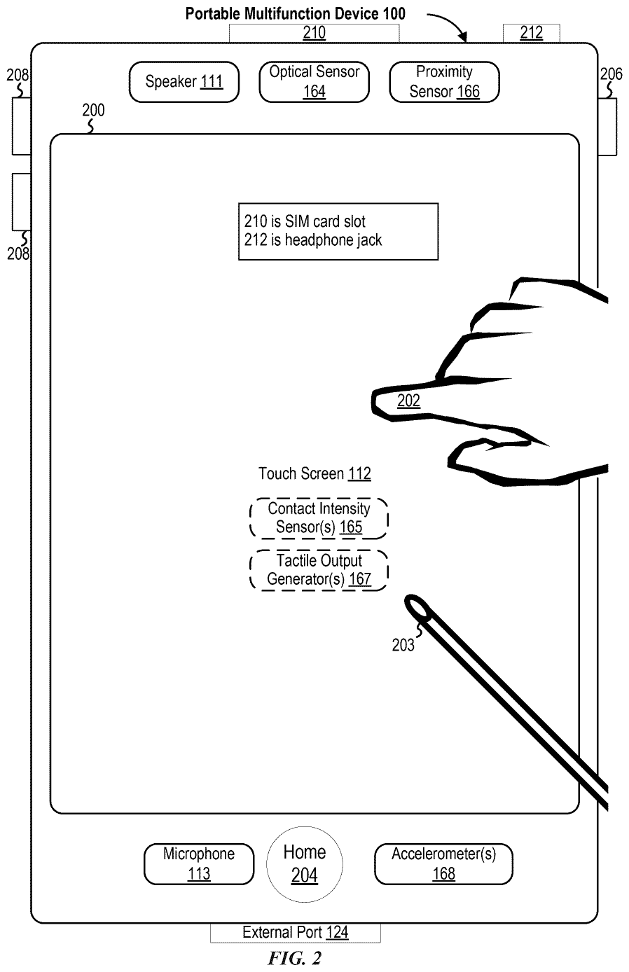

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

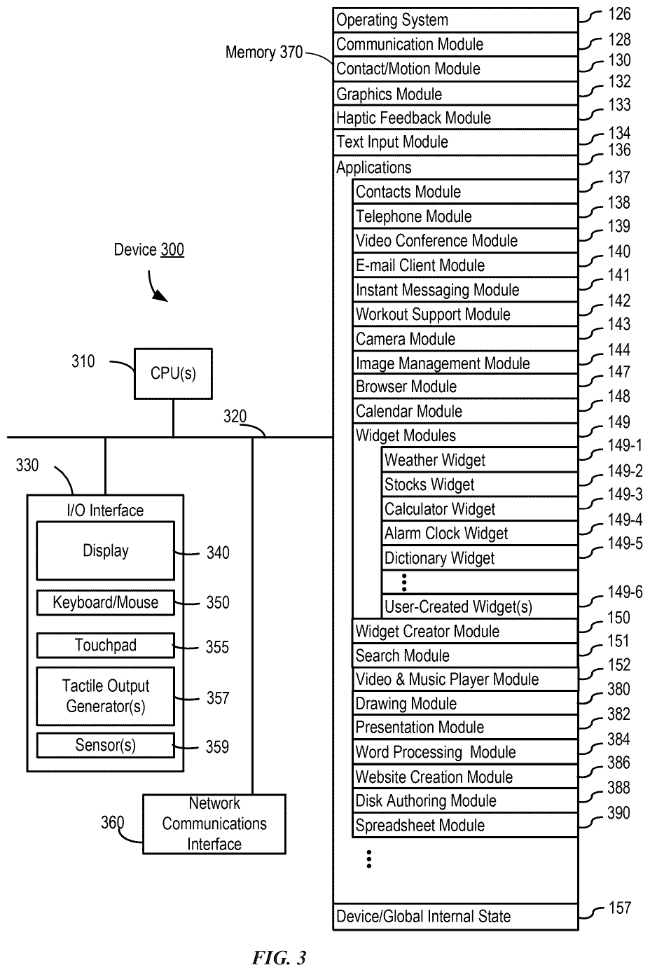

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

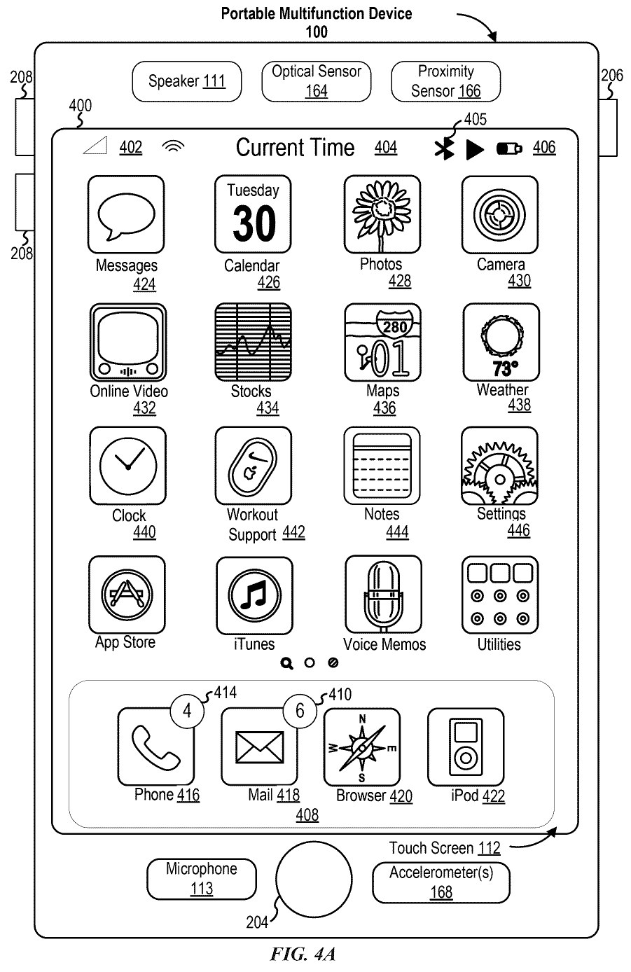

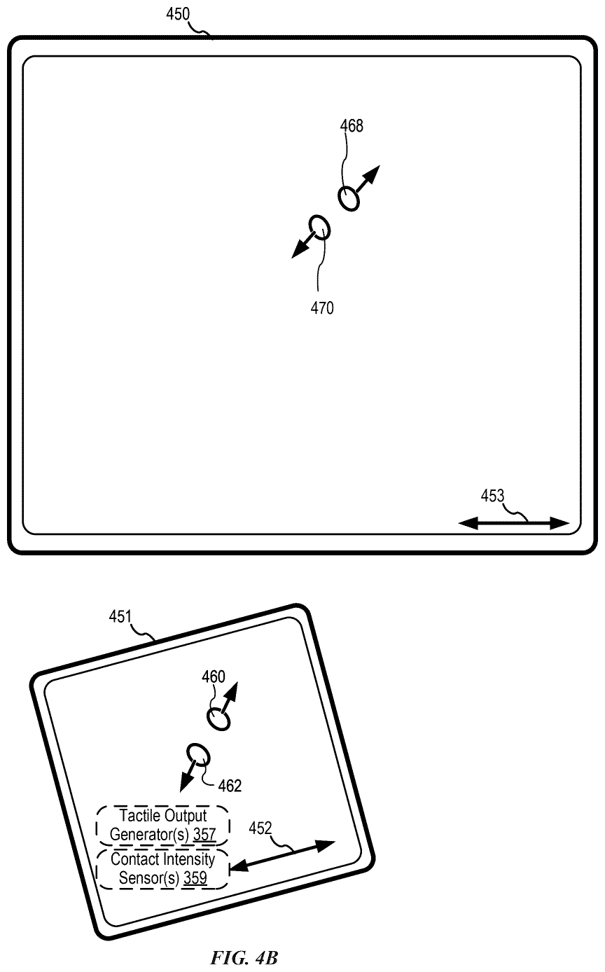

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contact 460 and contact 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

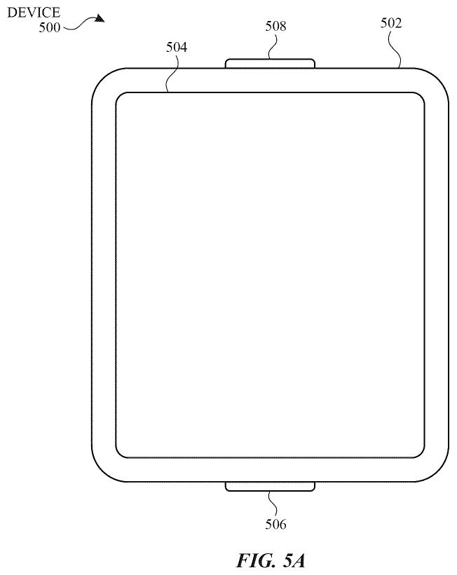

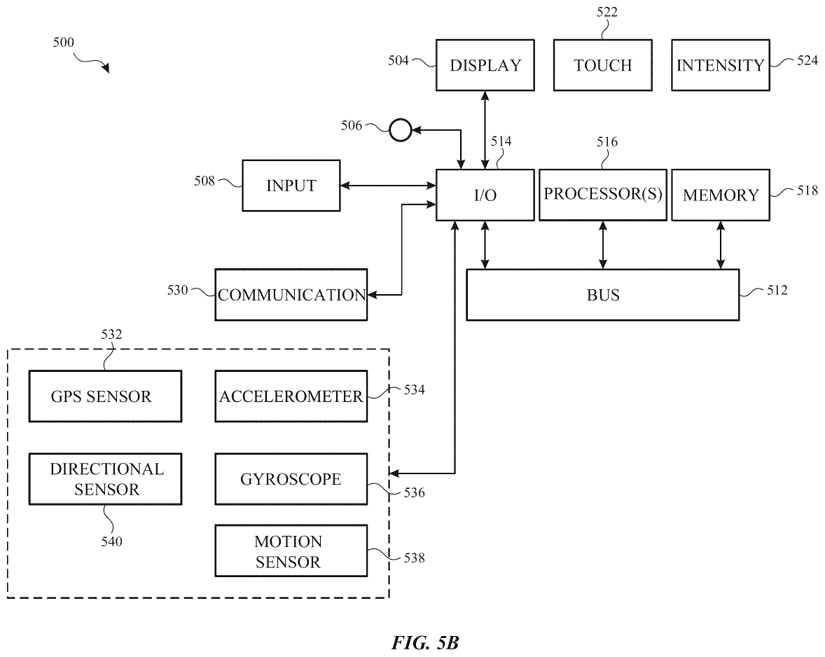

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1, and 3. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including processes 700, 900, and/or 1100 (FIGS. 7, 9, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6AR illustrate exemplary user interfaces for creating stickers, in accordance with some embodiments. The user interfaces in these figures are used to illustrate the processes described below, including the processes in FIG. 7. It should be appreciated that the stickers in FIGS. 6A-6AR can be edited using any of the techniques described below with respect to FIGS. 8A-8N and 9. Similarly, the stickers can be used in accordance with any of the techniques described below with respect to FIGS. 10A-10I and 11. For the sake of brevity, details are not repeated.

FIG. 6A illustrates device 600 (e.g., a smartphone), which is a computer system that includes display 600-1 (e.g., a touch-sensitive display), one or more cameras 600-2, one or more microphones 600-3, and one or more speakers 600-4 (e.g., similar to speaker 111). In some embodiments, device 600 includes one or more elements of devices 100, 300, and/or 500.

In FIG. 6A, device 600 displays, via display 600-1, messaging interface 602, which is a text message conversation with participants of a group called “Fur Babies.” Messaging interface 602 includes message conversation region 604, which includes content (e.g., messages, photos, links, information) sent and/or received among the participants. For example, photo 606 has been sent to the participants of the message conversation and, therefore, is shown in message conversation region 604. Specifically, photo 606 was sent from the user account of participant member Brad Hollis and is received by the other participants of the message conversation, including the user account associated with device 600. Messaging interface 602 also includes message compose field 608 and keyboard interface 610. Keyboard interface 610 can be used to provide content for the message conversation, which is displayed in message compose field 608 prior to being sent and subsequently displayed in message conversation region 604.

Keyboard interface 610 includes region 612, which includes various options 614 that can be selected for accessing content to be used for the messaging interface. In FIG. 6A, stickers option 614-1 is selected via input 605-1 (e.g., a tap or touch input directed to stickers option 614-1). In response to detecting input 605-1, device 600 displays sticker interface 615, as shown in FIG. 6B.

Sticker interface 615 includes stickers 616, sticker creation option 618, and sticker filter options 620. Stickers 616 are virtual, graphical objects that can be added to the message conversation or used in other ways, as described in greater detail below. Stickers 616 and sticker creation option 618 are displayed in sticker display region 607. In FIG. 6B, stickers 616 in sticker interface 615 include bottle sticker 616-1, die sticker 616-2, pizza sticker 616-3, hat sticker 616-4, and bacon sticker 616-5. Sticker creation option 618 can be selected to generate a new sticker, which can be displayed in sticker interface 615. Sticker filter options 620 are options that can be selected to filter or sort the stickers displayed in sticker display region 607 of sticker interface 615, as discussed in greater detail below. In FIG. 6B, user created sticker option 620-1 is selected, and sticker display region 607 includes stickers 616 that have been created or added by a user account associated with device 600.

In FIG. 6B, device 600 detects input 605-2, which is a selection of photo 606 in message conversation region 604. In response to detecting input 605-2, device 600 displays photo interface 622, as shown in FIG. 6C. Photo interface 622 displays selected photo 606, which is an image of clock 624, dog 626, and cat 628. In some embodiments, photo 606 is comprised of multiple image frames and, therefore, can be activated to display an animation. As shown in FIG. 6D, while device 600 detects input 605-3 (e.g., a sustained touch input) maintained on photo 606, device 600 displays a sequence of the image frames comprising photo 606, which provides an animated effect of the objects in photo 606. Specifically, device 600 displays a sequence of frame 606-1, frame 606-2, and frame 606-3 while input 605-3 is maintained on photo 606. Dog 626 and cat 628 have a first pose in frame 606-1, a second pose in frame 606-2, and a third pose in frame 606-3. Playback of the image frames with the changing poses provides the animation effect of dog 626 and cat 628. In some embodiments, such as that shown in FIG. 6D, the playback of the animation repeats one or more times, therefore providing a looping playback of the animation. Although photo 606 is shown as an image with multiple image frames, in some embodiments the image can be a video or an image having only a single image frame. When the image is a video, the image includes an animation similar to that described with respect to the image comprised of multiple image frames. When the image has only a single image frame, the image does not provide an animated effect.

FIGS. 6E-6K provide example interfaces for embodiments in which device 600 creates a sticker from one or more objects in an image. In FIG. 6E, device 600 detects input 605-4 selecting cat 628 in photo 606 of photo interface 622. In response, device 600 displays menu 630 and shading effect 632 indicating that cat 628 is selected as an object that can be used to generate a sticker.

In FIG. 6F, device 600 detects input 605-5 selecting add sticker option 630-1 from menu 630. In response to input 605-5, device 600 creates a new sticker that is based on the appearance of cat 628. In some embodiments, photo 606 is a single image frame and the resulting cat sticker (e.g., cat 628) does not have an animated effect. In some embodiments, photo 606 is comprised of multiple image frames and the resulting cat sticker has an animated effect (e.g., as shown in FIG. 6H). Device 600 displays the new sticker in sticker interface 615, as shown in FIG. 6G. Sticker display region 607 of sticker interface 615 is now updated to include cat sticker 616-6, which has an appearance that matches cat 628 in photo 606. In some embodiments, a created sticker can include various visual effects. For example, in FIG. 6G, cat sticker 616-6 includes simulated shadow effect 632. Other visual effects are discussed in greater detail below. In some embodiments, when a new sticker is created (e.g., cat sticker 616-6), the newly created sticker is associated with a user account used to create the sticker, and the sticker is synchronized across devices associated with the user account such that the sticker can be created on one device and accessed using a different device logged into the same user account.

In some embodiments, a created sticker can be displayed with an animated effect. For example, in FIG. 6H device 600 displays cat sticker 616-6 in sticker interface 615 having an animated effect that matches the animation of cat 628 in images 606-1 to 606-3 of FIG. 6D. As cat sticker 616-6 moves, device 600 also displays shadow effect 632 moving based on the changes in pose of cat sticker 616-6. In some embodiments, the animated effect is automatically enabled when the sticker is generated. In some embodiments, the sticker is generated without the animated effect, and the animated effect can be enabled in response to one or more inputs (e.g., as discussed with respect to any of FIGS. 8K-8N).

In some embodiments, device 600 automatically suggests or recommends an object from a photo for generating a sticker. For example, in FIG. 6I, device 600 automatically selects clock 624 and displays menu 630, including add sticker option 630-1, which can be selected to generate a new sticker having an appearance based on clock 624. A user can also select different objects from the photo. For example, in FIG. 6I a user selects dog 626 and cat 628 by tapping on the cat and dog (represented by input 605-6 overlapping both the cat and dog in photo 606). In response to detecting input 605-6, device 600 selects dog 626 and cat 628 (and deselects clock 624) and displays menu 630 as shown in FIG. 6J. The user can generate a sticker having an appearance based on dog 626 and cat 628 by selecting add sticker option 630-1 in FIG. 6J.

In some embodiments, a user can modify a selection of an object in an image to generate a sticker based on the modified selection. For example, in FIG. 6J device 600 shows dog 626 and cat 628 selected for sticker creation. In response to input 605-7, device 600 modifies the selection of dog 626 and cat 628 to include the selection of cat 628 only. As shown in FIGS. 6J and 6K, input 605-7 is a touch-and-drag input that starts at a perimeter region of dog 626 and moves towards cat 628. When input 605-7 terminates at a perimeter region of cat 628, device 600 modifies the selection of the dog and cat to include only the selection of cat 628, as shown in FIG. 6K. In response to input 605-8 selecting add sticker option 630-1, the cat sticker is then generated and added to sticker interface 615. The embodiment provided in FIGS. 6J and 6K offer one example for modifying the boundaries of an object selected for sticker creation. Accordingly, the boundaries can be modified in other ways such as, for example, tapping on cat 628 when both the dog and cat are selected, accessing a menu that enables a user to move or select boundaries of objects selected for sticker creation, displaying different shading or selection options that enable a user to select or choose between different sets or subsets of objects for sticker creation, or any combination thereof.

FIGS. 6L-60 provide example interfaces for embodiments in which device 600 edits an appearance of a user-created sticker. In FIG. 6L, device 600 detects input 605-9 (e.g., a tap input or a touch-and-hold input) selecting cat sticker 616-6 in sticker interface 615. In response to input 605-9, device 600 displays menu 635. Menu 635 includes remove option 635-1, edit option 635-2, and arrange option 635-3. Remove option 635-1 can be selected to delete sticker 616-6 from sticker interface 615. In some embodiments, selecting remove option 635-1 deletes sticker 616-6 from device 600 and, optionally, at other devices associated with the user account used to create sticker 616-6. Edit option 635-2 can be selected to display an editing interface for editing an appearance of the sticker. Arrange option 635-3 can be selected to enable a mode in which stickers in sticker display region 607 can be rearranged (e.g., moved, reordered) in sticker interface 615. In some embodiments, sticker interface 615 can be expanded (e.g., in response to a touch and upward drag input at the top of sticker interface 615) to increase the size of sticker display region 607 and display additional stickers on display 600-1. In some embodiments, the expanded sticker interface can be scrolled to view additional stickers in the interface.

In FIG. 6N, device 600 displays sticker editing interface 640 in response to input 605-10 selecting edit option 635-2 in FIG. 6M. Sticker editing interface 640 is a user interface for modifying an appearance of a respective sticker. For example, sticker editing interface 640 can be used to apply a visual effect to the sticker, to change the visual effect applied to the sticker, to remove a visual effect from the sticker, and/or to enable or disable an animated effect of the sticker. In FIG. 6N, sticker editing interface 640 displays representation 642 of cat sticker 616-6, live option 644, and visual effect options 645. Representation 642 provides an enlarged view of cat sticker 616-6 so that a user can more easily view the appearance of the sticker and any changes to the appearance of the sticker using sticker editing interface 640. Live option 644 can be selected to enable or disable an animated effect, such as the animated effect illustrated in FIG. 6H. Visual effect options 645 include null option 645-1 which provides no visual effect (or removes a previously applied visual effect). Null option 645-1 is currently selected in FIG. 6N, as indicated by border 646. Visual effect options 645 also include outline option 645-2, comic book effect option 645-3, three-dimensional effect option 645-4 (e.g., a puffy effect option), and iridescent option 645-5. In some embodiments, device 600 automatically selects one of the visual effect options when sticker editing interface 640 is displayed. Sticker editing interface 640, including visual effect options 645, are described in greater detail with respect to FIGS. 8A-8N and 9. In some embodiments, when a new sticker is created, device 600 automatically displays editing interface 640 with the newly created sticker and corresponding visual effect options (e.g., without requiring selection of the new sticker and/or selection of edit option 635-2 in sticker interface 615).

In FIG. 6N, device 600 detects input 605-11 selecting outline option 645-2 and, in response, updates representation 642 to have an outline visual effect as shown in FIG. 6O. Device 600 detects input 605-12 selecting done option 648 and, in response, displays sticker interface 615 with cat sticker 616-6 having the outline visual effect applied, as shown in FIG. 6P.

FIGS. 6P-6S-2 provide example interfaces for an embodiment in which cat sticker 616-6 is added to the message conversation in messaging interface 602 via a simulated “peel-and-stick” type of behavior. In FIG. 6P, device 600 detects input 605-13 selecting cat sticker 616-6. While input 605-13 is maintained and moved across display 600-1, cat sticker 616-6 is removed (e.g., “peeled”) from sticker interface 615, leaving silhouette 649 in the shape of cat sticker 616-6 at the location in sticker interface 615 previously occupied by cat sticker 616-6, and cat sticker 616-6 is dragged from sticker interface 615 onto message conversation region 604, as shown in FIG. 6Q. Because input 605-13 has not terminated in FIG. 6Q, cat sticker 616-6 has not been placed in message conversation region 604. Accordingly, the cat sticker is not visible at the devices of other participants of the message conversation.

For example, device 650 represents a device of a different participant of the fur babies message conversation. Device 650 is similar to device 600 and displays messaging interface 652 (similar to messaging interface 602) with message conversation region 654 and photo 656 (similar to message conversation region 604 and photo 606, respectively). Because cat sticker 616-6 has not yet been placed on message conversation region 604 of device 600, the sticker is not yet added to the message conversation and, therefore, is not visible in message conversation region 654 of device 650.

In FIG. 6R, device 600 detects termination of input 605-13 and places (e.g., “sticks”) cat sticker 616-6 onto the message conversation in messaging interface 602 at the location at which cat sticker 616-6 was displayed when input 605-13 was terminated. Accordingly, cat sticker 616-6 is displayed on photo 606 in message conversation region 604 of device 600 (and a second instance of the cat sticker is redisplayed in sticker interface 615). Because cat sticker 616-6 has been added to the message conversation by device 600, device 650 displays cat sticker 658 (similar to cat sticker 616-6) at the corresponding location on photo 656 in message conversation region 654. In some embodiments, a sticker can be added to the message conversation as an attachment. An example of such an embodiment is described in greater detail with respect to FIGS. 10A-10I and 11.

FIGS. 6S-1 and 6S-2 illustrate an animated effect of the sticker placed in the message conversation region as described above with respect to FIG. 6R. FIG. 6S-1 depicts device 600 showing animation of cat sticker 616-6 after it is placed on message conversation region 604. FIG. 6S-2 depicts device 650 showing corresponding animation of cat sticker 658 after it is displayed on message conversation region 654. In some embodiments, the animation of sticker 616-6 and/or sticker 658 repeats on loop or for a predetermined number of times. In some embodiments, the animation of the stickers is played one time without repeating. In some embodiments, animation of the sticker can be enabled or disabled.

FIGS. 6T-6V depict example interfaces for an embodiment in which a received sticker is added to the sticker interface. In FIG. 6T, device 600 receives surfer sticker 660 as an attachment sent from one of the participants of the fur babies message conversation. In response to detecting input 605-14 on sticker 660, device 600 displays menu 662, which includes add sticker option 662-1 as shown in FIG. 6U. Device 600 detects input 605-15 on add sticker option 662-1 and, in response, adds surfer sticker 660 to sticker interface 615 as shown in FIG. 6V. Newly created or added stickers, such as surfer sticker 660, can be edited and/or used as described with respect to other stickers described herein. In some embodiment, device 600 displays menu 663 in response to detecting input 605-14. In some embodiments, menu 663 includes an option that is similar to add sticker option 662-1 and is selectable to add surfer sticker 660 to sticker interface 615. In some embodiments, menu 663 includes other sticker options such as an option that is selectable to display sticker interface 615.

FIGS. 6V-6Z depict example interfaces for interacting with sticker interface 615. In FIG. 6V, device 600 detects input 605-16 selecting emoji sticker option 620-2 from sticker filter options 620 and, in response, replaces the objects in sticker display region 607 (e.g., sticker creation option 618 and stickers 660, 616-6, 616-1, 616-2, and 616-3) with emoji stickers 661. Emoji stickers 661 are emojis that have a sticker behavior (e.g., they can be peeled and stuck in a manner similar to stickers 616). In FIG. 6W, device 600 detects input 605-17, which selects emoji sticker 661-1 and places it on message conversation region 604 as shown in FIG. 6X. In FIG. 6X, device 600 detects input 605-18 selecting avatar sticker option 620-3 and, in response, replaces emoji stickers 661 with avatar stickers 664 in sticker display region 607, as shown in FIG. 6Y.

Avatar stickers 664 are similar in behavior to stickers 616, but are generated based on an appearance of an avatar rather than an object in a media item. When avatar sticker option 620-3 is selected, sticker filter options 620 is expanded to include avatar options 665, which represent different sets of avatar stickers. In FIG. 6Y, avatar option 665-1 is currently selected, and avatar stickers 664 have an appearance that is based on the avatar corresponding to avatar option 665-1. Different avatar options 665 can be selected to replace avatar stickers 664 with avatar stickers that correspond to the appearance of the selected avatar option.

In some embodiments, avatar stickers can be edited by editing the appearance of the corresponding avatar. In FIG. 6Y, device 600 detects input 605-19 on avatar editing option 666 and, in response, displays avatar editing interface 668, as shown in FIG. 6Z. Avatar editing interface includes various avatar options that can be selected to modify the appearance of the avatar corresponding to avatar stickers 664. In response to detecting changes to the appearance of the avatar, device 600 updates the appearance of the corresponding avatar stickers 664 to reflect the changes to the appearance of the avatar.

FIGS. 6AA-6AJ depict example interfaces for creating a new sticker using sticker creation option 618 in sticker interface 615. In FIG. 6AA, device 600 detects input 605-20 selecting sticker creation option 618 and, in response, displays sticker creation menu 670 as shown in FIG. 6AB. Sticker creation menu 670 includes new avatar option 670-1, camera option 670-2, and photo option 670-3. New avatar option 670-1 can be selected to create a new avatar from which a corresponding set of stickers is created. Camera option 670-2 can be selected to access the camera for taking a picture that can be used to generate a new sticker. Photo option 670-3 can be selected to access a photo library to select a photo from which to generate a new sticker.

In response to detecting input 605-21 selecting new avatar option 670-1, device 600 displays avatar editing interface 668 which, as shown in FIG. 6AC, includes a newly created avatar 668-1. Avatar editing interface 668 can be used to customize the new avatar. Once the new avatar is created, device 600 generates one or more avatar stickers (e.g., similar to avatar stickers 664) based on the appearance of the newly created avatar.

In response to detecting input 605-23 selecting photo option 670-3, device 600 displays photo album interface 671, as shown in FIG. 6AD. Photo album interface 671 includes a library of photos 674 available at device 600 and photo filter options 672, which can be selected to filter or sort the photos displayed in photo album interface 671. In FIG. 6AD, all photos option 672-1 is currently selected. In response to detecting input 605-24 selecting food option 672-2, device 600 filters the displayed photos 674 to display food photos corresponding to the selected food option 672-2. In FIG. 6AE, food option 672-2 is shown in a selected state, and photos 674 displayed in photo album interface 671 correspond to food photos. In some embodiments, the photos displayed in photo album interface 671 are a subset of the photos available at the device. In some embodiments, photos 674 are photos that are selected by device 600 as suitable candidates for creating a new sticker based on one or more objects in the respective photos.

In FIG. 6AE, device 600 detects input 605-25 selecting can photo 674-1. In response, device 600 enlarges the display of can photo 674-1 and automatically identifies and selects can 675 as an object in photo 674-1 from which to generate a new sticker. In some embodiments, other objects can be selected (e.g., by the user) from the photo and a sticker can be created using the user selected object instead of the object selected by device 600. In response to detecting input 605-26 selecting done option 676, device 600 generates a new sticker based on can 675 and displays the sticker in sticker interface 615. Accordingly, device 600 displays new can sticker 678 in sticker interface 615, as shown in FIG. 6AG.

In FIG. 6AH, device 600 displays camera interface 680 in response to detecting input 605-22 selecting camera option 670-2 in FIG. 6AB. In this embodiment, a camera of device 600 (e.g., camera 600-2) is accessed for capturing a picture that is used to create a sticker. In FIG. 6AH, camera interface 680 includes representation 682 of the camera's field of view, which includes dog 684. In response to detecting input 605-27 selecting capture affordance 685, device 600 captures photo 687, which includes dog 684, as shown in FIG. 6AI. In some embodiments, dog 684 is automatically selected by device 600 as an option for creating a new sticker based on the dog. In some embodiments, dog 684 is manually selected from photo 687 for creating the new sticker. In some embodiments, a different object (e.g., a tree in the background) can be selected in photo 687 for generating a new sticker. In some embodiments, after capturing photo 687, device 600 displays one or more options for manually selecting an object from the photo to create a sticker. In response to detecting input 605-28 on done option 686, device 600 generates dog sticker 688 based on the appearance of dog 684 in photo 687. Dog sticker 688 is displayed in sticker interface 615, as shown in FIG. 6AJ. In some embodiments, photo 687 is captured having a single image frame when input 605-27 is a tap input on capture affordance 685. In some embodiments, 687 is captured having multiple image frames when input 605-27 is a touch-and-hold input on capture affordance 685. In some embodiments, when photo 687 has multiple image frames, dog sticker 688 has an animated effect (that can be enabled/disabled) based on the animation of dog 684 in the multiple image frames of photo 687. In some embodiments, device 600 generates dog sticker 688 having an animated effect in response to detecting a touch-and-hold input on dog 684 in photo 687. In some embodiments, device 600 generates dog sticker 688 without an animated effect in response to detecting a tap input on dog 684 in photo 687.

FIGS. 6AK-6AN depict example interfaces for modifying a photo to include a sticker (e.g., a user-created sticker). In FIG. 6AK, device 600 displays photo editing interface 690, which includes photo 691 of man 692. Photo editing interface 690 includes various options for editing photo 691, including menu option 693. In response to detecting input 605-29 on menu option 693, device 600 displays a menu that includes an option for accessing sticker interface 615. In response to an input selecting the option for accessing the sticker interface, device 600 displays sticker interface 615, as shown in FIG. 6AL. Sticker interface 615 includes sticker 664-1, which is a sticker created based on an avatar (e.g., in response to creating a new avatar or editing an avatar using avatar editing interface 668). Sticker interface 615 also includes dog sticker 688, can sticker 678, surfer sticker 660, cat sticker 616-6, and bottle sticker 616-1.

As shown in FIGS. 6AL-6AM, device 600 detects input 605-30 selecting avatar sticker 664-1 and dragging the avatar sticker onto photo 691. In FIG. 6AM, silhouette 693 is displayed while sticker 664-1 is being dragged onto photo 691. When device 600 detects termination of input 605-30, device 600 adds sticker 664-1 to photo 691, as shown in FIG. 6AN. Accordingly, device 600 displays photo 691 with sticker 664-1 placed over man 692 in FIG. 6AN. Although FIGS. 6AL-6AN depict photo 691 being modified to include sticker 664-1, photo 691 can be modified in a similar manner using other stickers in sticker interface 615 including, for example, dog sticker 688, can sticker 678, surfer sticker 660, cat sticker 616-6, bottle sticker 616-1, or a combination thereof.

In some embodiments, sticker interface 615 can include stickers generated using applications that are not native to device 600 (e.g., third-party applications that are not native to the operating system of device 600). In some embodiments, such stickers can be accessed by scrolling and/or filtering stickers in sticker interface 615 in a manner similar to that described herein. In some embodiments, stickers in sticker interface 615 can be added to interfaces displayed using non-native applications. In some embodiments, non-native applications can include graphical objects that can be selected to access sticker interface 615 and/or to access the stickers in sticker interface 615 for display using the non-native application. In some embodiments, non-native applications can access sticker interface 615 using a keyboard interface (similar to keyboard interface 610) and/or using other interfaces (e.g., a user interface object that can be selected to add content such as a gif, sticker, image, and the like) that are provided for use with the non-native application.

FIGS. 6AO-6AR depict example interfaces for applying a sticker to a message in a message conversation. In FIG. 6AO, device 600 detects input 605-31 selecting message 694 in message conversation region 604. In some embodiments, input 605-31 is a tap input or a tap-and-hold input on message 694. In response to detecting input 605-31, device 600 displays menu 695, which includes add sticker option 695-1, as shown in FIG. 6AP. Add sticker option 695-1 can be selected to apply a sticker to message 694. Device 600 detects input 605-32 on add sticker option 695-1 and, in response, displays sticker interface 615 with stickers 660, 616-6, 616-1, 616-2, and 616-3, as shown in FIG. 6AQ. The user can select one of the stickers displayed in sticker interface 615 (including additional stickers 616 that are displayed in response to scrolling the stickers in sticker interface 615) or can navigate to other sticker options such as emoji stickers 661 (e.g., shown in FIG. 6W) or avatar stickers 664 (e.g., shown in FIG. 6Y), which can be selected to add the selected sticker to message 694. For example, in FIG. 6AQ, device 600 detects input 605-33 selecting pizza sticker 616-3 and, in response, displays pizza sticker 616-3 applied to message 694 as shown in FIG. 6AR. In some embodiments, device 600 displays an animation of the selected sticker moving from sticker interface 615 to the message. In some embodiments, the animation includes displaying a peeling effect where the sticker appears to peel from sticker interface 615 and move to message 694. In some embodiments, the selected sticker is displayed at a predetermined location on the message such as, for example, a corner region of the message. In some embodiments, the sticker (e.g., sticker 616-3) can be modified while being placed on the message (e.g., 694) (e.g., prior to being placed on the message). For example, the sticker can be rotated and/or resized using one or more gestures during the sticker placement process. For example, computer system 600 increases the size of sticker 616-3 in response to detecting a de-pinch gesture (e.g., a separation movement of one touch contact relative to a second touch contact on display 600-1, wherein at least one of the contacts is located on or adjacent to the sticker) on sticker 616-3. As another example, computer system 600 reduces the size of sticker 616-3 in response to detecting a pinch gesture (e.g., a movement of one touch contact towards a second touch contact on display 600-1, wherein at least one of the contacts is located on or adjacent to the sticker) on sticker 616-3. In yet another example, computer system 600 rotates sticker 616-3 in response to detecting a rotate gesture (e.g., a rotational movement of at least one touch contact relative to a second touch contact on display 600-1). The sticker is then displayed on the message having the rotated and/or resized appearance.

FIG. 7 is a flow diagram illustrating a method for creating stickers using a computer system in accordance with some embodiments. Method 700 is performed at a computer system (e.g., 100, 300, 500, 600, and/or 650) (e.g., a smartphone, a tablet computer, a desktop computer, laptop computer, and/or a head-mounted device (e.g., a head-mounted augmented reality and/or extended reality device)) that is in communication with (e.g., includes and/or is connected to) a display generation component (e.g., 600-1) (e.g., a display controller, a touch-sensitive display system, a monitor, a projector, a holographic display, and/or a head-mounted display system) and one or more input devices (e.g., 600-1, 600-2, and/or 600-3) (e.g., a touch-sensitive surface, a keyboard, mouse, trackpad, one or more optical sensors for detecting gestures (e.g., such as gaze-based gestures or inputs), one or more acoustical input devices (e.g., a microphone) for detecting speech-based input, one or more capacitive sensors for detecting hover inputs, and/or accelerometer/gyroscope/inertial measurement units). Some operations in method 700 are, optionally, combined, the orders of some operations are, optionally, changed, and some operations are, optionally, omitted.

As described below, method 700 provides an intuitive way for creating stickers. The method reduces the cognitive burden on a user for creating stickers, thereby creating a more efficient human-machine interface. For battery-operated computing devices, enabling a user to create stickers faster and more efficiently conserves power and increases the time between battery charges.

In method 700, the computer system (e.g., 600) displays (702), via the display generation component (e.g., 600-1): a media item (e.g., 606, 674-1, and/or 687) (e.g., a photo, image, and/or video) that includes a representation of a respective object (e.g., 624, 626, 628, 675, and/or 684) (e.g., an object that has been selected and/or identified for a potential action (e.g., create a sticker, copy, lookup, share)); and a graphical user interface object (e.g., 618, 630-1, 662-1, 676, and/or 686) (e.g., a create sticker option, an add sticker option, and/or a new sticker option) that is selectable to generate a sticker (e.g., 616-6, 660, 678, and/or 688) (e.g., a graphical user interface object that can be selected (e.g., via a touch, touch-and-hold, and/or touch-and-drag input) at a first location and placed (e.g., displayed, dragged, moved, and/or copied/pasted) at a second location (e.g., a location in or on a media item and/or in a messages conversation (e.g., at least partially overlaying previously displayed content such as a user interface, text, an image, and/or a graphical user interface object))) based on the media item (e.g., based on an appearance of the respective object in the media item).

The computer system (e.g., 600) detects (704), via the one or more input devices (e.g., 600-1), a selection (e.g., 605-5, 605-8, 605-15, 605-20, 605-26, and/or 605-28) of the graphical user interface object (e.g., 618, 630-1, 662-1, 676, and/or 686). In response to detecting the selection of the graphical user interface object, the computer system generates (706) a respective sticker (e.g., 616-6, 660, 678, and/or 688) having an appearance based on the representation of the respective object (e.g., 624, 626, 628, 675, and/or 684) in the media item (e.g., 606, 674-1, and/or 687) (e.g., the sticker has a visual appearance that is the same as the visual appearance of the representation of the respective object in the media item, and/or the sticker has one or more visual characteristics (e.g., shape, color, and/or animation) that are the same as the visual characteristics of the representation of the respective object in the media item). Generating a respective sticker having an appearance based on the representation of the respective object in the media item in response to detecting the selection of the graphical user interface object reduces the number of inputs needed to generate a respective sticker having an appearance based on a representation of an object in a media item.

In some embodiments, the respective sticker is generated having the appearance based on the representation of the respective object in the media item in accordance with a determination that the representation of the respective object is selected for generating a respective sticker. In some embodiments, in accordance with a determination that the representation of the respective object is not selected for generating the respective sticker, the respective sticker is not generated having an appearance based on the representation of the respective object in the media item (e.g., the respective sticker is not generated or the respective sticker is generated having an appearance based on something other than the representation of the respective object (e.g., a representation of a different object selected from the media item)).

In some embodiments, the sticker has a same appearance as the representation of the respective object, but a different size. In some embodiments, the sticker is not based on (e.g., does not include) one or more other objects represented in the media item (e.g., the sticker is based on a portion of the media item, without including at least one other portion of the media item).

The computer system (e.g., 600) displays (708), via the display generation component (e.g., 600-1), a plurality of stickers (e.g., 616, 660, 678, and/or 688) (e.g., a plurality of representations of stickers, a sticker user interface, and/or a sticker drawer). The plurality of stickers includes a representation of the respective sticker (e.g., 616-6, 660, 678, and/or 688) having the appearance based on the representation of the respective object (e.g., 624, 626, 628, 675, and/or 684) in the media item (e.g., 606, 674-1, and/or 687). In some embodiments, the plurality of stickers are displayed including the representation of the respective sticker having the appearance based on the representation of the respective object in the media item in accordance with a determination that the respective sticker was generated based on the appearance of the representation of the respective object. In some embodiments, in accordance with a determination that the respective sticker was not generated based on the appearance of the representation of the respective object (e.g., the respective sticker was generated based on an appearance of a representation of a different object in the media item or the respective sticker was not generated), the computer system displays the plurality of stickers without the representation of the respective sticker having the appearance based on the representation of the respective object in the media item. In some embodiments, if the respective sticker was generated based on an appearance of a representation of a second object in the media item (different from the respective object), displaying the plurality of stickers includes displaying a representation of the respective sticker having an appearance based on the representation of the second object in the media item.

In some embodiments, the plurality of stickers, including the representation of the respective sticker, is displayed in response to the selection of the graphical user interface object and the generation of the respective sticker. In some embodiments, the plurality of stickers, including the representation of the respective sticker, is displayed in response to one or more inputs that are detected after generating the respective sticker. In some embodiments, the media item includes a plurality of objects other than the respective object, and the respective sticker is generated based on the appearance of the representation of the respective object and not based on an appearance of the other objects in the media item.

In some embodiments, the representation of the respective object (e.g., 624, 626, 628, 675, and/or 684) is automatically selected (e.g., by the computer system (e.g., 600) and/or without input from a user to select the respective object) in the media item (e.g., 606, 674-1, and/or 687) for generating the respective sticker having the appearance based on the representation of the respective object. Automatically selecting the representation of the respective object in the media item for generating a respective sticker having an appearance based on the representation of the respective object reduces the number of inputs needed to generate a respective sticker having an appearance based on a representation of an object in a media item. In some embodiments, the respective object is selected from a plurality of objects in the media item. In some embodiments, the respective object is automatically selected for generating a sticker based on the respective object.

In some embodiments, the representation of the respective object (e.g., 624, 626, 628, 675, and/or 684) is selected in response to a first set of one or more inputs (e.g., 605-4, 605-6, 605-7) corresponding to selecting the respective object for generating the respective sticker having the appearance based on the representation of the respective object. Selecting the representation of the respective object in the media item in response to the first set of one or more inputs provides additional control options for selecting a representation of a respective object in a media item for generating a respective sticker having an appearance based on the representation of the respective object without cluttering the user interface with additional displayed controls. In some embodiments, the respective object is manually selected by a user of the computer system for generating a sticker based on the respective object.

In some embodiments, the first set of one or more inputs (e.g., 605-4, 605-6, 605-7) includes one or more inputs (e.g., 605-6, 605-7) modifying a prior selection of a representation of an object (e.g., a prior automatic selection of an object (e.g., an object different from the respective object) by the system and/or a prior manual selection of the object) selected for generating a sticker. Modifying a prior selection of a representation of an object selected for generating a sticker provides additional control options for modifying or customizing a selection of a representation of a respective object in a media item for generating a respective sticker having an appearance based on the representation of the respective object without cluttering the user interface with additional displayed controls.

In some embodiments, in response to detecting the selection (e.g., 605-5, 605-8, 605-15, 605-20, 605-26, and/or 605-28) of the graphical user interface object (e.g., 618, 630-1, 662-1, 676, and/or 686) and in accordance with a determination that a representation of a second object (e.g., 624, 626) (e.g., different from the respective object and/or a portion of the respective object) in the media item (e.g., 606) is selected for generating a respective sticker, the computer system (e.g., 600) generates a second sticker (e.g., a clock sticker, a dog sticker) having an appearance based on the representation of the second object in the media item. Generating a second sticker having an appearance based on the representation of the second object in the media item in response to detecting the selection of the graphical user interface object and in accordance with a determination that a representation of a second object in the media item is selected for generating a respective sticker provides additional control options for generating a second sticker based on a representation of a different object in a media item selected for generating a respective sticker without cluttering the user interface with additional displayed controls.

In some embodiments, while displaying the media item (e.g., 606), the computer system (e.g., 600) detects a selection (e.g., 605-4, 605-6, 605-7) of a representation of a second object (e.g., 626, 628) (e.g., different from the respective object) in the media item. In some embodiments, in accordance with a determination that the second sticker was generated based on the appearance of the representation of the second object, the computer system displays the plurality of stickers including the second sticker having the appearance based on the representation of the second object in the media item.

In some embodiments, the representation of the second object is a portion (e.g., 628) (e.g., subset) of the representation of the respective object (e.g., 626 and 628 collectively as shown in FIG. 6J). In some embodiments, a user edits the selected respective object to select a subset of the respective object (e.g., the second object), which is used to generate the sticker based on the second object (e.g., as shown in FIG. 6J).

In some embodiments, the representation of the second object (e.g., 628) is different from the representation of the first object (e.g., 624) (e.g., the representation of the second object does not include the representation of the first object or a representation of a portion of the first object).

In some embodiments, the graphical user interface object (e.g., 630-1) that is selectable to generate a sticker based on the media item (e.g., 606, 674-1) is displayed in response to detecting one or more inputs (e.g., 605-4, 605-6, 605-7, 605-25) directed to the media item (e.g., a tap and/or long press on an object in the photo or video). Displaying the graphical user interface object that is selectable to generate a sticker based on the media item in response to detecting one or more inputs directed to the media item reduces the number of inputs needed to display control options for generating a respective sticker based on a representation of an object selected in the media item. In some embodiments, the graphical user interface object that is selectable to generate a sticker based on the media item is displayed automatically (e.g., without a user input directed to the media item). In some embodiments, the graphical user interface object is automatically displayed when the media item is displayed in response to capturing a photo or video (e.g., via selection of a capture affordance) and/or in response to selecting a photo or video from a library (e.g., database) of images.

In some embodiments, as a part of generating the respective sticker having an appearance based on the representation of the respective object in the media item, the computer system (e.g., 600) performs the following steps. In accordance with a determination that the media item (e.g., 606, 687) has an animated effect (e.g., the media item is a photo or video that can be animated on playback), the computer system generates the respective sticker having a sticker animated effect based on the animated effect of the media item (e.g., the sticker is animated based on the corresponding animation of the respective object in the media item); and in accordance with a determination that the media item does not have the animated effect, the computer system generates the respective sticker without the sticker animated effect (e.g., the sticker does not include an animated effect if the media item does not include an animation). Generating the respective sticker having a sticker animated effect based on the animated effect of the media item when the media item includes an animated effect, and generating the respective sticker without a sticker animated effect when the media item does not include an animated effect, enables the computer system to automatically generate a respective sticker with or without a sticker animated effect based on whether or not the corresponding media item has an animated effect.

In some embodiments, in response to receiving a request to display the respective sticker, the computer system (e.g., 600) displays the respective sticker, including: in accordance with a determination that the respective sticker has a sticker animated effect (e.g., based on an animated effect of the media item), the computer system displays the respective sticker having an animation (e.g., a looping animation based on the animation of the respective object in the media item); and in accordance with a determination that the respective sticker does not have a sticker animated effect, the computer system displays the respective sticker without an animation. In some embodiments, the animation of the respective sticker can be toggled on/off, as discussed in greater detail with respect to FIGS. 8E-8N and 9. For the sake of brevity, these details are not repeated.

In some embodiments, in response to receiving a request (e.g., 605-9, 605-10) to edit one or more characteristics of the respective sticker (e.g., 616-6), the computer system (e.g., 600) displays a sticker editing interface (e.g., 640) that includes a visual effect option (e.g., 645) (in some embodiments, the editing interface includes a plurality of options) that is selectable to apply a visual effect (e.g., an outline effect, a shadow effect, a three-dimensional (e.g., puffy) effect, an iridescence, a hand drawn effect, a cartoon effect, and/or an animated effect) to the respective sticker. The computer system detects, via the one or more input devices (e.g., 600-1), a selection (e.g., 605-11) of the visual effect option. In response to detecting the selection of the visual effect option, the computer system displays the respective sticker having a visual effect. Displaying the sticker editing interface that includes a visual effect option in response to receiving a request to edit one or more characteristics of the respective sticker reduces the number of inputs needed to edit the respective sticker to include a visual effect. The sticker editing interface, and the application of various visual effects to the stickers, are discussed in greater detail with reference to FIGS. 8A-8N and 9. For the sake of brevity, these details are not repeated.

In some embodiments, the media item (e.g., 606, 687) is comprised of a plurality of image frames (e.g., the media item is a photo or video that can be animated on playback). In some embodiments, the media item is a photo or video taken by the user (e.g., using the computer system). In some embodiments, the media item is a photo, video, and/or image saved at the computer system (e.g., saved in a photo application and/or database) (e.g., saved from another source such as a webpage and/or application). In some embodiments, the media item is a photo, video, and/or image received from an external source such as another user device, an email, an SMS message, an MMS message, a live message communication session, and/or a live video communication session.

In some embodiments, the respective sticker (e.g., 616-6) includes an animation based on the plurality of image frames comprising the media item (e.g., the sticker is animated based on the corresponding animation of the respective object in the media item). In some embodiments, the animation is limited to an amount of time or a number of image frames of the media item (e.g., a subset of the image frames comprising the photo or video, or an animation length of 1 second, 2 seconds, 3 seconds, or 5 seconds).

In some embodiments, the animation (e.g., in FIG. 6H, FIG. 6S-1, FIG. 6S-2) based on the plurality of image frames comprising the media item is automatically generated (e.g., by the computer system (e.g., 600) and/or without input from a user to select and/or generate the animation). Automatically generating the animation based on the plurality of image frames comprising the media item reduces the number of inputs needed to generate an animation for the respective sticker.

In some embodiments, the computer system (e.g., 600) displays, via the display generation component (e.g., 600-1), a first sticker (e.g., 660) received from a remote computer system (e.g., 605) (e.g., an external computer system associated with a different user account than the computer system). The computer system detects, via the one or more input devices (e.g., 600-1), an input (e.g., 605-14, 605-15) directed to the first sticker (e.g., a tap input or a touch-and-hold input on the first sticker). In response to detecting the input directed to the first sticker, the computer system displays, via the display generation component, a sticker option (e.g., 662, 662-1) that is selectable to add the first sticker to the plurality of stickers (e.g., a collection of stickers available at the computer system) (e.g., as shown in FIG. 6V). Displaying a sticker option that is selectable to add the first sticker to the plurality of stickers in response to detecting the input directed to the first sticker reduces the number of inputs needed to save a received sticker to the computer system or to create a new sticker at the computer system that is based on a sticker received at the computer system. In some embodiments, the received sticker can be edited and sent by the remote computer system using any of the techniques described with respect to FIGS. 6A-6AR, 7, 8A-8N, 9, 10A-10I, and 11. For the sake of brevity, these details are not repeated.

In some embodiments, while displaying a media editing interface (e.g., 690) that includes the media item (e.g., 691) (or a different media item), the computer system (e.g., 600) displays the plurality of stickers (e.g., 616-6, 660, 664-1, 678, 688) including the respective sticker (e.g., 616-6, 664-1) (or a different sticker). The computer system detects, via the one or more input devices (e.g., 600-1), a second set of one or more inputs that includes a selection (e.g., 605-30) of the respective sticker from the plurality of stickers (e.g., a tap input, a touch-and-hold input, and/or a touch-and-drag input to select the respective sticker and place the respective sticker on the media item). In response to detecting the second set of one or more inputs, the computer system modifies the media item to include a representation (e.g., 664-1 in FIG. 6AN) of the respective sticker (e.g., overlaying the sticker over a portion of the media item). Modifying a media item to include a representation of a respective sticker in response to detecting the second set of one or more inputs that includes a selection of the respective sticker provides additional control options for modifying the media item to include a respective sticker without cluttering the user interface with additional displayed controls.

In some embodiments, the computer system (e.g., 600) displays, via the display generation component (e.g., 600-1), a first sticker interface (e.g., 607, 615) including a sticker creation option (e.g., 618, 670) that is selectable to initiate a process for generating a new sticker. In some embodiments, the sticker creation option includes a menu of options (e.g., a new avatar option, a camera option, and/or a photos option) that are selectable to generate a new sticker. In some embodiments, the sticker creation option includes an affordance that is selectable to display a menu of options for generating a new sticker.

In some embodiments, while displaying the first sticker interface (e.g., 607, 615), the computer system (e.g., 600) detects, via the one or more input devices (e.g., 600-1), a set of one or more inputs (e.g., 605-20, 605-21, 605-22, 605-23) directed to the sticker creation option (e.g., 618, 670) including a selection (e.g., 605-23) of a photos option (e.g., 670-3) (in some embodiments, the photos option is selected from a menu of options). In response to detecting the set of one or more inputs directed to the sticker creation option including a selection of the photos option, the computer system displays a collection of media items (e.g., 674) (e.g., a set of photos and/or videos) that are selectable for generating the new sticker. Displaying a collection of media items that are selectable for generating a new sticker in response to detecting the set of one or more inputs directed to the sticker creation option including a selection of the photos option reduces the number of inputs needed to display media items that are suitable for generating a new sticker.

In some embodiments, the collection of media items (e.g., 674) is a subset of media items available at the computer system (e.g., 600) (e.g., a curated selection of photos and/or videos that are suitable for creating stickers). In some embodiments, the subset includes media items that are selectable to generate potential stickers from a group of categories that includes: people, animals, food, vehicles, products, and statues.

In some embodiments, the collection of media items (e.g., 674) includes a set of one or more media category options (e.g., 672) (e.g., one or more options for filtering and/or sorting categories (e.g., people, animals, food, vehicles, products, and statues) of media items displayed in the collection of media items) that are selectable to update (e.g., change, filter, and/or sort) the subset of media items displayed in the collection of media items based on a selected media category option (e.g., as shown in FIGS. 6AD and 6AE). Displaying the collection of media items with a set of one or more media category options that are selectable to update the subset of media items displayed in the collection of media items based on a selected media category option reduces the number of inputs needed to find and display a respective media item in the collection of media items by providing a control scheme for quickly and easily filtering and/or sorting the displayed media items in the collection of media items.

In some embodiments, while displaying the first sticker interface (e.g., 615), the computer system (e.g., 600) detects, via the one or more input devices (e.g., 600-1), a set of one or more inputs (e.g., 605-20, 605-21, 605-22, 605-23) directed to the sticker creation option (e.g., 618, 670) including a selection (e.g., 605-22) of a camera option (e.g., 670-2) (in some embodiments, the camera option is selected from a menu of options). In response to detecting the set of one or more inputs directed the sticker creation option including a selection of the camera option, the computer system displays a camera user interface (e.g., 680) for capturing an image (e.g., 687) (e.g., a photo or a video) (e.g., using a camera of the computer system) to use for generating the new sticker. Displaying a camera user interface for capturing an image to user for generating a new sticker in response to detecting the set of one or more inputs directed to the sticker creation option including a selection of the camera option reduces the number of inputs needed to access the camera to capture a photograph that can be used to generate a new sticker. In some embodiments, the camera user interface includes a representation of the camera field of view. In some embodiments, the camera user interface includes a representation of an image captured by the camera.

In some embodiments, the computer system (e.g., 600) is in communication with a camera (e.g., 600-2) (e.g., an infrared camera, a depth camera, and/or a visible light camera). While displaying the camera user interface (e.g., 680), the computer system detects, via the one or more input devices (e.g., 600-1), a request (e.g., 605-27) to capture an image using the camera (e.g., a selection of a capture affordance). In response to detecting the request to capture an image using the camera, the computer system captures an image (e.g., 687) (e.g., a photo or a video) using the camera. The computer system displays (e.g., in response to one or more inputs, in response to capturing the image, and/or in an image editing user interface) the captured image with an option (e.g., 686) that is selectable to generate a sticker (e.g., 688) having an appearance based on an object (e.g., 684) detected (e.g., automatically (e.g., by the computer system) or manually (e.g., in response to a selection of the object (e.g., by a user of the computer system))) in the captured image. Displaying the captured image with an option that is selectable to generate a sticker having an appearance based on an object detected in the captured image reduces the number of inputs needed to select an object from a captured image to generate a new sticker based on the object in the captured image.

In some embodiments, the computer system (e.g., 600) detects, via the one or more input devices (e.g., 600-1), a set of one or more inputs (e.g., 605-27, 605-28) corresponding to a request to generate a sticker from the captured image (e.g., 687). In response to detecting the set of one or more inputs corresponding to a request to generate a sticker from the captured image, the computer system generates a new sticker (e.g., 688) from the captured image, including: in accordance with a determination that the set of one or more inputs corresponding to a request to generate a sticker from a captured image includes an input (e.g., on a capture affordance, on a representation of a captured image, and/or on a representation of an object in a captured image) of a first type (e.g., a touch-and-hold input and/or an input having a duration that is greater than a threshold duration (e.g., 0.5 seconds, 1 second, or 1.5 seconds)), the computer system generates the new sticker with an animated effect (e.g., the sticker is animated based on a corresponding animation of an object in the captured image); and in accordance with a determination that the set of one or more inputs corresponding to a request to generate a sticker from a captured image includes an input (e.g., on a capture affordance, on a representation of a captured image, and/or on a representation of an object in a captured image) of a second type different from the first type (e.g., a tap input and/or an input having a duration that is less than a threshold duration (e.g., 0.5 seconds, 1 second, or 1.5 seconds)), the computer system generates the new sticker without the animated effect. Generating the new sticker with an animated effect when the set of one or more inputs corresponding to the request to generate the sticker from the captured image includes an input of a first type, and generating the new sticker without the animated effect when the set of one or more inputs includes an input of a second type, provides additional controls for selectively generating a sticker with or without animation without cluttering the user interface with additional displayed controls. In some embodiments, the input of the first type causes the computer system to capture a photo or a video that can be animated on playback and the new sticker is generated with an animation from the photo or video.

In some embodiments, while the computer system (e.g., 600) displays, via the display generation component (e.g., 600-1), a messaging interface (e.g., 602 and/or 604) (e.g., a user interface for viewing, composing, sending, and/or receiving text messages, SMS messages, MMS messages, and/or emails) that includes a respective message (e.g., 694) (e.g., a text message), the computer system receives a set of one or more inputs (e.g., 605-31, 605-32, and/or 605-33) corresponding to the respective message (e.g., a tap input, a tap-and-hold input, an input on the respective message, an input on a menu option that is displayed with the respective message, and/or an input on a sticker in the plurality of stickers). In response to receiving the set of one or more inputs corresponding to the respective message, the computer system displays an option (e.g., 695-1, 616-3) (e.g., an add sticker option, an option in a menu, and/or a representation of a sticker) that is selectable to initiate a process for applying (e.g., automatically and/or without further user input) a sticker (e.g., 616-3) (e.g., the respective sticker or a different sticker in the plurality of stickers) from the plurality of stickers to the respective message. Displaying an option that is selectable to initiate a process for applying a sticker from the plurality of stickers to the respective message provides additional control options for adding a sticker to the respective message without cluttering the user interface with additional displayed controls. In some embodiments, the option is an “add sticker” option (e.g., 695-1) in a menu (e.g., 695). In some embodiments, the menu is displayed in response to an input (e.g., 605-31) at the respective message (e.g., 694). In some embodiments, the computer system detects a selection of the option and, in response, displays the plurality of stickers (e.g., 616). In some embodiments, the option is a representation of the sticker (e.g., 616-3, 616-6, and/or 660) in the plurality of stickers (e.g., 616). In some embodiments, while displaying the plurality of stickers, the computer system detects a selection of the sticker from the plurality of stickers and, in response, displays the sticker at a predefined location on the respective message in the messages interface. In some embodiments, the computer system displays an animation of the sticker moving from the plurality of stickers to the predefined location on the respective message in the messages interface.

In some embodiments, as part of the process for applying the sticker (e.g., 616-3) (e.g., the respective sticker or a different sticker in the plurality of stickers) from the plurality of stickers (e.g., 616) to the respective message (e.g., 694), the computer system (e.g., 600), while displaying via the display generation component (e.g., 600-1) the messaging interface (e.g., 602 and/or 604) including the respective message and the sticker from the plurality of stickers, detects a gesture (e.g., a pinch gesture, a de-pinch gesture, a rotation gesture, and/or a resize gesture) directed to the sticker. In response to detecting the gesture directed to the sticker, the computer system modifies an appearance of the sticker (e.g., a size, orientation, and/or position) based on the detected gesture. Modifying the appearance of the sticker based on the detected gesture provides additional controls for modifying an appearance of the sticker on the respective message without cluttering the UI with additional displayed controls. In some embodiments, the gesture is a de-pinch gesture (e.g., a separation movement of one touch contact relative to a second touch contact on display 600-1, wherein at least one of the contacts is located on or adjacent to the sticker). In some embodiments, the computer system increases a size of the sticker (e.g., without increasing a size of the respective message) based on a magnitude of the de-pinch gesture (e.g., as the contact points of the de-pinch gesture move away from each other, the computer system increases the size of the sticker at a corresponding rate). In some embodiments, the gesture is a pinch gesture (e.g., a movement of one touch contact towards a second touch contact on display 600-1, wherein at least one of the contacts is located on or adjacent to the sticker). In some embodiments, the computer system decreases a size of the sticker (e.g., without decreasing a size of the respective message) based on a magnitude of the pinch gesture (e.g., as the contact points of the pinch gesture move towards each other, the computer system decreases the size of the sticker at a corresponding rate). In some embodiments, the gesture is a rotation gesture (e.g., a rotational movement of at least one touch contact relative to a second touch contact on display 600-1). In some embodiments, the computer system rotates an orientation of the sticker (e.g., without rotating an orientation of the respective message) based on the amount of rotational movement of the rotation gesture (e.g., as one touch contact point rotates relative to a second touch contact point, the computer system rotates the orientation of the sticker at a corresponding rate). For example, if the rotate gesture corresponds to clockwise rotation of 45°, the computer system rotates the sticker 45° in the clockwise direction.

Note that details of the processes described above with respect to method 700 (e.g., FIG. 7) are also applicable in an analogous manner to the methods described below. For example, methods 900 and 1100 optionally include one or more of the characteristics of the various methods described above with reference to method 700. For example, the stickers edited and/or used as described with respect to the techniques in methods 900 and/or 1100 can be created using any of the techniques described with respect to method 700. For brevity, these details are not repeated below.

FIGS. 8A-8N illustrate exemplary user interfaces for editing stickers, in accordance with some embodiments. The user interfaces in these figures are used to illustrate the processes described below, including the processes in FIG. 9. It should be appreciated that the stickers in FIGS. 8A-8N can be used and/or created using any of the techniques described above with respect to FIGS. 6A-6AR and 7. Similarly, the stickers can be used in accordance with any of the techniques described below with respect to FIGS. 10A-10I and 11. For the sake of brevity, details are not repeated.

FIG. 8A depicts device 600 displaying, via display 600-1, messaging interface 802 (similar to messaging interface 602) and sticker interface 805 (similar to sticker interface 615). Sticker interface 805 includes stickers 806, sticker filter options 810 (similar to sticker filter options 620), sticker display region 807 (similar to sticker display region 607), sticker creation option 808 (similar to sticker creation option 618), and animation option 812. As described in greater detail below, animation option 812 can be selected to enable or disable animation of stickers 806 displayed in sticker display region 807.

In FIG. 8A, stickers 806 are similar to the stickers described with respect to FIGS. 6A-6AR and 7. Stickers 806 include cat sticker 806-1 (similar to cat sticker 616-6), surfer sticker 806-2 (similar to surfer sticker 660), dog sticker 806-3, bottle sticker 806-4, and die sticker 806-5. Some of stickers 806 are depicted having various visual effects applied to them. For example, surfer sticker 806-2 is displayed having an outline visual effect represented by outlining 814, dog sticker 806-3 is displayed having a comic book effect represented by shading 816, bottle sticker 806-4 is displayed having an iridescent effect represented by iridescence 818, and die sticker 806-5 is displayed having a three-dimensional effect (e.g., a puffy effect) represented by shading 820. Cat sticker 806-1 is displayed in FIG. 8A with a default appearance that does not include a visual effect applied to the sticker. In some embodiments, stickers 806 are displayed having a simulated shadow. For example, cat sticker 806-1 includes shadow portion 806-1a, surfer sticker 806-2 includes shadow portions 806-2a, dog sticker 806-3 includes shadow portions 806-3a, bottle sticker includes shadow portion 806-4a, and die sticker includes shadow portions 806-5a. In some embodiments, shadows are shown for some stickers, but not others. For example, a sticker shown having a three-dimensional puffy effect has a shadow, but stickers with different (e.g., two-dimensional) effects do not.

In some embodiments, device 600 modifies the display of stickers 806 so that they appear to be reactive to movement of device 600. For example, in FIG. 8A, device 600 is tilted, and stickers 806 are modified to appear as if they are reacting to the tilt of device 600. For example, shadow portion 806-1a of cat sticker 806-1 is moved to a different location to simulate a movement of the shadow portion as a result of the device tilt causing a simulated position change of cat sticker 806-1 relative to a simulated light source. The shadow portions of stickers 806-2 to 806-5 are displayed having a similar effect. Similarly, device 600 displays a modification of some of the visual effects applied to stickers 806, to simulate a change in the visual effects caused by tilting of device 600. For example, shading 816 of dog sticker 806-3 is modified (e.g., moved and/or darkened) to indicate a change in the comic book effect, the iridescence effect of bottle sticker 806-4 is changed by moving the displayed location of the iridescence and displaying additional iridescence, and the three-dimensional effect of die sticker 806-5 is changed by moving the location of shading 820.

Referring now to FIGS. 8C-8D, device 600 detects input 811-1 selecting cat sticker 806-1 and input 811-2 selecting edit option 822-2 from menu 822 (similar to edit option 635-2 of menu 635). In response, device 600 displays sticker editing interface 825 (similar to sticker editing interface 640), as shown in FIG. 8E. Sticker editing interface 825 is a user interface for modifying an appearance of a respective sticker. For example, sticker editing interface 825 can be used to apply a visual effect to the sticker, to change the visual effect applied to the sticker, to remove a visual effect from the sticker, and to enable or disable an animated effect of the sticker.

Sticker editing interface 825 includes representation 826 of cat sticker 806-1, visual effect options 828, and live option 830. Representation 826 provides an enlarged view of cat sticker 806-1 so that a user can more easily view the appearance of cat sticker 806-1 and any changes to the appearance of cat sticker 806-1 using sticker editing interface 825. In other words, representation 826 provides a preview of how cat sticker 806-1 will appear when any changes to the appearance of cat sticker 806-1 (e.g., via selection of different visual effects) are applied. Live option 830 can be selected to enable or disable an animated effect, as illustrated in FIG. 8F. Visual effect options 828 include null option 828-1 which provides no visual effect (or removes a previously applied visual effect), outline option 828-2, comic book effect option 828-3, three-dimensional effect option 828-4, and iridescent option 828-5. In some embodiments, device 600 automatically selects one of the visual effect options when sticker editing interface 825 is displayed. For example, as shown in FIG. 8E, device 600 automatically selects outline option 828-2 when displaying sticker editing interface 825. The selection of outline option 828-2 is indicated by border 824 around outline option 828-2 and by the addition of outlining 832 to the perimeter of representation 826 of cat sticker 806-1. It should be appreciated that the visual effect options 828 in sticker editing interface 825 have an appearance that matches the appearance of the cat sticker, and provide a preview of the visual effect provided by the respective visual effect option. For example, null option 828-1 does not include a visual effect option and, therefore, depicts a representation of cat sticker 806-1 without a visual effect. Similarly, outline option 828-2 provides an outline effect and, therefore, depicts a representation of cat sticker 806-1 having the outline effect (represented by outlining 832 on outline option 828-2). Comic book effect option 828-3 provides a comic book effect and, therefore, depicts a representation of cat sticker 806-1 having the comic book effect. Three-dimensional effect option 828-4 provides a three-dimensional (e.g., puffy) effect of cat sticker 806-1 and, therefore, depicts a representation of cat sticker 806-1 having the three-dimensional (e.g., puffy) effect. Iridescent option 828-5 provides an iridescence effect of cat sticker 806-1 and, therefore, depicts a representation of cat sticker 806-1 having the iridescence effect. In some embodiments, the visual effects displayed in sticker editing interface 825 are reactive to movement of device 600 in a manner similar to that described above with respect to stickers 806 in FIG. 8B.

In some embodiments, some stickers have an animated effect (e.g., when the sticker is based on a media item that has multiple image frames). The animated effect can be enabled or disabled from sticker editing interface 825 by selecting live option 830. For example, in FIG. 8E, device 600 detects input 811-3 selecting live option 830 and, in response, displays the animation of representation 826 of cat sticker 806-1, as shown in FIG. 8F. Live option 830 is displayed with a shaded appearance to indicate the animation is enabled. The animation depicted in FIG. 8F is a looping animation based on a media item (e.g., photo 606) from which cat sticker 806-1 was created (e.g., similar to creation of cat sticker 616-6 as discussed above with respect to FIGS. 6A-6AR and 7). The animation includes movement of shadow 806-1a based on the movement of the cat sticker. In some embodiments, the animation of the sticker can be displayed in response to a tap-and-hold input on representation 826 or another region of sticker editing interface 825. In some embodiments, the animation of the representation of the sticker continues while the input is maintained (e.g., held) and then ceases when the input is terminated (e.g., released).

FIGS. 8G-8K depict example interfaces for embodiments in which different visual effect options are selected for cat sticker 806-1 while the animation of the sticker continues as shown by the changing poses (e.g., swishing tail, blinking eyes, tilting head) of representation 826 in sticker editing interface 825. In FIG. 8G, device 600 detects input 811-4 selecting null option 828-1 while representation 826 of cat sticker 806-1 is displayed animated and having the outline effect represented by outlining 832. In response to input 811-4, device 600 removes the outline effect (e.g., by removing outlining 832) from representation 826 and continues to animate representation 826 of cat sticker 806-1, as shown in FIG. 8H.

In FIG. 8H, device 600 detects input 811-5 selecting three-dimensional effect option 828-4 and, in response, updates the appearance of representation 826 of cat sticker 806-1 to include a three-dimensional effect (e.g., a puffy effect) while continuing the animation, as shown in FIG. 8I. The three-dimensional effect is represented by shading 834 depicted on representation 826 of cat sticker 806-1. Shading 834 is also displayed on three-dimensional effect option 828-4.

While displaying representation 826 of cat sticker 806-1 having the three-dimensional effect in FIG. 8I, device 600 detects input 811-6 selecting iridescence option 828-5. In response, device 600 updates the appearance of representation 826 of cat sticker 806-1 to include the iridescence effect while continuing the animation, as shown in FIG. 8J. The iridescence effect is represented by iridescence 836 depicted on representation 826 of cat sticker 806-1. Iridescence 836 is also displayed on iridescence option 828-5.

While displaying representation 826 of cat sticker 806-1 having the iridescence effect in FIG. 8J, device 600 detects input 811-7 selecting comic book effect option 828-3. In response, device 600 updates the appearance of representation 826 of cat sticker 806-1 to include the comic book effect while continuing to display the animation, as shown in FIG. 8K. The comic book effect is represented by shading 838 depicted on representation 826 of cat sticker 806-1. Shading 838 is also displayed on comic book effect option 828-3.

In FIG. 8K, device 600 detect input 811-8 selecting live option 830 and, in response, disables the animation of representation 826 of cat sticker 806-1, as shown in FIG. 8L. Live option 830 is displayed with an unshaded appearance in FIG. 8L to indicate the animation is disabled. In FIG. 8L, device displays representation 826 of cat sticker 806-1 having the comic book effect and without animation. Device 600 detects input 811-9 on done option 840 and, in response, updates sticker 806-1 with the visual effect that was currently applied to representation 826 when the done option was selected. Accordingly, device 600 displays sticker interface 805 with cat sticker 806-1 having an updated appearance that includes the comic book effect represented by shading 838, as shown in FIG. 8M.

In some embodiments, animation of stickers can be enabled and disabled in sticker interface 805. For example, in FIG. 8M, stickers 806 are displayed without an animated effect. Device 600 detects input 811-10 selecting animation option 812. In response, device 600 enables animation of stickers that have an available animated effect, as shown in FIG. 8N. In the embodiment depicted in FIG. 8N, cat sticker 806-1, surfer sticker 806-2, and dog sticker 806-3 are capable of being animated and, therefore, are shown in an animated state (and having respective visual effects) in sticker display region 807 of sticker interface 805. Bottle sticker 806-4 and die sticker 806-5 do not have an animated effect and, therefore, are shown without animation (and having respective visual effects) in sticker interface 805. Animation option 812 is displayed with a shaded appearance in FIG. 8N to indicate the animation feature is enabled. Animation option 812 can be selected again to toggle off (disable) the animation feature, reverting to the user interface depicted in FIG. 8M.

FIG. 9 is a flow diagram illustrating a method for editing stickers using a computer system in accordance with some embodiments. Method 900 is performed at a computer system (e.g., 100, 300, 500, 600, and/or 650) (e.g., a smartphone, a tablet computer, a desktop computer, laptop computer, and/or a head-mounted device (e.g., a head-mounted augmented reality and/or extended reality device)) that is in communication with (e.g., includes and/or is connected to) a display generation component (e.g., 600-1) (e.g., a display controller, a touch-sensitive display system, a monitor, a projector, a holographic display, and/or a head-mounted display system) and one or more input devices (e.g., 600-1, 600-2, and/or 600-3) (e.g., a touch-sensitive surface, a keyboard, mouse, trackpad, one or more optical sensors for detecting gestures (e.g., such as gaze-based gestures or inputs), one or more acoustical input devices (e.g., a microphone) for detecting speech-based input, one or more capacitive sensors for detecting hover inputs, and/or accelerometer/gyroscope/inertial measurement units). Some operations in method 900 are, optionally, combined, the orders of some operations are, optionally, changed, and some operations are, optionally, omitted.

As described below, method 900 provides an intuitive way for editing stickers. The method reduces the cognitive burden on a user for editing stickers, thereby creating a more efficient human-machine interface. For battery-operated computing devices, enabling a user to edit stickers faster and more efficiently conserves power and increases the time between battery charges.

In method 900, the computer system (e.g., 600) displays (902), via the display generation component (e.g., 600-1), a sticker editing interface (e.g., 825) (e.g., a user interface for editing and/or creating a sticker) that includes one or more visual effect options (e.g., 828) that are selectable to apply a visual effect (e.g., an outline effect, a shadow effect, a three-dimensional effect, a puffy effect, an iridescence, a hand drawn effect, a cartoon effect, and/or an animated effect) to a respective sticker (e.g., 806-1), wherein the respective sticker has a first appearance (e.g., 806-1 as shown in FIG. 8A) (e.g., a default appearance, a predetermined appearance, and/or an appearance that does not include a visual effect). In some embodiments, a representation (e.g., 826) of the respective sticker is displayed in the sticker editing interface (e.g., having the first appearance before a visual effect is applied and/or after a visual effect is removed) (e.g., having a different appearance when a visual effect is applied).

The computer system (e.g., 600) detects (904), via the one or more input devices (e.g., 600-1), a set of one or more inputs that includes a selection (e.g., 811-4, 811-5, 811-6, 811-7) of one of the one or more visual effect options (e.g., 828-1, 828-2, 828-3, 828-4, 828-5). In response to detecting the set of one or more inputs that includes a selection of one of the visual effect options, the computer system performs (906) the following steps. In accordance with a determination that the set of one or more inputs includes a selection (e.g., 811-6) of a first visual effect option (e.g., 828-5), the computer system displays (908) (e.g., in the sticker editing interface) a representation (e.g., 826) of the respective sticker having a second appearance (e.g., 826 in FIG. 8J) that is different from the first appearance. The second appearance includes a first visual effect (e.g., 836) applied to the respective sticker (e.g., 806-1) (e.g., a visual effect corresponding to the first visual effect option). In accordance with a determination that the set of one or more inputs includes a selection (e.g., 811-5) of a second visual effect option (e.g., 828-4) that is different from the first visual effect option (e.g., and while the first visual effect option is not selected), the computer system displays (910) (e.g., in the sticker editing interface) a representation (e.g., 826) of the respective sticker having a third appearance (e.g., 826 in FIG. 8I) that is different from the first appearance and the second appearance. The third appearance includes a second visual effect (e.g., 834) applied to the respective sticker (e.g., a visual effect corresponding to the second visual effect option) without the first visual effect. The second visual effect is different from the first visual effect. Displaying a representation of the respective sticker having a second appearance that includes a first visual effect applied to the respective sticker when the set of one or more inputs includes a selection of a first visual effect option, and displaying a representation of the respective sticker having a third appearance that includes a second visual effect applied to the respective sticker without the first visual effect when the set of one or more inputs includes a selection of a second visual effect option, provides improved feedback about the appearance of the respective sticker such as feedback about a changed visual effect that is applied to the respective sticker.

In some embodiments, if no visual effect option is selected (e.g., none of the visual effect options are selected, or a null option is selected), the computer system (e.g., 600) displays the sticker (e.g., 806-1) or representation of the sticker (e.g., 826) having no visual effect applied to the sticker. In some embodiments, the visual effects discussed herein can be applied to an emoji in a manner that is analogous to the manner in which the visual effects are applied to a sticker.

In some embodiments, the respective sticker (e.g., 806-1) is generated based on a media item (e.g., 606) (e.g., a photo, image, and/or video). In some embodiments, the respective sticker has an appearance that is based on an appearance of a respective object in the media item. One or more example embodiments of a sticker based on a media item are discussed with respect to FIGS. 6A-6AR and 7. For the sake of brevity, these details are not repeated.

In some embodiments, as a part of displaying the sticker editing interface (e.g., 825), the computer system (e.g., 600) performs the following steps. In accordance with a determination that the respective sticker (e.g., 806-1) is generated based on a media item having an animated effect (e.g., a photo and/or video that can be animated on playback), the computer system displays (e.g., in the sticker editing interface) a representation of the respective sticker with an animated effect (e.g., 826 in FIGS. 8F-8K) (e.g., the sticker is animated based on the corresponding animation of the media item (e.g., animation of an object in the media item from which the sticker is based)). In accordance with a determination that the respective sticker is generated based on a media item that does not have an animated effect, the computer system displays (e.g., in the sticker editing interface) a representation of the respective sticker without the animated effect. Displaying the representation of the respective sticker with an animated effect when the respective sticker is generated based on a media item having an animated effect, and displaying the representation of the respective sticker without an animated effect when the respective sticker is generated based on a media item that does not have an animated effect, provides improved feedback about an animated state of the respective sticker.

In some embodiments, the animated effect is a looping animated effect (e.g., the animation of the sticker repeats automatically one or more times) (e.g., as shown in FIGS. 8F and 8N).

In some embodiments, the sticker editing interface (e.g., 825) includes a selectable animation toggle (e.g., 830) that is selectable to enable or disable displaying of the representation (e.g., with the first appearance, the second appearance, and/or the third appearance) of the respective sticker (e.g., 826) with an animated effect. Displaying the sticker editing interface with a selectable animation toggle that is selectable to enable or disable displaying of the representation of the respective sticker with an animated effect reduces the number of inputs needed to enable or disable the animated effect of the respective sticker by displaying the selectable animation toggle in the sticker editing interface.

In some embodiments, as a part of displaying the sticker editing interface (e.g., 825), the computer system (e.g., 600) performs the following steps. In accordance with a determination that the selectable animation toggle (e.g., 830) is in a first selection state (e.g., as shown in FIGS. 8F-8K), the computer system displays a representation of the respective sticker (e.g., 826) having an animated effect (e.g., the animation is enabled). In accordance with a determination that the selectable animation toggle is in a second selection state (e.g., as shown in FIGS. 8E and 8L) (e.g., a disabled state), the computer system displays the representation of the respective sticker without the animated effect (e.g., the animation is disabled). In some embodiments, the computer system detects a selection of the animation toggle and switches from the disabled state to the enabled state, including updating display of the representation of the respective sticker to enable the animated effect such that the representation of the respective sticker is displayed with the animated effect. In some embodiments, the computer system detects a selection of the animation toggle and switches from the enabled state to the disabled state, including updating display of the representation of the respective sticker to disable the animation such that the representation of the respective sticker is displayed without the animated effect.

In some embodiments, as a part of displaying the sticker editing interface (e.g., 825) the computer system (e.g., 600) automatically selects (e.g., by the computer system, without additional user input) one of the visual effect options (e.g., 828) so that the first appearance (e.g., an initial appearance) of the respective sticker includes an applied visual effect (e.g., 832) corresponding to the automatically selected visual effect option (e.g., 828-2). Automatically selecting one of the visual effect options so that the first appearance of the respective sticker includes an applied visual effect when displaying the sticker editing interface reduces the number of inputs needed to apply a visual effect to the respective sticker. In some embodiments, a representation of the respective sticker is displayed having a visual effect automatically applied to the respective sticker in response to a request (e.g., 811-2) to display the sticker editing interface.

In some embodiments, the computer system (e.g., 600) displays a sticker interface (e.g., 805) (e.g., a plurality of representations of stickers, a sticker user interface, and/or a sticker drawer) (in some embodiments, while the sticker editing interface is not displayed (e.g., prior to displaying the sticker editing interface or after the sticker editing interface is no longer displayed)) including a plurality of stickers (e.g., 806) (e.g., a collection of stickers including, in some embodiments, the respective sticker) and a first selectable graphical user interface object (e.g., 822, 822-2) (e.g., a menu option and/or an edit option), wherein displaying the sticker editing interface (e.g., 825) occurs in response to selection (e.g., 811-2) of the first selectable graphical user interface object (e.g., 822-2). Displaying a sticker interface including a plurality of stickers and a first selectable graphical user interface object, wherein displaying the sticker editing interface occurs in response to selection of the first selectable graphical user interface object provides additional control options for accessing a user interface for editing a visual effect of the respective sticker without cluttering the user interface with additional displayed controls. In some embodiments, the first selectable graphical user interface object is visually associated with the respective sticker in the sticker interface. In some embodiments, the respective sticker has the first appearance in the sticker interface (e.g., after creating the respective sticker and/or before editing the respective sticker). In some embodiments, the respective sticker has the second appearance or the third appearance in the sticker interface (e.g., after editing and/or updating the respective sticker).

In some embodiments, after detecting the set of one or more inputs (e.g., 811-4, 811-5, 811-6, 811-7, and/or 811-9) that includes a selection (e.g., 811-4, 811-5, 811-6, or 811-7) of one of the visual effect options (e.g., 828-2, 828-3, 828-4, or 828-5), the computer system (e.g., 600) displays the sticker interface (e.g., 805) with the plurality of stickers including the respective sticker (e.g., 806-1) having the second appearance or the third appearance (e.g., as shown in FIG. 8M) (e.g., after editing and/or updating the respective sticker). Displaying the sticker interface with the plurality of stickers including the respective sticker having the second appearance or the third appearance provides improved feedback about an updated appearance of the respective sticker.

In some embodiments, the sticker interface (e.g., 805) is configurable (e.g., in response to an input (e.g., tap-and-hold input) to activate a mode for rearranging/deleting one or more stickers in the sticker interface (e.g., using menu 822)) to modify an arrangement of the plurality of stickers (e.g., 806) and/or delete one or more of the plurality of stickers. Displaying a sticker interface that is configurable to modify an arrangement of the plurality of stickers and/or delete one or more of the plurality of stickers provides an enhanced control scheme for allowing a user to customize the plurality of stickers displayed in the sticker interface.

In some embodiments, the sticker interface (e.g., 805) includes a selectable animation user interface object (e.g., 812) (e.g., toggle) that is selectable to enable or disable animation (e.g., an animated effect) of one or more of the plurality of stickers (e.g., 806-1, 806-2, and/or 806-3) (e.g., the affordance enables or disables animation of the stickers in the sticker interface that are capable of having animation such as stickers that are generated based on a media item having an animated effect (e.g., a photo or a video that can be animated on playback) including, in some embodiments, animation of the respective sticker). Displaying the sticker interface including a selectable animation user interface object that is selectable to enable or disable animation of one or more of the plurality of stickers reduces the number of inputs needed to change an animation state of the plurality of stickers.

In some embodiments, as a part of displaying the sticker interface (e.g., 805), the computer system (e.g., 600) performs the following steps. In accordance with a determination that the selectable animation user interface object (e.g., 812) is in a first selection state (e.g., as shown in FIG. 8N), the computer system displays one or more of the plurality of stickers (e.g., 806-1, 806-2, and/or 806-3) having animation (e.g., the animation is enabled) (e.g., as shown in FIG. 8N). In accordance with a determination that the selectable animation user interface object is in a second selection state (e.g., a disabled state) (e.g., as shown in FIG. 8M), the computer system displays the plurality of stickers without animation (e.g., the animation is disabled) (e.g., as shown in FIG. 8M). In some embodiments, the computer system detects a selection (e.g., 811-10) of the animation user interface object and switches from the disabled state to the enabled state, including updating display of the plurality of stickers to enable the animation. In some embodiments, the computer system detects a selection of the animation user interface object and switches from the enabled state to the disabled state, including updating display of the plurality of stickers to disable the animation.

In some embodiments, the computer system (e.g., 600) displays the respective sticker (e.g., 806-1) (e.g., in a sticker interface, a plurality of representations of stickers, a sticker user interface, and/or a sticker drawer) (in some embodiments, while the sticker editing interface is not displayed (e.g., prior to displaying the sticker editing interface or after the sticker editing interface is no longer displayed)), and the computer system displays the sticker editing interface (e.g., 825) in response to detecting a set of one or more inputs (e.g., 811-1, 811-2) (e.g., one or more inputs selecting the respective sticker, displaying a menu, and/or selecting an option to edit the respective sticker) corresponding to the respective sticker. Displaying the respective sticker, wherein displaying the sticker editing interface occurs in response to detecting a set of one or more inputs corresponding to the respective sticker, provides additional control options for accessing a user interface for editing the respective sticker without cluttering the user interface with additional displayed controls.

In some embodiments, the first visual effect option corresponds to an outline option (e.g., 828-2), and the computer system (e.g., 600) displaying the representation of the respective sticker (e.g., 826) having the second appearance includes displaying the representation of the respective sticker having an outline effect (e.g., 832) (e.g., a border and/or outline applied to the perimeter of the respective sticker) applied to the respective sticker (e.g., as shown in FIG. 8E). Displaying the representation of the respective sticker having an outline effect provides improved feedback about an appearance of the respective sticker such as a visual effect applied to the respective sticker. In some embodiments, the second visual effect option is an outline option and displaying the representation of the respective sticker having the third appearance includes displaying the representation of the respective sticker having the outline effect applied to the respective sticker.

In some embodiments, the first visual effect option corresponds to a three-dimensional option (e.g., 828-4), and the computer system (e.g., 600) displaying the representation of the respective sticker (e.g., 826) having the second appearance includes displaying the representation of the respective sticker having a three-dimensional effect (e.g., 834) (e.g., having a simulated three-dimensional and/or puffy appearance applied to the respective sticker to resemble a puffy sticker) applied to the respective sticker (e.g., as shown in FIG. 8I). Displaying the representation of the respective sticker having a three-dimensional effect provides improved feedback about an appearance of the respective sticker such as a visual effect applied to the respective sticker. In some embodiments, the second visual effect option is a three-dimensional option and displaying the representation of the respective sticker having the third appearance includes displaying the representation of the respective sticker having the three-dimensional effect applied to the respective sticker.

In some embodiments, the first visual effect option corresponds to an iridescence option (e.g., 828-5), and the computer system (e.g., 600) displaying the representation of the respective sticker (e.g., 826) having the second appearance includes displaying the representation of the respective sticker having an iridescent effect (e.g., 836) (e.g., a visual effect in which the respective sticker has colors (e.g., luminous colors) that appear to change when viewed from different angles) applied to the respective sticker (e.g., as shown in FIG. 8J). Displaying the representation of the respective sticker having an iridescent effect provides improved feedback about an appearance of the respective sticker such as a visual effect applied to the respective sticker. In some embodiments, the second visual effect option is an iridescence option and displaying the representation of the respective sticker having the third appearance includes displaying the representation of the respective sticker having the iridescent effect applied to the respective sticker.

In some embodiments, the first visual effect option corresponds to a comic book option (e.g., 828-3), and the computer system (e.g., 600) displaying the representation of the respective sticker (e.g., 826) having the second appearance includes displaying the representation of the respective sticker having a comic book effect (e.g., 838) (e.g., a hand drawn, cartoon, filtered, shaded, and/or colored appearance that resembles various artistic stylings of a comic book) applied to the respective sticker (e.g., as shown in FIG. 8K). Displaying the representation of the respective sticker having a comic book effect provides improved feedback about an appearance of the respective sticker such as a visual effect applied to the respective sticker. In some embodiments, the second visual effect option is a comic book option and displaying the representation of the respective sticker having the third appearance includes displaying the representation of the respective sticker having the comic book effect applied to the respective sticker.

In some embodiments, while displaying the representation of the respective sticker (e.g., 826, 806-1) having a respective visual effect applied to the respective sticker (e.g., the representation of the respective sticker has the second appearance or the third appearance), wherein the respective visual effect has a first displayed state: the computer system (e.g., 600) detects, via the one or more input devices (e.g., an accelerometer, a sensor, a gyroscope, an inertial measurement unit, and/or a camera), movement of the display generation component (e.g., 600-1) (e.g., angling, tilting, rotating, and/or turning the display screen of the computer system) (in some embodiments, movement of the computer system); and in response to detecting the movement of the display generation component, the computer system displays the representation of the respective sticker (e.g., 826, 806-1) changing appearance based on the movement of the display generation component, including displaying the respective visual effect changing from the first displayed state (e.g., in FIG. 8A) to a second displayed state of the respective visual effect (e.g., in FIG. 8B) that is different from the first displayed state (e.g., changing the appearance of the visual effect to simulate a parallax effect, tilting of shadows, shifting of a sticker outline, shimmering of iridescence, and/or movement of lighting and/or coloring on the sticker(s)). Displaying the representation of the respective sticker changing appearance based on the movement of the display generation component, including displaying the respective visual effect changing from the first displayed state to a second displayed state of the respective visual effect, provides improved feedback about an appearance of the respective sticker such as a change in appearance of the visual effect in response to device movement.

Note that details of the processes described above with respect to method 900 (e.g., FIG. 9) are also applicable in an analogous manner to the methods described below and above. For example, methods 700 and 1100 optionally include one or more of the characteristics of the various methods described above with reference to method 900. For example, the stickers created and/or used as described with respect to the techniques in methods 700 and/or 1100 can be edited using any of the techniques described with respect to method 900. For brevity, these details are not repeated.

FIGS. 10A-10I illustrate exemplary user interfaces for using stickers, in accordance with some embodiments. The user interfaces in these figures are used to illustrate the processes described below, including the processes in FIG. 11. It should be appreciated that the stickers in FIGS. 10A-10I can be used and/or created using any of the techniques described above with respect to FIGS. 6A-6AR and 7. Similarly, the stickers can be edited using any of the techniques described above with respect to FIGS. 8A-8N and 9. For the sake of brevity, details are not repeated.

FIG. 10A depicts device 600 displaying, via display 600-1, messaging interface 1002 (similar to messaging interfaces 602 and 802), which includes message conversation region 1004 (similar to message conversation region 604), message compose field 1006 (similar to message compose field 608), and keyboard interface 1008 (similar to keyboard interface 610). Keyboard interface 1008 can be used to provide content for the message conversation, which is displayed in message compose field 1006 prior to being sent and subsequently displayed in message conversation region 1004. Messaging interface 1002 depicts a text messages conversation between members of the “Surf Trip” group.

Keyboard interface 1008 includes region 1003, which includes various options 1010 that can be selected for accessing content to be used for the messaging interface. Keyboard interface 1008 also includes emoji option 1012, which can be used to access emoji for messaging interface 1002. FIG. 10A, depicts input 1005-1 selecting emoji option 1012 and input 1005-2 selecting stickers option 1010-1 (similar to stickers option 614-1).

In response to detecting input 1005-1 selecting emoji option 1012, device 600 displays emojis 1014, as shown in FIG. 10B. Emojis 1014 include dog emoji 1014-1 and pawprints emoji 1014-2, which are both associated with a dog category. Emojis 1014 can be selected to be added to a message being composed in messaging interface 1002. In some embodiments, emojis 1014 are displayed as part of an emoji keyboard as shown in FIG. 10B. In some embodiments, the emoji keyboard includes a stickers option (e.g., similar to stickers option 1010-1) that is selectable to display sticker interface 1015.

In response to detecting input 1005-2 selecting stickers option 1010-1, device 600 displays sticker interface 1015, as shown in FIG. 10C. Sticker interface 1015 is similar to sticker interfaces 615 and 805 and includes stickers 1016 (similar to stickers 616 and 806) displayed in sticker display region 1018 (similar to sticker display regions 607 and 807). Stickers 1016 includes dog sticker 1016-1, which is a dog sticker created from a media item. In some embodiments, dog sticker 1016-1 is associated with a dog category because the sticker has the appearance of a dog or has other features associated with the dog category. In some embodiments, dog sticker 1016-1 is created using any of the techniques described above with respect to FIGS. 6A-6AR and 7, and can be edited or displayed using any of the techniques described above with respect to FIGS. 8A-8N and 9. For the sake of brevity, details are not repeated. In some embodiments, stickers 1016 or a subset of stickers (e.g., including dog sticker 1016-1) can be displayed in response to a scroll gesture (e.g., a horizontal scroll gesture) on emojis 1014 in FIG. 10B. In some embodiments, sticker interface 1015 can be closed by selecting close option 1020 (e.g., via input 1005-3).

FIGS. 10D-10I depict example interfaces for embodiments in which a text message is composed using keyboard interface 1008. In the embodiments depicted in FIGS. 10D-10I, device 600 suggests or recommends stickers and/or emojis based on text entered in message compose field 1006.

In FIG. 10D, device 600 displays messaging interface 1002 with text 1022 displayed in message compose field 1006. In some embodiments, text 1022 is displayed in response to input at keyboard interface 1008 (e.g., selecting the keyboard keys) and/or by other means (e.g., a command to paste text). When text is entered in message compose field 1006, device 600 updates region 1003 of the keyboard interface to include suggested content. In some embodiments, the suggested content is text that is likely to be used while composing the message in message compose field 1006. For example, the suggested text can be a corrected spelling of a word or a word that is predicted (e.g., based on criteria) by device 600 as being relevant for the composed message. In FIG. 10D, the suggested content in region 1003 includes text 1024.

In FIG. 10E, additional text 1022-1 has been added to the message in message compose field 1006. The additional text 1022-1 includes the word “dog” which, in some embodiments, is a keyword that is recognized by device 600 or otherwise meets criteria for displaying, in region 1003, suggested sticker and/or emoji options that correspond to the word “dog.” Accordingly, device 600 updates region 1003 to include suggested sticker option 1026, pawprints emoji 1014-2, and dog emoji 1014-1, because these sticker and emoji options are associated with the word “dog.” Sticker option 1026 is an option that is selectable to add dog sticker 1016-1 to message compose field 1006. Similarly, pawprints emoji 1014-2 and dog emoji 1014-1 are selectable to add the respective pawprints emoji 1014-2 or dog emoji 1014-1 to the message compose field 1006, as described in greater detail below. In some embodiments, device 600 updates region 1003 to include relevant text options such as text options 1024-1 and 1024-2, which relate to the word “dog” in text 1022-1. In some embodiments, suggested sticker options are visually distinguished from suggested emoji options so that a user of device 600 can easily distinguish between a sticker option and an emoji option. For example, in FIG. 10E, suggested sticker option 1026 includes border 1028, whereas emoji options 1014-1 and 1014-2 do not include a border. In some embodiments, other distinguishing features can be used such as, for example, a peeling visual effect of the sticker, a background color or filling, or other visual characteristics. In FIG. 10E, sticker option 1026 is also distinguished from emoji options because the sticker option has the appearance of dog sticker 1016-1 (inside border 1028). Accordingly, a user of device 600 can determine that sticker option 1026 corresponds to an option for adding dog sticker 1016-1 to the message conversation.

In some embodiments, when device 600 detects selection of a suggested emoji option in region 1003, the device replaces the keyword text in message compose field 1006 (e.g., text 1022-1) with the selected emoji option. For example, in FIG. 10E, device 600 detects input 1005-5 selecting pawprints emoji 1014-2 from region 1003 of keyboard interface 1008. In response, device 600 replaces text 1022-1 in message compose field 1006 with pawprints emoji 1014-2, as shown in FIG. 10F. In some embodiments, after the selected emoji option is added to the composed message, device 600 displays an additional suggested sticker or suggested emoji in region 1003. For example, in FIG. 10F, device 600 displays second dog emoji 1014-3 after pawprints emoji 1014-2 is displayed in message compose field 1006.

In FIG. 10F, device 600 detects input 1005-6 selecting send affordance 1030 and, in response, sends the message in message compose field 1006 to the participants of the messages conversation (e.g., members of the “Surf Trip” group), as illustrated in FIG. 10G. Accordingly, device 600 displays message 1032 in message conversation region 1004 of messaging interface 1002, indicating that the message, including text and pawprints emoji 1014-2 (but not text 1022-1), was sent to the members of the “Surf Trip” group.

In some embodiments, when device 600 detects selection of a suggested sticker option in region 1003, the device adds the corresponding sticker to message compose field 1006 without replacing the keyword text in message compose field 1006 (e.g., text 1022-1). For example, in FIG. 10E, device 600 detects input 1005-4 selecting dog sticker option 1026 from region 1003 of keyboard interface 1008. In response, device 600 displays dog sticker 1016-1 in message compose field 1006 with text 1022-1, as shown in FIG. 10H. In some embodiments, after the selected sticker option is added to the composed message, device 600 displays an additional suggested sticker or suggested emoji in region 1003. For example, in FIG. 10H, device 600 displays second dog emoji 1014-3 after dog sticker 1016-1 is added to message compose field 1006.

In FIG. 10H, device 600 detects input 1005-7 selecting send affordance 1030 and, in response, sends the message in message compose field 1006 (including dog sticker 1016-1) to the participants of the messages conversation (e.g., members of the “Surf Trip” group), as illustrated in FIG. 10I. Accordingly, device 600 displays message 1034 and dog sticker 1016-1 in message conversation region 1004 of messaging interface 1002, indicating that the message, including text 1022-1 and dog sticker 1016-1, was sent to the members of the “Surf Trip” group.

FIG. 11 is a flow diagram illustrating a method for using stickers using a computer system in accordance with some embodiments. Method 1100 is performed at a computer system (e.g., 100, 300, 500, 600, and/or 650) (e.g., a smartphone, a tablet computer, a desktop computer, laptop computer, and/or a head-mounted device (e.g., a head-mounted augmented reality and/or extended reality device)) that is in communication with (e.g., includes and/or is connected to) a display generation component (e.g., 600-1) (e.g., a display controller, a touch-sensitive display system, a monitor, a projector, a holographic display, and/or a head-mounted display system) and one or more input devices (e.g., 600-1, 600-2, and/or 600-3) (e.g., a touch-sensitive surface, a keyboard, mouse, trackpad, one or more optical sensors for detecting gestures (e.g., such as gaze-based gestures or inputs), one or more acoustical input devices (e.g., a microphone) for detecting speech-based input, one or more capacitive sensors for detecting hover inputs, and/or accelerometer/gyroscope/inertial measurement units). Some operations in method 1100 are, optionally, combined, the orders of some operations are, optionally, changed, and some operations are, optionally, omitted.

As described below, method 1100 provides an intuitive way for using stickers. The method reduces the cognitive burden on a user for using stickers, thereby creating a more efficient human-machine interface. For battery-operated computing devices, enabling a user to use stickers faster and more efficiently conserves power and increases the time between battery charges.

In method 1100, while displaying, via the display generation component (e.g., 600-1), a messages interface (e.g., 1002) (e.g., a user interface for viewing, composing, sending, and/or receiving text messages, SMS messages, MMS messages, and/or emails) that includes respective text (e.g., 1022, 1022-1) (e.g., a user input that includes text such as a composed text message, email message, word, and/or phrase), the computer system (e.g., 600) detects (1102) that the respective text meets a first set of criteria (e.g., the respective text corresponds to an emoji and/or sticker).

In response to detecting that the respective text (e.g., 1022-1) meets the first set of criteria, the computer system (e.g., 600) displays (1104) a set of one or more selectable options (e.g., 1026, 1014-1, and/or 1014-2) (e.g., emoji options and/or sticker options) associated with the respective text. In some embodiments, the selectable options include representations of emojis and/or stickers that represent or correspond to the respective text.

The computer system (e.g., 600) detects (1106) a set of one or more inputs (e.g., 1005-4, 1005-5) that includes a selection (e.g., 1005-4, 1005-5) of a respective option (e.g., 1026, 1014-1, 1014-2) of the set of one or more selectable options. In response to detecting the set of one or more inputs that includes a selection of a respective option of the set of one or more selectable options, the computer system performs (1108) the following steps.

In accordance with a determination that the respective option is a first type of selectable option (e.g., 1014-1, 1014-2) (e.g., an option that corresponds to an emoji), the computer system (e.g., 600) replaces (1110) (e.g., including ceasing to display the respective text) the respective text (e.g., 1022-1) with an emoji (e.g., 1014-1) (e.g., a static icon, image, or other graphical user interface object that represents a phrase, word, reaction, and/or emotion) corresponding to the respective option (e.g., ceasing to display the respective text in the messages interface and displaying, in place of the respective text, the corresponding emoji). In accordance with a determination that the respective option is a second type of selectable option (e.g., 1026) different from the first type (e.g., an option that corresponds to a sticker), the computer system displays (1112), in the messages interface (e.g., 1002), a sticker (e.g., 1016-1) corresponding to the respective option without replacing the respective text (e.g., 1022-1) (e.g., continuing to display the respective text concurrently with the sticker). Replacing the respective text with an emoji corresponding to the respective option when the respective option is a first type of selection option, and displaying a sticker corresponding to the respective option without replacing the respective text when the respective option is a second type of selectable option, provides additional control options for replacing respective text with an emoji or attaching a sticker with the respective text in a messages interface without cluttering the user interface with additional displayed controls.

In some embodiments, the respective text (e.g., 1022-1) meets the first set of criteria when the respective text corresponds to (e.g., matches (e.g., the text matches a name and/or keyword assigned to the emoji and/or sticker) and/or is linked to) an emoji (e.g., 1014, 1014-1, 1014-2) and/or a sticker (e.g., 1016, 1016-1) (e.g., one or more emojis and/or stickers) available at the computer system (e.g., 600). In some embodiments, the respective text corresponds to an emoji when the respective text includes a name, descriptor, or other keyword that is associated with a respective emoji, group of emojis, and/or category of emojis. For example, if the respective text includes the word “dog,” the respective text corresponds to emojis that represent, include, and/or are otherwise associated with a dog. In some embodiments, one or more emojis are linked to various corresponding phrases or keywords in a database, so that when one of the phrases or keywords is used (e.g., in the respective text), corresponding emojis, or a subset thereof, are displayed as a selectable option. In some embodiments, the respective text corresponds to a sticker when the respective text includes a name, descriptor, or other keyword that is associated with a respective sticker, group of stickers, and/or category of stickers. For example, if the respective text includes the word “dog,” the respective text corresponds to stickers that represent, include, or are otherwise associated with a dog. In some embodiments, one or more stickers are linked to various corresponding phrases or keywords in a database, so that when one of the phrases or keywords is used (e.g., in the respective text), corresponding stickers, or a subset thereof, are displayed as a selectable option.

In some embodiments, the set of one or more selectable options (e.g., 1026, 1014-1, 1014-2) associated with the respective text (e.g., 1022-1) are displayed in a region (e.g., 1003) of a keyboard user interface (e.g., 1008) (e.g., a region that is visually distinguished from keyboard keys of the keyboard user interface such as a top region of the keyboard and/or a region of the keyboard user interface that is used to display suggested text and/or other content related to typing and/or inserting text). Displaying the set of one or more selectable options associated with the respective text in a region of a keyboard user interface reduces the number of inputs needed to access the selectable options while composing a message in the messages interface.

In some embodiments, as a part of displaying the set of one or more selectable options (e.g., 1026, 1014-1, 1014-2) associated with the respective text (e.g., 1022-1), the computer system (e.g., 600) displays (e.g., concurrently or separately displaying) at least one selectable option of the first type (e.g., 1014-1, 1014-2) (e.g., one or more emoji options) and at least one selectable option of the second type (e.g., 1026) (e.g., one or more sticker options). In some embodiments, the selectable options of the second type are visually distinguished from the selectable options of the first type by a respective feature (e.g., 1028) (e.g., a background effect, a visual peeling effect, and/or other visual characteristic that distinguishes the sticker options from the emoji options). Displaying the selectable options of the second type visually distinguished from the selectable options of the first type by a respective feature provides improved feedback about the types of selectable options displayed and reduces the number of inputs by avoiding excess inputs caused by confusing the first and second types of selectable options. In some embodiments, the emoji options include a visual feature that distinguishes the emoji options from the sticker options.

In some embodiments, the messages interface (e.g., 1002) includes a first message conversation (e.g., 1004) between a user of the computer system (e.g., 600) (e.g., a person that is holding, operating, logged into, and/or otherwise associated with the computer system) and one or more participants (e.g., members of the “Surf Trip” group) (e.g., other user(s) and/or user account(s) who are participating in the message conversation).

In some embodiments, the computer system (e.g., 600) adds the sticker (e.g., 1016-1) to the message conversation (e.g., 1004) with the respective text (e.g., 1022-1) (e.g., sending the sticker to the participants of the message conversation with the respective text). Adding the sticker to the message conversation with the respective text provides improved feedback by indicating that the respective text and sticker have been transmitted to the participants of the message conversation. In some embodiments, the sticker is added to the message conversation with the respective text in response to detecting selection of the respective option that is a second type of selectable option. In some embodiments, the sticker is added to the message conversation with the respective text in response to one or more inputs detected after displaying the sticker corresponding to the respective option without replacing the respective text. In some embodiments, the sticker and the respective text are both sent (e.g., simultaneously) in response to one or more inputs selecting the sticker for sending and selecting an affordance for sending the message and sticker. In some embodiments, the sticker can be created and/or edited (e.g., prior to sending) using any of the techniques described herein with respect to FIGS. 6A-6AR, 7, 8A-8N, and 9. For the sake of brevity, these details are not repeated.

In some embodiments, as a part of displaying the sticker (e.g., 1016-1) corresponding to the respective option (e.g., 1026) without replacing the respective text (e.g., 1022-1), the computer system (e.g., 600) concurrently displays the sticker and the respective text in a message compose field (e.g., 1006) of the messages interface (e.g., 1002) (e.g., a region of the messages interface for inserting text, emojis, images, and/or stickers for sending in the message conversation). Concurrently displaying the sticker and the respective text in a message compose field of the messages interface provides improved feedback by indicating that the respective text and sticker are in condition to be transmitted to the participants of the message conversation. In some embodiments, the message compose field includes a send affordance (e.g.,) and the sticker and the respective text are both sent (e.g., simultaneously) to participants of the message conversation in response to an input selecting the send affordance (e.g., as shown in FIG. 10I).

In some embodiments, after displaying the sticker (e.g., 1016-1) corresponding to the respective option (e.g., 1026) without replacing the respective text (e.g., 1022-1) (e.g., while the sticker is displayed with the respective text in a message compose field), the computer system (e.g., 600) detects, via the one or more input devices (e.g., 600-1), a request (e.g., 1005-7) to transmit the sticker and the respective text to participants of a message conversation (e.g., an input selecting a send affordance). In response to detecting the request to transmit the sticker and the respective text to participants of the message conversation, the computer system concurrently displays the sticker and the respective text in a message conversation region (e.g., 1004) of the messages interface (e.g., 1002) (e.g., as a part of transmitting the sticker and the respective text to the participants of the message conversation). Concurrently displaying the sticker and the respective text in a message conversation region of the messages interface in response to detecting the request to transmit the sticker and the respective text to participants of the message conversation provides improved feedback by indicating that the respective text and sticker have been transmitted to the participants of the message conversation. In some embodiments, after replacing the respective text with the emoji, the computer system receives a request to send a message with the emoji, and in response, displays the emoji in the message interface without the respective text (e.g., as a part of sending the respective message to the participants of the message conversation).

Note that details of the processes described above with respect to method 1100 (e.g., FIG. 11) are also applicable in an analogous manner to the methods described above. For example, methods 700 and 900 optionally includes one or more of the characteristics of the various methods described above with reference to method 1100. For example, stickers created and/or edited as described with respect to the techniques in methods 700 and/or 900 can be used in accordance with any of the techniques described with respect to method 1100. For brevity, these details are not repeated.

The various embodiments provided herein are generally described using devices 600 and 650. However, it should be appreciated that other computer systems or devices can be used (in addition to, or in lieu of, devices 600/650) to generate, edit, and/or use stickers, and that various aspects of the embodiments described herein can be implemented in different manners across the various devices used to generate, edit, and/or use stickers. For example, a smart speaker, optionally including a display component, can be used to display a sticker interface. In some embodiments, inputs at the smart speaker can be provided verbally and, optionally, via a touch input, and outputs can be audio outputs and, optionally, visual outputs provided at a connected display component. As another example, a display component of a head-mounted device (HMD) can be used to display visual aspects of the sticker user interfaces described herein (and a speaker used to produce audio), and inputs can be received by detecting gestures, eye gaze, hand movements, audio inputs, touch inputs, or the like. In some embodiments, the user interfaces depicted in the figures can be displayed in an extended reality environment such as augmented reality or virtual reality. For example, stickers, messages, and/or other display regions shown in the figures can be displayed suspended in a three-dimensional environment. As another example, the representations of users or participants can be displayed as simulated three-dimensional avatars or two-dimensional avatars positioned around a three-dimensional environment rather than messages and/or stickers in a messaging application. Additionally, embodiments are described herein using various types of inputs such as taps, drags, clicks, and hover gestures, however, it should be appreciated that the described embodiments can be modified to respond to other forms of input including gestures, eye gaze, hand movements, audio inputs, and the like. Additionally, different devices with different capabilities can be combined in a single messaging session, for example a smartphone, tablet, laptop computer, desktop computer, smart speaker, smart TV, headphones or earbuds, HMD, and/or smartwatch (or a subset thereof) could participate in the same messaging session with the different devices participating in different manners according to the capabilities of the device (e.g., the HMD presenting content in a simulated three-dimensional environment or an augmented reality environment, the smart speaker providing audio outputs and inputs, the headphones providing spatial audio outputs and audio inputs, the laptop and desktop computers, smartphone and tablet providing audio and visual inputs and outputs, the smart TV providing audio and visual outputs and audio inputs (or audio and visual inputs)).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to create, edit, and/or use stickers. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to create, edit, and/or use stickers. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sticker creation, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, stickers can be created based on non-personal information data or a bare minimum amount of personal information, such as the content being requested by the device associated with a user, other non-personal information available, or publicly available information.

What is claimed is:

1. A computer system configured to communicate with a display generation component and one or more input devices, comprising:
one or more processors; and
memory storing one or more programs configured to be executed by the one or more processors, the one or more programs including instructions for:
displaying, via the display generation component, a sticker editing interface that includes one or more visual effect options that are selectable to apply a visual effect to a respective sticker, wherein the respective sticker has a first appearance;
detecting, via the one or more input devices, a set of one or more inputs that includes a selection of one of the one or more visual effect options; and
in response to detecting the set of one or more inputs that includes a selection of one of the visual effect options:
in accordance with a determination that the set of one or more inputs includes a selection of a first visual effect option, displaying a representation of the respective sticker having a second appearance that is different from the first appearance, wherein the second appearance includes a first visual effect applied to the respective sticker; and
in accordance with a determination that the set of one or more inputs includes a selection of a second visual effect option that is different from the first visual effect option, displaying a representation of the respective sticker having a third appearance that is different from the first appearance and the second appearance, wherein the third appearance includes a second visual effect applied to the respective sticker without the first visual effect, wherein the second visual effect is different from the first visual effect.

2. The computer system of claim 1, wherein the respective sticker is generated based on a media item.

3. The computer system of claim 1, wherein displaying the sticker editing interface includes:
in accordance with a determination that the respective sticker is generated based on a media item having an animated effect, displaying a representation of the respective sticker with an animated effect; and
in accordance with a determination that the respective sticker is generated based on a media item that does not have an animated effect, displaying a representation of the respective sticker without the animated effect.

4. The computer system of claim 3, wherein the animated effect is a looping animated effect.

5. The computer system of claim 1, wherein the sticker editing interface includes a selectable animation toggle that is selectable to enable or disable displaying of the representation of the respective sticker with an animated effect.

6. The computer system of claim 1, wherein displaying the sticker editing interface includes automatically selecting one of the visual effect options so that the first appearance of the respective sticker includes an applied visual effect corresponding to the automatically selected visual effect option.

7. The computer system of claim 1, the one or more programs further including instructions for:
displaying a sticker interface including a plurality of stickers and a first selectable graphical user interface object, wherein displaying the sticker editing interface occurs in response to selection of the first selectable graphical user interface object.

8. The computer system of claim 7, the one or more programs further including instructions for:
after detecting the set of one or more inputs that includes a selection of one of the visual effect options, displaying the sticker interface with the plurality of stickers including the respective sticker having the second appearance or the third appearance.

9. The computer system of claim 7, wherein the sticker interface is configurable to modify an arrangement of the plurality of stickers and/or delete one or more of the plurality of stickers.

10. The computer system of claim 7, wherein the sticker interface includes a selectable animation user interface object that is selectable to enable or disable animation of one or more of the plurality of stickers.

11. The computer system of claim 1, the one or more programs further including instructions for:
displaying the respective sticker, wherein displaying the sticker editing interface occurs in response to detecting a set of one or more inputs corresponding to the respective sticker.

12. The computer system of claim 1, wherein:
the first visual effect option corresponds to an outline option; and
displaying the representation of the respective sticker having the second appearance includes displaying the representation of the respective sticker having an outline effect applied to the respective sticker.

13. The computer system of claim 1, wherein:
the first visual effect option corresponds to a three-dimensional option; and
displaying the representation of the respective sticker having the second appearance includes displaying the representation of the respective sticker having a three-dimensional effect applied to the respective sticker.

14. The computer system of claim 1, wherein:
the first visual effect option corresponds to an iridescence option; and
displaying the representation of the respective sticker having the second appearance includes displaying the representation of the respective sticker having an iridescent effect applied to the respective sticker.

15. The computer system of claim 1, wherein:
the first visual effect option corresponds to a comic book option; and
displaying the representation of the respective sticker having the second appearance includes displaying the representation of the respective sticker having a comic book effect applied to the respective sticker.

16. The computer system of claim 1, the one or more programs further including instructions for:
while displaying the representation of the respective sticker having a respective visual effect applied to the respective sticker, wherein the respective visual effect has a first displayed state:
detecting, via the one or more input devices, movement of the display generation component; and
in response to detecting the movement of the display generation component, displaying the representation of the respective sticker changing appearance based on the movement of the display generation component, including displaying the respective visual effect changing from the first displayed state to a second displayed state of the respective visual effect that is different from the first displayed state.

17. A non-transitory computer-readable storage medium storing one or more programs configured to be executed by one or more processors of a computer system that is in communication with a display generation component and one or more input devices, the one or more programs including instructions for:
displaying, via the display generation component, a sticker editing interface that includes one or more visual effect options that are selectable to apply a visual effect to a respective sticker, wherein the respective sticker has a first appearance;
detecting, via the one or more input devices, a set of one or more inputs that includes a selection of one of the one or more visual effect options; and
in response to detecting the set of one or more inputs that includes a selection of one of the visual effect options:
in accordance with a determination that the set of one or more inputs includes a selection of a first visual effect option, displaying a representation of the respective sticker having a second appearance that is different from the first appearance, wherein the second appearance includes a first visual effect applied to the respective sticker; and
in accordance with a determination that the set of one or more inputs includes a selection of a second visual effect option that is different from the first visual effect option, displaying a representation of the respective sticker having a third appearance that is different from the first appearance and the second appearance, wherein the third appearance includes a second visual effect applied to the respective sticker without the first visual effect, wherein the second visual effect is different from the first visual effect.

18. A method, comprising:
at a computer system that is in communication with a display generation component and one or more input devices:
displaying, via the display generation component, a sticker editing interface that includes one or more visual effect options that are selectable to apply a visual effect to a respective sticker, wherein the respective sticker has a first appearance;
detecting, via the one or more input devices, a set of one or more inputs that includes a selection of one of the one or more visual effect options; and
in response to detecting the set of one or more inputs that includes a selection of one of the visual effect options:
in accordance with a determination that the set of one or more inputs includes a selection of a first visual effect option, displaying a representation of the respective sticker having a second appearance that is different from the first appearance, wherein the second appearance includes a first visual effect applied to the respective sticker; and
in accordance with a determination that the set of one or more inputs includes a selection of a second visual effect option that is different from the first visual effect option, displaying a representation of the respective sticker having a third appearance that is different from the first appearance and the second appearance, wherein the third appearance includes a second visual effect applied to the respective sticker without the first visual effect, wherein the second visual effect is different from the first visual effect.
